(19) United States
(12) Patent Application Publication
(10) Pub. No.: US 2026/0033517 A1
(43) Pub. Date: Feb. 5, 2026

(54) DENSIFICATION AND OIL EXTRACTION DEVICES, SYSTEMS, AND METHODS

(71) Applicant: ICM, Inc., Colwich, KS (US)

(72) Inventors: Andrew Potts, Colwich, KS (US); Brandon Emme, Colwich, KS (US); Charles C. Gallop, Colwich, KS (US)

(73) Assignee: ICM, Inc., Colwich, KS (US)

(21) Appl. No.: 19/289,928

(22) Filed: Aug. 4, 2025

Related U.S. Application Data
(60) Provisional application No. 63/679,481, filed on Aug. 5, 2024.

(51) Int. Cl. A23K 40/25; A23K 10/14; A23K 10/18; A23K 30/20

(52) U.S. Cl. CPC A23K 40/25; A23K 10/14; A23K 10/18; A23K 30/20

(57) ABSTRACT

Various examples of a system for generating a densified product are provided. The system may include an extruder device and a liquid extraction section. The liquid extraction section may receive a material from the extruder device for densification and may then retain solids while permitting extraction of liquids as the material passes through the liquid extraction section under pressure. In various instances, a series of features forms at least a portion of the liquid extraction section and operates to retain the material on one side of the rods while permitting liquid to pass to another side of the features.

### CROSS-REFERENCE TO RELATED APPLICATIONS

This is a Non-Provisional Patent Application that claims priority to U.S. Provisional Patent App. No. 63/679,481 entitled “Densification and Oil Extraction Devices, Systems, and Methods” filed Aug. 5, 2024, which is incorporated by reference herein in its entirety.

### FIELD

The present disclosure generally relates to densification and oil extraction of distillers' dried grain, corn bran, and/or other oil seeds, and more particularly to devices, systems, and methods that facilitate the densification and oil extraction.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

Methods and devices for extracting oil typically utilize high pressure and short residence time to extract the oil. For example, expeller presses, screw extruders, and pellet mills are each mechanical methods for extracting oil from raw materials.

In expeller pressing, the raw materials are squeezed under high pressure in a single step and utilize a significant amount of energy (i.e., consume a significant amount of energy). Expeller devices mechanically shear the feed material continuously. In this regard, significant heat energy is generated, which prevents the material from sticking together in a uniform shape.

Screw extruders have similar problems as expellers as they also impart high shear into the material. This shearing imparts significant heat that prevents the material from sticking together in a uniform shape unless it is cooled after extrusion. This cooling cannot be easily achieved uniformly. The exterior of the material will cool significantly faster than the center, which decreases the amount of oil that can be extracted because the oil and lignin viscosities will increase as the temperature will decrease, trapping some of the potential oil.

Pellet mills (i.e., pellet press) are a mill or machine press used to create pellets from powdered material. Pellet mills can only densify via pelleting. The current maximum known densification on industrial scale is 40 lbs./ft³ for certain materials (e.g., certain animal feed products). Pelleted material inherently leaves air voids between the pellets. These air voids decrease the bulk density that the material could achieve as a brick, sheet, or block. Additionally, pellet mills are not capable of both densification and oil extraction.

Briquetting machines are press machines used to recycle biomass waste into a high caloric fuel briquette. Traditionally, briquetting machines do not reform the material after compression and do not extract oil from the process.

### SUMMARY

An extruder device is provided. The extruder device may include a driving mechanism. The extruder device may include a piston pump section. The piston pump section may include a housing assembly and a piston. The housing assembly may include a chamber disposed therein. The extruder device may include a liquid extraction section coupled to the piston pump section. The liquid extraction section may have a top planar structure, a bottom planar structure, a first set of members and a second set of members. The first set of members and the second set of members may be configured to compress the top planar structure and the bottom planar structure together. The driving mechanism may be configured to drive the piston, directly or indirectly, at least partially through the chamber to drive a fibrous mixture between the top planar structure and the bottom planar structure.

One or more additional features may be provided. For example, the housing assembly further includes a feed spout and a fluid conduit. The fluid conduit may include a portion of the chamber, the feed spout in fluid communication with the chamber. In various instances the top planar structure and the bottom planar structure each comprise one of: (1) a mechanical screen; or (2) a plurality of rods, each of the plurality of rods having one of a square or rectangular cross-section, each of the plurality of rods aligned adjacent to an adjacent of the plurality of rods. In various embodiments, the liquid extraction section further includes a first longitudinal sidewall spaced apart laterally from a second longitudinal sidewall, and wherein the top planar structure and the bottom planar structure each comprise the plurality of rods. In various embodiments, the plurality of rods of the top planar structure and the plurality of rods of the bottom planar structure are each compressed together in a lateral direction between the first longitudinal sidewall and the second longitudinal sidewall by a fastener arrangement. In various embodiments, responsive to traversing the fibrous mixture through the liquid extraction section, liquid from the fibrous mixture is extracted between adjacent rods in the plurality of rods of the bottom planar structure. In various embodiments each of the plurality of rods is configured to move independently from one another, and one or more shims is disposed between a first of the plurality of rods and a second of the plurality of rods to set a leach gap therebetween.

The extruder device may have other features. For instance, the housing assembly further includes a plurality of plate. Each of the plurality of plates has an opening. Each of the plurality of plates is stacked in a longitudinal direction. Each of the plurality of plates is coupled together by a compressive force in the longitudinal direction. The opening of at least a portion of the plurality of plates forms at least a portion of the chamber of the housing assembly. The housing assembly may also have a feed spout and a fluid conduit. The chamber may be at least partially defined by an internal cavity of the fluid conduit and the opening from each of the plurality of plates.

In various embodiments, the extruder device has a drain relief channel disposed through the plurality of plates, wherein each of the plurality of plates has a drain relief aperture that at least partially forms the drain relief channel. The extruder device may also have a liquid collection tank. During operation of the extruder device, liquid travels through the drain relief channel to the liquid collection tank.

In various embodiments, the driving mechanism is one of a hydraulic pump, a lever arm, a wheel and crank arrangement, an electromagnet compressor, a pneumatic compressor, a steam engine, a steam turbine, or a flywheel. During operation of the extruder device, the liquid extraction section is configured to leach a liquid from the fibrous mixture and densify the fibrous mixture as the fibrous mixture traverses therethrough. The liquid extraction section may have a discharge end, and during operation of the extruder device, the liquid extraction section is configured to convert the fibrous mixture into a densified fibrous mixture. In various embodiments, the densified fibrous mixture is a dried animal feed and the dried animal feed has a density between 55 lbs/ft\hat{ }3 (881 kg/m\hat{ }3) and 75 lbs/ft\hat{ }3 (1201 kg/m\hat{ }3).

In various embodiments, the bottom planar structure is configured to be oriented at an acute angle above a horizontal plane defined through an inlet end of the bottom planar structure. In various embodiments, the acute angle allows liquid that is extracted proximal a discharge end of the liquid extraction section to flow away from the discharge end.

In various embodiments, the extruder device has a heating section, a cooling section, and a discharge end. For example, the extruder device may have a heating section disposed adjacent to the liquid extraction section. Th extruder device may have a cooling section disposed adjacent to the heating section. The extruder device may have a discharge end disposed adjacent to the cooling section. Th extruder device may include a breaker spaced apart from the discharge end. The breaker may be configured to break a densified dried animal feed that is discharged from the discharge end.

A system is provided. The system may be for generating a densified dried animal feed. The system may include an extruder device. The extruder device may include a driving mechanism. The extruder device may include a piston pump section. The piston pump section may include a housing assembly and a piston, the housing assembly including a chamber disposed therein. The system may include a liquid extraction section. The liquid extraction section may be coupled to the piston pump section. The liquid extraction section may include a top planar structure, a bottom planar structure, a first set of members and a second set of members, the first set of members and the second set of members configured to compress the top planar structure and the bottom planar structure together, the driving mechanism configured to drive the piston, directly or indirectly, at least partially through the chamber to drive a fibrous mixture between the top planar structure and the bottom planar structure. The system may include one or more dryers. The system may include a fluid conduit extending from at least one of the one or more dryers to the chamber of the housing assembly of the piston pump section. The system may include a feed transfer mechanism. The feed transfer mechanism may include one of: a door or a screw. The door may be configured to drop a dried animal feed from the one or more dryers through the fluid conduit and into the chamber of the housing assembly of the piston pump section. The screw may be configured to convey the dried animal feed from the one or more dryers through the fluid conduit and into the chamber of the housing assembly of the piston pump section. The system may include a controller. The controller may be electronically coupled to the one or more dryers and the extruder device. The controller may be configured to control an operational cycle of the one or more dryers. The controller may be configured to transfer the dried animal feed from the one or more dryers to the chamber of the housing assembly of the piston pump section. The controller may be configured to convey the dried animal feed through the extruder device to form the densified dried animal feed.

A housing assembly is provided. The housing assembly may be for an extruder device. The housing assembly may include a plurality of plates stacked in a longitudinal direction. The plurality of plates may at least partially define a chamber of a piston pump section of the extruder device therein. The chamber may include a first cross-sectional profile at an inlet of the plurality of plates and a second cross-sectional profile at an outlet of the plurality of plates. The second cross-sectional profile may be being different from the first cross-sectional profile. The assembly may include a fastener arrangement. Each of the plurality of plates are coupled together by a compressive force in the longitudinal direction from the fastener arrangement. The assembly may include a feed spout. The assembly may include a fluid conduit coupled to a forward plate in the plurality of plates. The chamber of the piston pump section of the extruder device is at least partially defined by an internal cavity of the fluid conduit. The chamber may be configured to reform a fibrous mixture as the fibrous mixture traverses from the inlet of the plurality of plates to the outlet of the plurality of plates.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a dry grind process in an ethanol plant configured to produce ethanol and various animal feed products, in accordance with various embodiments.

FIG. 2 illustrates a cross-sectional view of a liquid extraction system with an extruder device, in accordance with various embodiments.

FIG. 3A illustrates a perspective view of a liquid extraction system with an extruder device, in accordance with various embodiments.

FIG. 3B illustrates a perspective view of a liquid extraction system with an extruder device, in accordance with various embodiments.

FIG. 4A illustrates a side view of a housing assembly for use in an extruder device, in accordance with various embodiments.

FIG. 4B illustrates a cross-sectional view of a housing assembly for use in an extruder device, in accordance with various embodiments.

FIG. 4C illustrates a cross-sectional view of a housing assembly for use in an extruder device, in accordance with various embodiments.

FIG. 4D illustrates a cross-sectional view of a housing assembly for use in an extruder device, in accordance with various embodiments.

FIG. 4E illustrates a cross-sectional view of a housing assembly for use in an extruder device, in accordance with various embodiments.

FIG. 5A illustrates a side view of a liquid extraction system with an extruder device, in accordance with various embodiments.

FIG. 5B illustrates a side view of a liquid extraction assembly of the extruder device of FIG. 5A, in accordance with various embodiments.

FIG. 5C illustrates a top-down view of the liquid extraction assembly of FIG. 5B, in accordance with various embodiments.

FIG. 5D illustrates a cross-sectional view of the liquid extraction assembly of FIGS. 5B and 5C, in accordance with various embodiments.

FIG. 5E illustrates a cross-sectional view of the liquid extraction assembly of FIGS. 5B-D, in accordance with various embodiments.

FIG. 5F illustrates a front view of a plurality of rods for a liquid extraction assembly, in accordance with various embodiments.

FIG. 6 illustrates a side view of a portion of a liquid extraction system, in accordance with various embodiments.

FIG. 7 illustrates a perspective view of a liquid section of an extruder device, in accordance with various embodiments.

FIG. 8 illustrates a cross-sectional view of the liquid section of the extruder device of FIG. 7, in accordance with various embodiments.

FIG. 9 illustrates a discharge end of a liquid extraction section of an extruder device, in accordance with various embodiments.

FIG. 10A illustrates a side view of a transfer arrangement between a dryer and an extruder device, in accordance with various embodiments.

FIG. 10B illustrates a side view of a transfer arrangement between a dryer and an extruder device, in accordance with various embodiments.

FIG. 11 illustrates a perspective view of a portion of an extruder device, in accordance with various embodiments.

FIG. 12 illustrates a perspective view of a driving mechanism arrangement for a portion of an extruder device, in accordance with various embodiments.

FIG. 13 illustrates a perspective view of a housing assembly of a piston pump section of an extruder device, in accordance with various embodiments.

FIG. 14 illustrates a perspective view of a housing assembly of a piston pump section of an extruder device, in accordance with various embodiments.

FIG. 15 illustrates a schematic view of a control system for an extruder device, in accordance with various embodiments.

FIG. 16 illustrates a process 1600 performed by the control system of FIG. 16, in accordance with various embodiments.

FIG. 17A illustrates a method of forming a densified dried animal feed product, in accordance with various embodiments.

FIG. 17B illustrates a pictorial flow chart for the method of FIG. 17A, in accordance with various embodiments.

FIG. 18A illustrates a method of producing and shipping a densified dried animal feed product, in accordance with various embodiments.

FIG. 18B illustrates a pictorial flow chart for the method of FIG. 18A, in accordance with various embodiment.

FIG. 19 illustrates a top view and a side view of a densified animal feed product, in accordance with various embodiments.

FIG. 20 illustrates a loaded pallet with a plurality of sheets of densified animal feed product stacked thereon, in accordance with various embodiments.

FIG. 21 illustrates a pressure chart as a function of distance for a pump of an extruder device, in accordance with various embodiments.

FIG. 22 illustrates a perspective view of a portion of a piston pump section with a back flow preventer plate, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized, and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full, or any other possible attachment option. Additionally, any reference to “without contact” (or similar phrases) may also include “reduced contact” or “minimal contact.” It should also be understood that unless specifically stated otherwise, references to “a,” “an,” or “the” may include one or more than one, and that reference to an item in the singular may also include the item in the plural. Further, all ranges may include upper and lower values, and all ranges and ratio limits disclosed herein may be combined.

While studying the structural strengths of densified fiber syrups, it was discovered that oil would leach out of a heated die of a mechanical heated press. More specifically, a fiber and syrup product, as described further herein, was hydraulically pressed at approximately 600 PSIG (4.1 MPa) for between one and five minutes to test a strength of the fiber and syrup product. It was noted that during the strength testing, that oil would leach out of a cake (or briquette) that was generated from the mechanical heated press. Accordingly, based on the discovery, and after further inquiry, it was determined that the amount of oil remaining in the fiber and syrup product that was produced in an ethanol plant was significant enough to scaling a process industrially and developing a product to extract the oil and further densify an animal feed product, as described further herein.

Accordingly, to further study an amount of remaining oil of various products produced from ethanol plants, various samples were tested using a mechanical heated press to extract oil. The results of the testing are shown below in Table 1.

TABLE 1
Oil Extraction Testing Results

| | Oil | |
|---|---|---|
| Sample | (lbs./bushel) | Time (Min) |
| Plant #1 Dried Fiber & Syrup #12 Filtered | 0.25 | 5 |
| Unders | | |
| Plant #2 Fiber 907-5 | 0.3 | 5 |
| Plant #3 Dried Fiber & Syrup #12 Filtered | 0.17 | 5 |
| Unders | | |
| Plant #2 Fiber 908-3 | 0.23 | 5 |
| Plant #4 Burnt Dried Fiber & Syrup | 0.12 | 1 |
| Plant #4 Burnt Dried Fiber & Syrup | 0.15 | 3 |
| Plant #4 Burnt Dried Fiber & Syrup | 0.15 | 5 |
| Plant #5 DDGs | 0.53 | 1 |
| Plant #5 DDGs | 0.63 | 3 |
| Plant #5 DDGs | 0.63 | 5 |
| Rotary Fiber (Plant #5) | 0.21 | 1 |
| Rotary Fiber (Plant #5) | 0.28 | 3 |
| Rotary Fiber (Plant #5) | 0.31 | 5 |
| Plant #3 Dried Fiber & Syrup | 0.1 | 1 |
| Plant #3 Dried Fiber & Syrup | 0.14 | 3 |
| Plant #3 Dried Fiber & Syrup | 0.14 | 5 |

As shown in Table 1, oil extraction increased when particle separation was performed with a #12 sieve. For example, 23% more oil was extracted when Plant #3 the dried fiber & syrup product was screened on a weight-by-weight basis. That is, the screen material had 23% more oil release per pound then the unscreened material. The total oil removed was less for all the material. Not to be bound by theory, germ and bran can be separated by particle size when roller mills are utilized, which could cause the increase in oil when utilizing a #12 sieve. Accordingly, based on the testing, a 13.2 lbs./bushel of distiller's dry grains with syrup (DDGS) and an 8.2 lbs./bushel of fiber for the dried fiber & syrup product could potentially be available for extraction. Additionally, as shown in Table 1, approximately twice as much oil was recovered from DDGS compared to rotary fiber (Plant #5). Accordingly, it was discovered that drying with syrup could be a key factor to improve oil extraction yield.

Accordingly, based on the experimental data above, a hypothesis was conceived by the inventors that drying corn fiber can increase the oil extraction on a weight-by-weight basis thereafter. Traditionally, it was thought extracting oil from each stream in an ethanol process prior to combining of the streams would produce the highest oil yield. For a fiber stream in a traditional method, expellers would be utilized, while the soluble sugar streams would typically utilize centrifuges. In contrast, disclosed herein is an extruder device that is configured to densify a dried animal feed product (e.g., a fiber and syrup product, a dried distiller's grains with solubles (DDGS) product, or any other animal feed product, as described further herein).

Accordingly, based on the discovery outlined above, disclosed herein are systems, devices, and methods for simultaneous liquid extraction and densification of a cereal grain-based composition (e.g., dried distillers' grains with solubles (DDGS), dried distillers' grains (DDG), condensed distillers solubles (CDS), grain distillers dried yeast, oilseeds, or any other fibrous-based mixture where liquid extraction and densification may be desired). In this regard, both densification and oil extraction can be performed simultaneously from a corn fiber feed with soluble sugars (or any other fibrous mixture) that is input from a dryer in an ethanol plant. In various embodiments, a liquid extraction system comprises an extruder device adaptable to densify the cereal grain-based composition simultaneously with extracting oil (or another liquid) from the cereal grain-based composition.

For expellers, this decreases the length of the screw used. In contrast to expellers, which operate at high pressure and low residence times, the extruder device disclosed herein is configured to operate at lower pressure with longer residence time. In this regard, since the cost of the extraction zone disclosed herein is far cheaper to manufacture and machine then a traditional expeller or extruder, the system can accommodate greater wear and components can be swapped out as needed. Stated another way, by having an extruder with low capital and maintenance cost, a higher wear rate is not a significant issue. Repairing components and other maintenance items can be inexpensive allowing for a less expensive process, in accordance with various embodiments.

Typical distiller grain pellet production methods have used screw expellers to pretreat the granular material prior to densification and potential oil extraction. Screw expellers can achieve oil extraction through high pressure and shear force. However, the constant shearing continuously increases the material temperature preventing it from forming a stable, substantially uniform, macro-solid structure, and the pretreatment system requires significant energy to prepare the granular material. Furthermore, the frictional forces imparted by typical screw expellers greatly increases the energy requirements to operate such a system. Additionally, fabrication of typical screw expellers for such systems can be capital intensive, due to the necessity of high precision machining to achieve the appropriate gap between the screw and barrel walls of the extruder and are often difficult to maintain. Furthermore, the economics of mechanical oil extraction of corn oil has been limited to the wet milling space that has the capacity to separate the corn bran from the germ. Screw expellers are volumetric machines that are economical when fed 90% or more germ. The inability to separate germ from bran in the dry grind plant reduces the oil yield on volume and weight basis can increase the power requirements and capacity (units) of the expellers required.

Disclosed herein, and in contrast to typical screw expellers, is a system that is configured to form a stable macro-solid structure during densification and extraction, and utilizes no pretreatment, as the material may be at elevated temperature prior to entering the extruder device. The extruder device disclosed herein can further include minimally machined parts, reducing an initial capital cost for the extruder device, and facilitating significantly easier maintenance relative to screw expellers. In various embodiments, the extruder device disclosed herein utilizes minimal amounts of energy relative to similar densification type devices, such as a typical screw expeller. In various embodiments, the extruder device has significantly higher throughput relative to a screw expeller, much lower capital cost relative to the screw expeller, and/or lower energy demand relative to the screw expeller.

Typically, feed suppliers have provided densified animal feeds ranging from compressed crumble, to pellets, to briquettes, and even tubs. However, the density for densified feed products has never been high enough independently to allow the feed product to be stacked on a pallet and shipped via containerized shipping. Stated another way, although animal feed products may have been added to tubs and shipped via pallets, to achieve a density to facilitate shipping via pallets, the density of the animal feed products alone have not been high enough to allow the feed product to be stacked on pallets without a non-feed product element added. Yet, by the methods, systems, and devices disclosed herein, an animal feed product can be formed that includes a density that is high enough to be shipped via palletized shipping. Accordingly, disclosed herein is an animal feed product that can be loaded onto a standard pallet, coupled to the pallet, and shipped via containerized shipping, as described further herein.

In various embodiments, the extruder device disclosed herein is configured to output a densified product (e.g., a densified animal feed, a particle board, or any other densified product formed by the extruder device disclosed herein). In various embodiments, the extruder device is configured to output a densified product from the liquid extraction section that can be shaped into a variety of forms (e.g., sheets of dried cereal grain-based composition, pellet sized pieces of dried cereal grain-based composition, or any other shape that may be readily apparent to one skilled in the art). In various embodiments, the extruder device can output a sheet of dried cereal grain-based composition (e.g., in a generally cuboid shape) that is sized and configured to be stacked on a pallet, and which can greatly reduce shipping costs, in accordance with various embodiments, as described further herein.

The extruder device disclosed herein comprises a piston pump section and a liquid extraction section. In various embodiments, the piston pump section includes a plurality of stacked plates that facilitate a reduction in initial capital costs and/or maintenance costs relative to typical piston pump sections of mechanical devices. In various embodiments, the piston pump section could reduce capital costs for alternative applications, such as a concrete pump. In various embodiments, the liquid extraction section is configured to mechanically remove free liquid (e.g., free oil). In various embodiments, the piston pump section allows for the material being extruded to plug any leaks. For example, due to the difference between the static friction constant, and the kinetic friction factor, the material being extruded can plug any potential leak paths in the piston pump section, in accordance with various embodiments.

Disclosed herein is housing assembly for a piston pump section for use in an extruder device. In various embodiments, the housing assembly comprises a stacked plate assembly, which can allow for inexpensive manufacturing and case of repair and/or maintenance. The piston for use with the housing assembly, can be driven by a driving mechanism. The driving mechanism can drive the piston directly (e.g., via a hydraulic pump, a steam engine, a steam turbine, a pneumatic compressor, an electromagnetic compressor, or any other direct driving mechanism) or indirectly (e.g., via a lever arm, a wheel and crank arrangement, or any other indirect mechanism). The present disclosure is not limited in this regard. In various embodiments, a lever assembly can allow for a lower pressure hydraulic system to achieve the elevated pressures of the extruder device.

Disclosed herein is a mechanical system (e.g., the liquid extraction system) integrated with the piston pump section to work free oil (or any other liquid) out of a compressible solids matrix (e.g., a fibrous matrix, such as dried distillers grain (DDG), dried distillers grain with solubles (DDGS), or any other fibrous matrix), which can be agricultural oil streams from corn, soy, or similar, or process streams thereof.

In various embodiments, the housing assembly of the piston pump section can be created by cutting a series of cross sections from a metal plate (or plates) (e.g., steel, nickel, titanium, aluminum, or any other material known in the art). The metal plates can then be stacked and held in place by a fastener arrangement (e.g., bolt and nut arrangement, stud and nuts arrangement, or any other fastener arrangement for compressing two components together that may be readily apparent to one skilled in the art) similar to a plate-and-frame heat exchanger. In this regard, if any of the cross sections wears out, that single plate can be replaced instead of having to replace the entire chamber. Furthermore, the housing assembly of the piston pump section can allow for the plates to wear out in a predictable fashion, allowing plates that wear out faster to be replaced more often, allowing certain plates to be periodically rearranged, and allowing at least some of the plates to be periodically replaced, in accordance with various embodiments.

In various embodiments, the liquid extraction system can use a top planar structure (e.g., a plurality of square or rectangular rods oriented in a plane above the compressed solids cake coming from the piston pump section), a bottom planar structure (e.g., a plurality of square or rectangular rods oriented in a plane below the compressed solids cake coming from the piston pump section), and a compression arrangement. These rods can be able to move as the compression arrangement (e.g., compression rollers) move back and forth, helping to keep oil leaching gaps clear. These rods can be off the shelf, such that any mechanical failures (or wear) only require replacing the damaged rod and not the entire extraction section, which can provide savings on operating cost, in accordance with various embodiments.

Existing densification of ethanol plants dried feed (e.g., DDGS, DDG, or any other dried animal fees from ethanol plants) is currently limited to 42 lbs./ft³ (657 kg/m³). Train railcars have bulk density limits upwards of 55 lbs./ft³ (881 kg/m³). The ability to densify to 55 lbs./ft³ (881 kg/m³) would decrease the required number of railcars and decrease transportation and storage cost. The extruder device and the oil extraction system disclosed herein can achieve bulk densities between 55 lbs./ft³ (881 kg/m³) and 80 lbs./ft³ (1281 kg/m³), or between 55 lbs./ft³ (881 kg/m³) and 75 lbs./ft³ (1201 kg/m³), or greater than 55 lbs./ft³ (881 kg/m³). If formed into stacked sheets, the extruder device and the oil extraction system disclosed herein can facilitate sheets of dried animal feed that can be sized and configured for use in flat bed trailers and warehouse storage instead of bulk hopper trucks and bunker storage, which can reduce on shipping and storage costs, in accordance with various embodiments.

Disclosed herein is a method for densifying a fibrous matrix and extracting a liquid from the fibrous matrix. For example, at a discharge of a dryer in a dry grind ethanol plant, where the feed material (DDGS, SOLBRAN, corn bran) is no lower than 160° F. (71° C.), dried material (e.g., a dried fibrous matrix) can be sent to a liquid extraction system (e.g., an extruder device). Although described herein as being no lower than 160° F. (71° C.), the present disclosure is not limited in this regard. For example, in various embodiments, the feed material could be lower than 160° F. (71° C.), such as a dried animal feed product that is output from dry heating or steam injection, in accordance with various embodiments.

In various embodiments, by having the temperature of the fibrous matrix being greater than 160° F. (71° C.), an amount of force/pressure to facilitate compression and reforming of the feed material by extrusion may be reduced relative to a feed that has a temperature less than 160° F. (71° C.). The reformed feed can pass into a forming zone to maintain the extruders formed shape. Once formed the formed material can pass through a cooling zone. The cooling zone can help stabilize the feed and keep it from extruding through the liquid extraction openings (e.g., oil leach openings). The stabilized shape can then enter the oil extraction zone, which can contain openings on two walls to allow for liquid (e.g., oil) to leach from the feed material. The extraction zone can contain mechanical adjustments to narrow the height or width as liquid leached to maintain a pressure between 100 PSIG (0.69 MPa) and 1500 PSIG (10.3 MPa). At the discharge, an output of the formed material can either be stacked to make blocks for palleting or crumbled (or cut) for hopper car transportation or silo storage. The present disclosure is not limited in this regard. However, by palleting the formed material that is extruded from the extruder device, shipping costs can be reduced as described further herein, in accordance with various embodiments.

In various embodiments, use of a piston can allow for the fibrous matrix of material (e.g., bran) to naturally align itself to be perpendicular to the oil extraction zone. This alignment can create channels for the oil or other liquids leach out of the feed material.

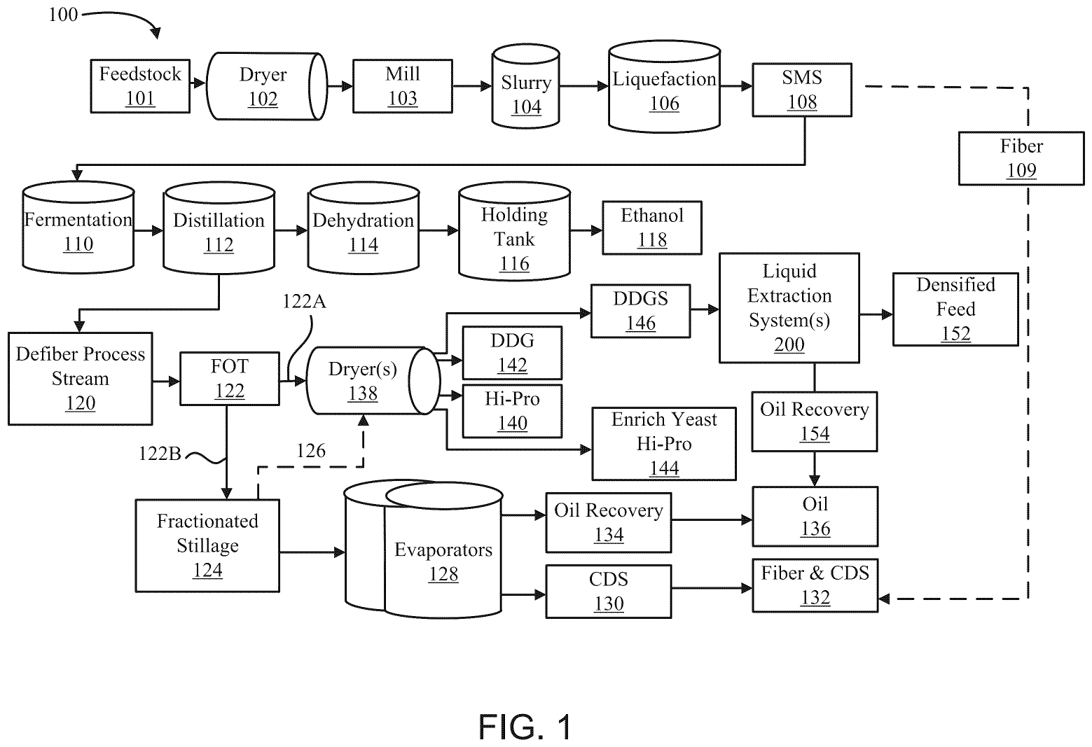

Referring now to FIG. 1, a process 100 performed in a dry grind mill of a production plant (e.g., an ethanol plant 10) is illustrated, in accordance with various embodiments. In various embodiments, the process 100 may operate in a continuous manner. However, the present disclosure is not limited in this regard. For example, the process 100 can operate in a batch process or a combination of batch and continuous processes and still be within the scope of this disclosure.

As described further herein, the process 100 utilizes a liquid extraction system 200 (e.g., an oil extraction system) for densifying an animal feed product (e.g., to form a densified animal feed 152) and simultaneously recovering oil 154 to increase an oil yield (e.g., oil 136). Stated another way, an ethanol plant 10 that is adaptable to perform the process 100 from FIG. 1 can comprise the liquid extraction system 200, in accordance with various embodiments. Although the liquid extraction system 200 is described herein as being utilized in a dry grind process (e.g., process 100), the present disclosure is not limited in this regard.

Referring back to the process 100 of FIG. 1, the process 100 may receive feedstock 101 of a grain. The feedstock 101 can include, but is not limited to, barley, beets, cassava, corn, cellulosic feedstock, grain (e.g., oil seeds, such as soybeans, grape seeds, mustard seeds, etc.), milo, oats, potatoes, rice, rye, sorghum grain, triticale, sweet potatoes, lignocellulosic biomass, wheat, and the like, or pulp. Lignocellulosic biomass may include corn fiber, corn stover, corn cobs, cereal straws, sugarcane bagasse, and dedicated energy crops, which are mostly composed of fast growing tall, woody grasses, including, but not limited to, switch grass, energy/forage sorghum, miscanthus, and the like. Also, the feedstock 101 may further include grain fractions or by-products as produced by industry, such as hominy, wheat middlings, corn gluten feed, distillers' dried grains with solubles, and the like. The feedstock 101 may include, an individual type, a combined feedstock of two types, a combined feedstock of multiple types, or any combination or blend of the above grains. The feedstock 101 may include, but is not limited to, one to four different types combined in various percentage ranges. The feedstock 101 may be converted into different types of products and co-products that may include, but is not limited to, ethanol, syrup, distillers' oil, distillers' dried grains, distillers' dried grains with solubles, condensed distillers' solubles, wet distillers' grains, and the like. In this application, there will be pounds of high protein animal feed products, enriched yeast products, and other types of products. For instance, a bushel of corn may produce about 17-19 pounds of ethanol, about 17-18 pounds of DDGS, and 17-18 pounds of carbon dioxide.

For brevity purposes, the process 100 of using a single stream of feedstock will be described with reference to FIG. 1. As an example, corn may be used as a single feedstock (e.g., feedstock 101) in the process 100 (e.g., a dry grind process). Corn may be broken down into its major components of endosperm, germ, bran, and tip cap. Each of these major components may be further broken down to their smaller components. The endosperm, the germ, the bran, and the tip cap each contain varying amounts of starch, protein, oil, fiber, ash, sugars, etc. For example, the amounts of the components in corn may include, but are not limited to, about 70 to 74% starch, about 7 to 9% protein, about 3 to 4% oil, about 7 to 9% fiber, about 1 to 2% ash, about 1 to 2% sugars, and others.

The process 100 can comprise pre-heating the feedstock 101 in a dryer 102 prior to milling the feedstock 101 in a mill 103. For example, in various embodiments, feedstock 101 is wet prior to performing the process 100. Accordingly, by pre-drying the feedstock in the dryer 102, moisture can be removed from the feedstock 101 prior to milling in the mill 103 of process 100. In various embodiments, the dryer 102 can comprise a resistance heater or the like.

The process 100 comprises feeding the feedstock 101 dried by the dryer 102 into a mill 103 (e.g., hammer mills, roller mills, or any other mill or grinder that may be readily apparent to one skilled in the art) to grind the feedstock 101 into a meal, a powder, or a flour to achieve an appropriate particle size. This grinding, via mill 103, serves to break an outer coating of the corn kernel and increases a surface area to expose starch for penetration of water in cooking. This initial grinding of the feedstock 101 affects the particle size further down the processes. A “mill” as referred to herein includes mills and grinders. Stated another way, a “mill” refers to any device that is adaptable to reduce a particle size of a grain that is known in the art.

The process 100 sends the ground material from the mill 103 to slurry 104. Next, the process 100 adds fresh water, backset or process recycled water, and/or enzymes to the feedstock 101 that has been ground via mill 103 to create a slurry 104 in a slurry tank. In various embodiments, the process 100 adds a liquefying enzyme, such as alpha-amylase to this mixture. The alpha-amylase enzyme hydrolyzes and breaks starch polymer into short sections, dextrins, which are a mix of oligosaccharides. The process 100 maintains a temperature between about 60° C. to about 100° C. (about 140° F. to about 212° F.) in the slurry 104 to cause the starch to gelatinize and a residence time of about 30 to about 60 minutes to convert insoluble starch in the slurry 104 to soluble starch. The slurry 104 may have suspended solids content of about 26% to about 46%, which includes starch, fiber, protein, and oil.

In various embodiments, the process 100 can pump the slurry 104 to jet cookers to cook the slurry 104. Jet cooking may occur at elevated temperatures and pressures. For example, jet cooking may be performed at a temperature of about 104° C. to about 150° C. (about 240° F. to about 302° F.) and at an absolute pressure of about 1.0 to about 6.0 kg/cm² (about 15 to 85 lbs./in²) for about five minutes. Jet cooking is another method to gelatinize the starch.

The process 100 further comprises sending the slurry 104 to liquefaction 106, which converts the slurry to a mash. In various embodiments, the process 100 uses a temperature range of about 80° C. to about 150° C. (about 176° F. to about 302° F.) to hydrolyze the gelatinized starch into water soluble maltodextrins and oligosaccharides to produce a liquefied mash. Here, the process 100 produces a mash stream, which has about 26% to about 40% total solids content. The mash may have suspended solids content that includes protein, oil, fiber, grit, and the like. In various embodiments, one or more liquefaction tanks may be used in liquefaction 106. In various embodiments, the process 100 may add another enzyme, such as glucoamylase, in the liquefaction 106 to break down the dextrins into simple sugars.

At liquefaction 106, the process 100 obtains the process stream or a mixture from the slurry 104. In other embodiments, the process 100 may obtain a process stream or mixture as slurry 104 from a slurry tank, from a jet cooker, from a first liquefaction tank, from a second liquefaction tank, or after a pretreatment process in cellulosic production facility. The present disclosure is not limited in this regard.

In various embodiments, after liquefaction 106, the process stream is fed to a selective milling system (“SMS”) 108. The SMS 108 can be configured to increase a starch recovery from grain and/or to remove fiber 109 (e.g., as shown in the dotted line) before sending the process stream to fermentation 110. The process 100 can send the fiber 109 to a feed area, avoiding fermentation, distillation, dehydration, and drying (i.e., back-end processes).

In various embodiments, the SMS 108 may obtain the process stream or mixture as slurry 104 from a slurry tank, from a jet cooker, from a first liquefaction tank, from a second liquefaction tank, or after a pretreatment process in cellulosic production facility. The present disclosure is not limited in this regard.

At fermentation 110, the process 100 adds a microorganism to the mash for fermentation in a tank. The process 100 may use a common strain of microorganism, such as Saccharomyces cerevisiae to convert the simple sugars (i.e., maltose and glucose) into alcohol with solids and liquids, carbon dioxide (CO₂), and heat. The process 100 may use a residence time in fermentation 110 as long as about 50 to about 72 hours. However, variables such as a microorganism strain being used, a rate of enzyme addition, a temperature for fermentation, a targeted alcohol concentration, and the like, may affect fermentation time. Although described herein as having a residence time in fermentation 110, the present disclosure is not limited in this regard. For example, the process 100 may include continuous fermentation for fermentation 110 and would still be within the scope of this disclosure. In various embodiments, one or more fermentation tanks may be used in the process 100.

The process 100 creates alcohol, solids, liquids, microorganisms, and various particles through fermentation 110. Once completed, the mash is commonly referred to as beer, which may contain about 8% to about 22% alcohol, plus soluble and insoluble solids from the grain components, microorganism metabolites, and microorganism bodies. The microorganism may be recycled in a microorganism recycling step, which is an option. The part of the process 100 that occurs prior to distillation 112 may be referred to as the “front-end,” and the part of the process 100 that occurs during and after distillation 112 may be referred to as the “back-end.”

Turning to distillation 112, the process 100 distills the beer to separate the alcohol from the non-fermentable components, solids, and the liquids by using a distillation process, which may include one or more distillation columns, work with beer columns, side stripper, and the like. The process 100 pumps the beer through distillation 112, which is boiled to vaporize the alcohol or produce concentrated stillage. The process 100 condenses the alcohol vapor in distillation 112 where liquid alcohol exits through a top portion of the distillation 112 at about 90% to about 95% purity ethanol, 5% to 10% water which is about 180 proof to 190 proof alcohol. In various embodiments, the distillation columns and/or beer columns may be in series or in parallel.

At dehydration 114, the process 100 removes any moisture from the 190 proof alcohol by going through dehydration. The dehydration 114 may include one or more drying column(s) packed with molecular sieve media to yield a product of nearly 100% alcohol, which is 200 proof alcohol.

At the holding tank 116, the process 100 adds a denaturant to the alcohol. Thus, the alcohol is not meant for drinking, but to be used for motor fuel purposes. In various embodiments, an ethanol product 118, is produced to be used as fuel or fuel additive for motor fuel purposes.

Turning back to distillation 112, the water-rich product output from the distillation device that is remaining is now referred to as a defiber process stream 120, which may include, but is not limited to, starches, soluble organic and inorganic compounds, suspended solids containing protein, carbohydrate, dissolved solids, water, oil, fat, protein, minerals, acids, bases, recycled yeast, non-fermented carbohydrates, by-products, small amount of lignocellulose, and the like. “Defiber” is defined as having a minimum or small amount of fiber. The defiber process stream 120 falls to the bottom of the distillation 112 and passes through a feed processing system (e.g., a feed optimization technology or “FOT 122”) process to create a high protein feed product. Stated another way, the defiber process stream 120 is enriched in protein via FOT 122.

The process in FOT 122 may be included with any process as part of the dry grind process or any type of process, steep process, or wet milling in a production facility. Specifically, FOT 122 helps to create a high protein animal feed product and other products that may be sold.

The liquid stream 122B from FOT 122 may need further processing due to its total solids composition. For example, the liquid stream 122B could contain high amounts of suspended solids that may cause inefficiency problems such as heating surface fouling in the evaporators. Furthermore, this processing step of evaporating to concentrate solids in high water content streams utilizes a significant amount of energy. Thus, the amount of energy can increase the operating costs. The evaporator capacity may be a bottleneck in the plant. The process 100 sends this liquid stream 122B to fractionated stillage 124 for further processing.

Fractionated stillage 124 may be included with any process as part of the dry grind process or any type of process in a production facility. Specifically, fractionated stillage 124 helps to improve the separation of solids from liquids in an efficient manner, improve evaporator operation, increase throughput, provide feed streams for further processing to produce valuable animal feed products and/or oil, and to reduce GHG or carbon emissions. Other embodiments may include fractionated stillage 124 processes being located after whole stillage or after any of the evaporators (i.e., after one, two, three, last, and the like).

The process 100 sends a liquid stream from fractionated stillage 124 to the one or more evaporators 128 to boil away liquids from this stream. This creates a thick syrup, condensed distillers' solubles, CDS 130 (i.e., about 25% to about 50% dry solids), which contains soluble or dissolved solids, suspended solids (generally less than 50 μm), and buoyant suspended solids from fermentation.

The process 100 sends the CDS 130 (AAFCO 2017 Official Publication at 27.7) from the one or more evaporators 128 to become combined with the fiber 109 (AAFCO 2017 Official Publication at 48.2) from SMS 108 to produce fiber and CDS product 132. This may also be referred to as a fiber & syrup product.

In various embodiments, the process 100 can send the syrup, which is concentrated having about 20% to about 70% by weight of total solids, to be sold as CDS 130 (AAFCO 2017 Official Publication at 27.7). This may be sold at a very low price. The CDS 130 may contain fermentation byproducts, moderate amounts of fat, spent yeast cells, phosphorus, potassium, sulfur, and other nutrients. The moisture content for the CDS 130 may range from about 55% to about 80%.

In various embodiments, the process 100 may send a stream from the one or more evaporators 128 to a process for oil recovery 134, which removes oil from fractionated stillage 124 to recover oil. As a result, the process 100 produces a product of oil 136 of back-end oil and solids. The process 100 may send solids, water, and the like from the oil recovery 134 back to the one or more evaporators 128 for further processing, in accordance with various embodiments. As described further herein, oil can be recovered during evaporation of the fractionated stillage 124 (e.g., oil recovery 134) and through the densification and oil extraction of an animal feed (e.g., oil recovery 154 of one or more of DDGS 146, DDG 142, Hi-Pro 140, Enrich Yeast Hi-Pro 144, via liquid extraction system 200), in accordance with various embodiments. In this regard, any solids or solids-based mixture produced during the process 100 could be sent through the liquid extraction system 200 and would be within the scope of this disclosure.

Returning to FOT 122, the process sends a cake stream 122A to the one or more dryers 138. The one or more dryers 138 are dryers for removing moisture from the feed products. The process 100 dries these materials via the one or more dryers 138 to create a very high protein product, Hi-Pro 140 having protein content ranging from approximately 46% to approximately 64% dry basis. The process 100 may receive a yeast enriched stream 126 from the fractionated stillage 124 to be combined with material from FOT 122 to create an Enrich Yeast Hi-Pro 144, which is dried animal feed product, that is yeast enriched and has high protein over 46%. The yeast may be approximately 25% based on mass balance calculations. The process 100 also blends fiber and syrup from SMS 108 and some very high protein from Hi-Pro 140 together to achieve 26% protein content for dried distillers' grains (“DDG”) 142. The process 100 combines individual ingredients of fiber 109 from SMS 108, CDS 130 from the one or more evaporators 128, high protein feed product (e.g., Hi-Pro 140) from FOT 122 and yeast enriched stream 126 from the fractionated stillage 124 to create dried distiller grains with solubles (“DDGS”) 146.

In various embodiments, as described further herein, the DDGS 146 is sent through a liquid extraction system 200 (e.g., an oil extraction system). Although described herein with respect to extracting oil from the DDGS 146, the present disclosure is not limited in this regard. For example, the liquid extraction system 200 can be utilized to extract oil from DDG 142, Hi-Pro 140, and/or Enrich Yeast Hi-Pro 144 and still be within the scope of this disclosure. Similarly, the liquid extraction system 200 can be utilized with various other applications for extracting a liquid and/or densifying a fibrous mixture and would still be within the scope of this disclosure. For example, the liquid extraction system 200 can be utilized after a press (e.g., a rotary press, a screw press, a plate press, belt press, or any other press that may be readily apparent to one skilled in the art) in the SMS 108 to increase the dry matter of the fiber cake to the dryer above the current 40% limit, in accordance with various embodiments.

At a discharge of one of the one or more dryers 138 (or at a discharge of the one or more evaporators 128), where one of the feed material (e.g., DDGS 146, DDG 142, Hi-Pro 140, Enrich Yeast Hi-Pro 144, CDS 130, the fiber and CDS product 132, or the like) is no lower than 160° F. (71° C.), the dried feed material is sent to a liquid extraction system 200 (e.g., a piston extruder oil extraction system). In various embodiments, the one or more dryers 138 heats a feed material that is received therein between 160° F. (71° C.) and 220° F. (104° C.), or approximately 190° F. (88° C.). However, the present disclosure is not limited in this regard, and any drying temperature that may be readily apparent to one skilled in the art could be used by the one or more dryers 138 depending on a composition of a material that is received therein, and a desired output material into the liquid extraction system 200.

In various embodiments, a hot feed material (e.g., the dried feed material) from the one or more dryers 138 in the ethanol plant 10 can be dropped (e.g., via a door) or conveyed (e.g., via a screw) from the one or more dryers 138 into the liquid extraction system 200.

The dried feed can be heated to decrease the force/pressure to compress and reform the feed by extrusion. The reformed feed passes into a forming zone to maintain the extruders formed shape. Once formed the material will pass through a cooling zone. The cooling zone will help stabilize the feed and keep it from extruding through the oil leach openings. The stabilized shape will then enter the oil extraction zone. In the oil extraction zone one or more openings on one or more walls can allow for oil to leach from the feed material. The extraction zone may contain mechanical adjustments to narrow the height or width as oil is leached to maintain a pressure between 100-1500 PSIG. The leached oil can be recovered (e.g., oil recovery 154), which can be combined with the product of oil 136 of back-end oil and solids as described previously herein. At the discharge, the formed material (e.g., densified animal feed 152) can either be stacked to make blocks for pelleting or crumbled or cut for hopper car transportation or silo storage, as described further herein.

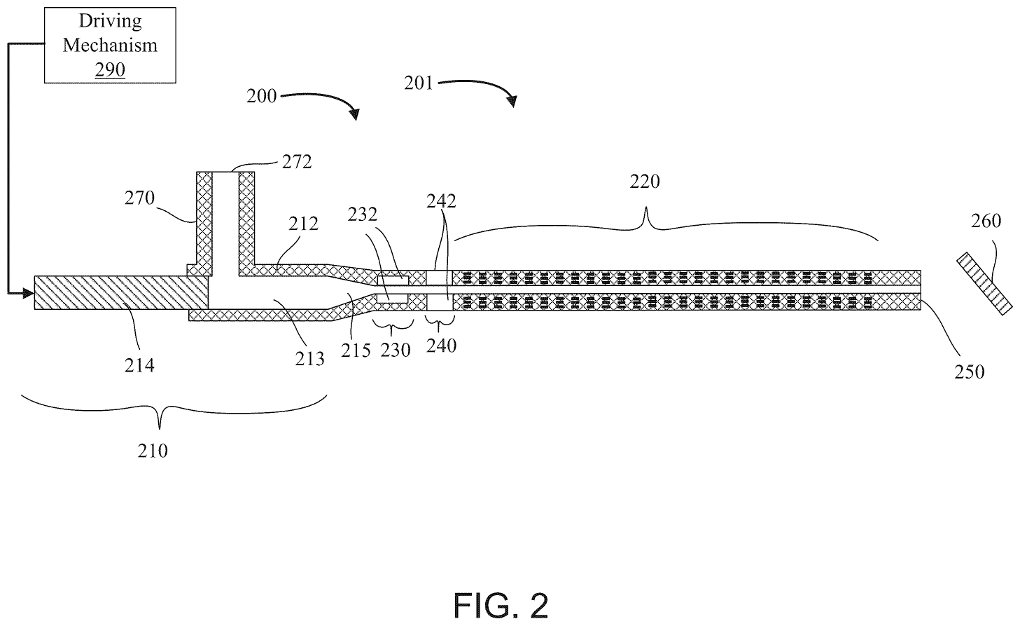

Referring now to FIG. 2, a schematic view of an extruder device 201 of a liquid extraction system 200 is illustrated, in accordance with various embodiments. The extruder device 201 is configured to simultaneously densify a fibrous mixture (e.g., a dried animal feed or any other fibrous mixture) and extract one or more liquids (e.g., water, oil, solubles in the water, micro particulates, or any other liquid known in the art) during the densification. Although described herein as being utilized in an ethanol plant for densifying a dried animal feed (e.g., dried distillers' grains with solubles (DDGS), dried distillers' grains (DDG), grain distillers dried yeast, oilseeds, or any other dried animal feed type products), the present disclosure is not limited in this regard. For example, the extruder device 201 disclosed herein could be utilized for densifying any fibrous material, whether from nature, or man-made, where a portion of the fibrous material is made up of a liquid. Stated another way, the extruder device 201 can be utilized for extracting a liquid from any fibrous material, and in the process of extracting the liquid, densify that fibrous material to form a densified fibrous material. For example, the extruder device 201 can be utilized for removing additional water from a front-end fiber extraction system (e.g., from SMS 108 in FIG. 1), removing liquid (e.g., oil, sweat, etch.) from textiles (e.g., shop rags at a car repair), extracting (or squeezing) water from wood chips or sawdust, removing juice from fruit/pulp, extracting liquid sugar from sugarcane, squeezing excess resin from oriented strand board (OSB) wood pulp, or any other application where extracting liquid from within a solid is desirable that may be readily apparent to one skilled in the art.

The extruder device 201 comprises a driving mechanism 290, a piston pump section 210, and a liquid extraction section 220. The piston pump section 210 comprises a housing assembly 212 and a piston 214. The housing assembly 212 comprises a chamber 213 (e.g., a piston pump chamber) disposed therein. The liquid extraction section 220 is coupled to the piston pump section 210. The liquid extraction section 220 is disposed downstream of the piston pump section 210 and configured to receive a fibrous mixture from the piston pump section 210 during operation of the extrusion, as described further herein. The driving mechanism 290 is configured to drive the piston 214 at least partially through the chamber 213 of the piston pump section 210 during operation of the extruder device 201. In this regard, the driving mechanism 290 can comprise any driving mechanism known in the mechanical arts, such as a hydraulic pump, a lever arm, a wheel and crank arrangement, an electromagnet compressor, a pneumatic compressor, a steam engine, a steam turbine, or a flywheel. The present disclosure is not limited in this regard. In various embodiments, in a dual piston arrangement, as described further herein, a portion of the driving mechanism 290 can comprise one or more gears to provide a mechanical advantage from a first piston that is returning to a second piston that is pushing the fibrous mixture through the chamber 213, and subsequently the liquid extraction section 220.

In various embodiments, the extruder device 201 can further comprise a heating section 230 and/or a cooling section 240. The heating section 230 can be disposed adjacent to the liquid extraction section 220 (e.g., upstream from the liquid extraction section 220). The cooling section 240 can be disposed adjacent to the liquid extraction section 220 (e.g., downstream from the liquid extraction section 220) and a discharge end 250 disposed adjacent to the cooling section 240. In this regard, during operation of the extruder device 201, the heating section 230 can be configured to heat a fibrous mixture (e.g., a dried animal feed or any other fibrous mixture) prior to the fibrous mixture entering the liquid extraction section 220 to sanitize the fibrous mixture. In various embodiments, if extruder device includes a heating section 230 prior to the liquid extraction section 220, a cooling section 240 can be included thereafter to sterilize the fibrous mixture prior to the fibrous mixture entering the liquid extraction section. In this regard, if the fibrous mixture remains heated (e.g., to temperatures above 200° F. (93° C.)) upon entering the liquid extraction section 220, there could be a risk that solids may also be extruded out in the liquid extraction section 220. Accordingly, when a heating section 230 is utilized, a cooling section 240 can be immediately thereafter to facilitate sterilization and reduce the risk of solids extruding out in the liquid extraction section 220, in accordance with various embodiments. Although illustrated with the heating section 230 and the cooling section 240, the present disclosure is not limited in this regard. For example, the fibrous mixture could naturally cool prior to entering the liquid extraction section 220 (e.g., in an embodiment without the heating section 230 and without the cooling section 240), or the fibrous mixture could be cooled by the cooling section 240 (e.g., in an embodiment without the heating section 230), and these embodiments would still be within the scope of this disclosure.

Although illustrated as the cooling section 240 being separate and distinct from the liquid extraction section 220, the present disclosure is not limited in this regard. For example, the cooling section 240 can overlap with the liquid extraction section 220, in accordance with various embodiments. In this regard, the cooling section 240 can continue to sterilize the fibrous mixture as the fibrous mixture traverses through the liquid extraction section. The cooling section 240 can be configured to end a sterilization process that is started by the heating section 230. Accordingly, as referred to herein, “adjacent” refers to being next to, or overlapping with, another section.

In various embodiments, upon completion of the sterilization of the fibrous mixture, the cooling section 240 can cool the fibrous mixture prior to densification, allowing the fibrous mixture to settle into a more solidified form prior to densification, as described further herein. Although described herein as including the heating section 230 and the cooling section 240, the present disclosure is not limited in this regard. For example, products that do not have to be sterilized (or sanitized), such as particle board or cement, could utilize an extruder device 201 without the heating section 230 and the cooling section 240, and would still be within the scope of this disclosure. Similarly, in various embodiments, the fibrous mixture could be sanitized prior to entering the extruder device 201, and the heating section 230 and the cooling section 240 could be eliminated in such a configuration.

In various embodiments, the heating section 230 comprises one or more heating elements 232. For example, the one or more heating elements 232 can comprise an electric heater, a forced air heater, a first heat exchanger, a steam heater, an induction heater, a radiation heater, a forced water heater, or a water heater. The present disclosure is not limited in this regard, and various potential heating elements would be readily apparent to one skilled in the art.

In various embodiments, the cooling section 240 comprises one or more cooling elements 242. For example, the one or more cooling elements 242 can comprise a fan, a second heat pump, cooling fins with a convection blower, or a second heat exchanger. The present disclosure is not limited in this regard. In various embodiments, a heat pump could be utilized where a first heat exchanger (e.g., a condenser or an evaporator) of the heat pump is used for the heating section 230, and a second heat exchanger (e.g., another of the condenser and the evaporator) is used for the cooling section 240. Various heating and cooling arrangements would be apparent to one skilled in the art and are within the scope of this disclosure.

In various embodiments, the extruder device 201 further comprises a breaker 260 spaced apart from the discharge end 250. The breaker 260 is configured to break a densified fibrous mixture (e.g., a densified dried animal feed) that is discharged from the discharge end 250. In this regard, the breaker 260 can be configured based on a desired end form for the densified fibrous mixture (e.g., a sheet of densified fibrous mixture configured to be palletized, pellets for bulk shipping, or any other final form). In various embodiments, the breaker 260 is configured to break a densified fibrous mixture into a sheet of the densified fibrous mixture. In this regard, a plurality of sheets can be stacked together on a pallet for shipping via palletized shipping, which can greatly reduce shipping costs, and facilitate a longer shelf life for a densified dried animal feed, as described further herein. Although illustrated with the breaker 260, the present disclosure is not limited in this regard. For example, the densified fibrous mixture could be broken manually at the discharge end 250, or after the discharging of the densified fibrous mixture, and would still be within the scope of this disclosure.

In various embodiments, the housing assembly 212 of the extruder device 201 further comprises a feed spout 270. The feed spout 270 can comprise an inlet 272 that is fluidly coupled to the chamber 213 of the piston pump section 210. Although illustrated with a feed spout 270, the present disclosure is not limited in this regard. For example, an outlet of a dryer can be directly coupled to the chamber 213 of the piston pump section 210 and would still be within the scope of this disclosure.

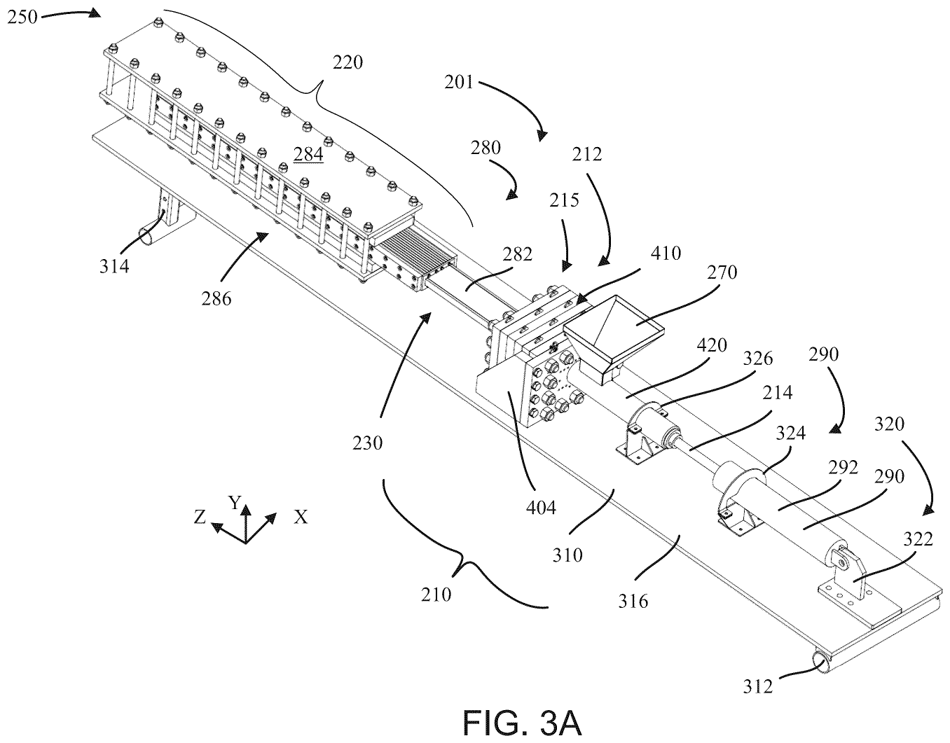

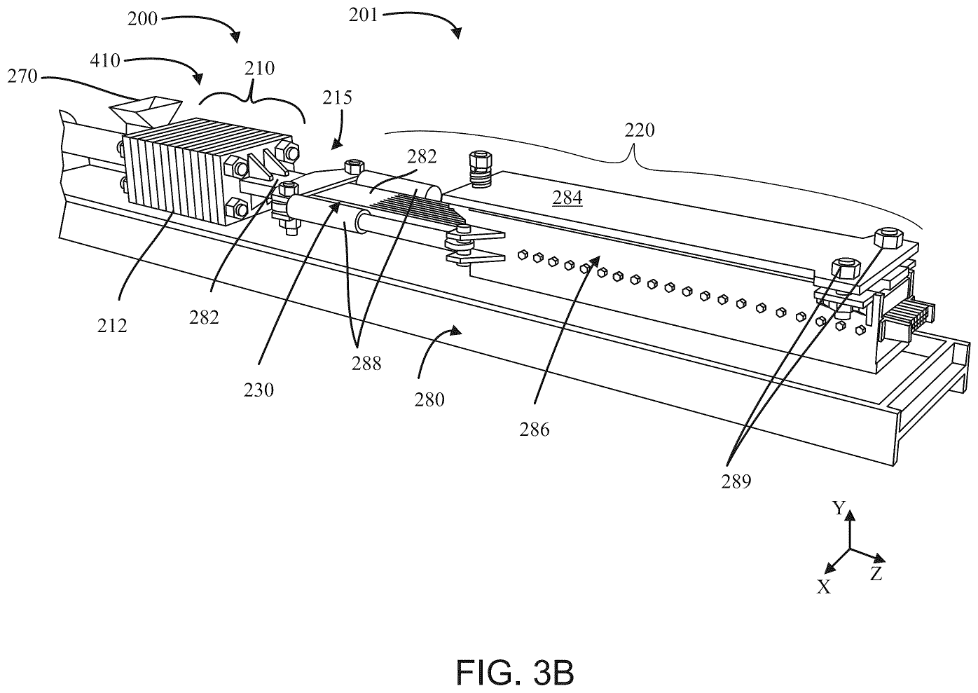

Referring now to FIGS. 3A and 3B, a perspective view of the extruder device 201 of the liquid extraction system 200 is illustrated with like numerals depicting like elements, in accordance with various embodiments. In various embodiments, the liquid extraction section 220, the piston pump section 210, and the driving mechanism 290 can each be coupled to a support structure 280. With reference now to FIG. 3A, the liquid extraction system 200 can comprise a base 310. The base 310 can comprise one or more supports (e.g., a first support leg 312 and a second support leg 314), and a platform 316. The base 310 is configured to support the extruder device 201. Although illustrated as including the base 310, the present disclosure is not limited in this regard. For example, the extruder device 201 can be installed directly in a respective plant or facility (e.g., ethanol plant 10 from FIG. 1), and would still be within the scope of this disclosure.

In various embodiments, one of the supports of the base 310 (e.g., second support leg 314) can be adjustable. In this regard, an end of the base 310 (e.g., an end proximate the discharge end 250) can be adjustable, in accordance with various embodiments. By adjusting a height of the discharge end 250 relative to a height at an opposite end (e.g., at the first support leg 312), an angle of the longitudinal axis (i.e., the Z-axis) of the flow path for a fibrous mixture that traverses through the extruder device 201 can be adjusted relative to a horizontal plane (e.g., a ground plane). In this regard, a drain angle of liquid being extracted can be adjusted by adjusting a height of the second support leg 314, in accordance with various embodiments, as described further herein.

In various embodiments, various components of the extruder device 201 are coupled to the platform 316 of the base 310. For example, the driving mechanism 290 can comprise an actuator housing 292 coupled to the platform 316 by one or more structural supports 320 (e.g., a mount 322 and a support 324), and the housing assembly 212 of the piston pump section 210 can be coupled to the platform 316 of the base 310 by one or more supports (e.g., a gusset 404 coupling a plurality of plates 410 of the housing assembly 212 to the platform 316 on each lateral side, and a support 326 coupling a fluid conduit 420 of the housing assembly 212 to the platform 316). The driving mechanism 290 can be configured to drive (i.e., actuate) the piston 214 in a cyclical manner into the housing assembly 212 of the piston pump section 210, in accordance with various embodiments. The mount 322, the support 324, the support 326, and the gusset 404 on each lateral side of the plurality of plates 410 can ensure that the piston 214 remains aligned and structurally secure during operation of the extruder device 201, in accordance with various embodiments.

In various embodiments, the housing assembly 212 of the piston pump section 210 comprises the plurality of plates 410 and the fluid conduit 420 (e.g., a feed conduit). The plurality of plates 410 can be stacked in a longitudinal direction (i.e., the Z-direction). In various embodiments, the longitudinal direction is defined by a direction that the fibrous material (e.g., a dried animal feed) traverses through the extruder device 201. In various embodiments, by having a forming section of the housing assembly 212 (i.e., a section that may be susceptible to high pressures and significant wear) constructed from a plurality of plates 410 that are stacked to form the chamber 213 from FIG. 2, a manufacturing cost can be significantly reduced (e.g., relative to a cast or machined housing) and maintenance of the housing assembly 212 can be simplified.

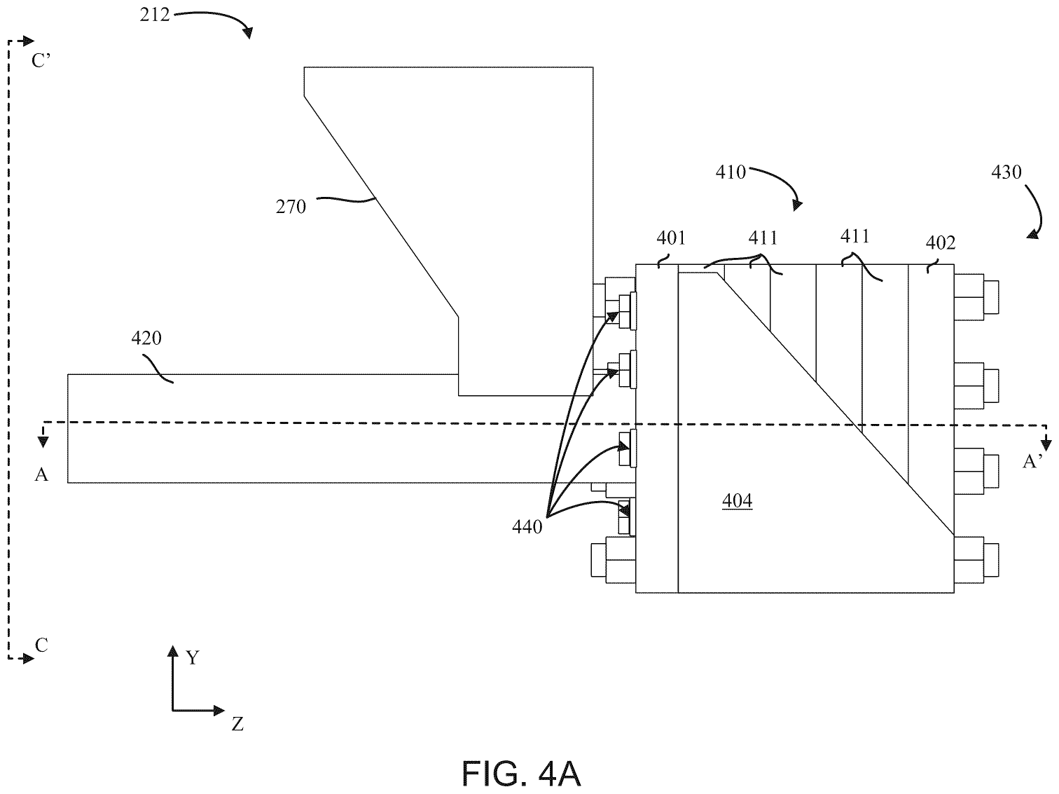

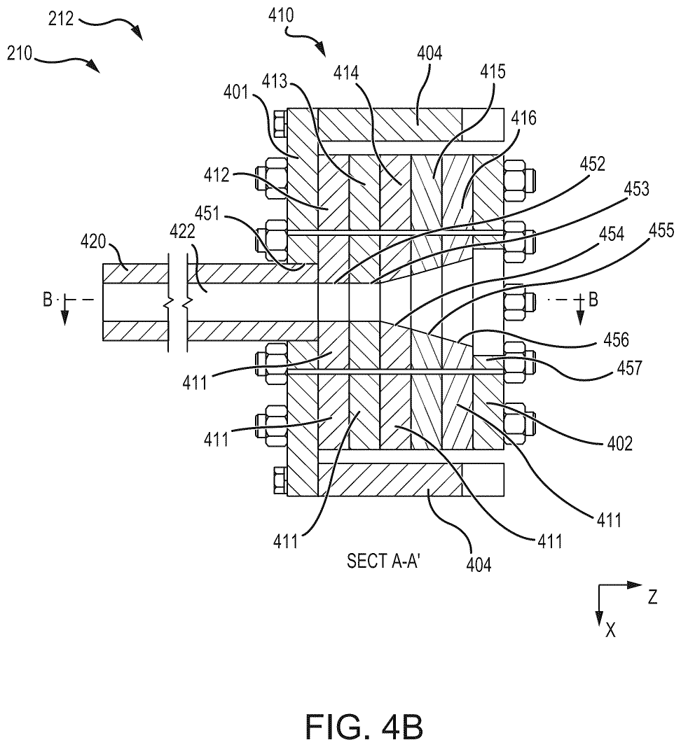

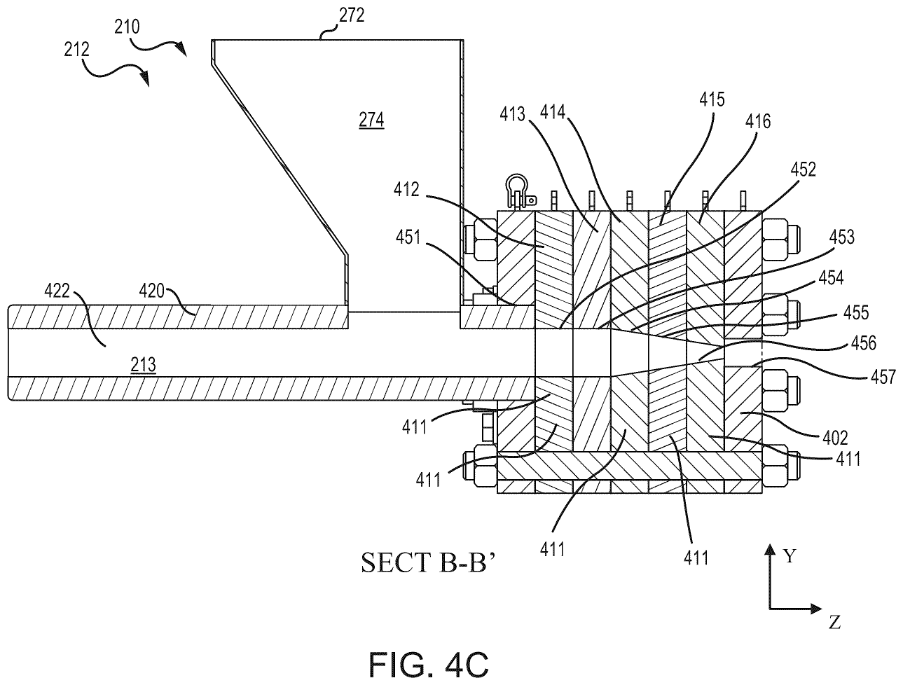

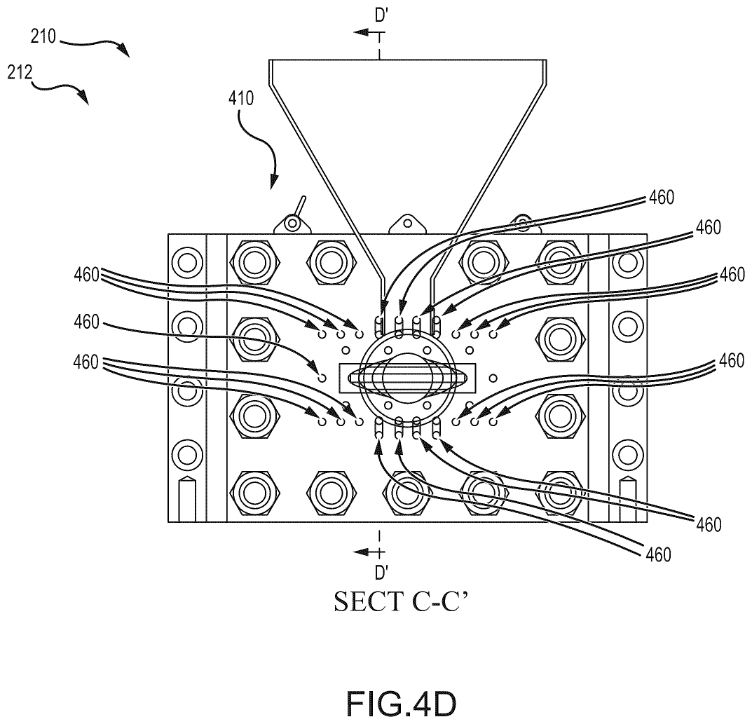

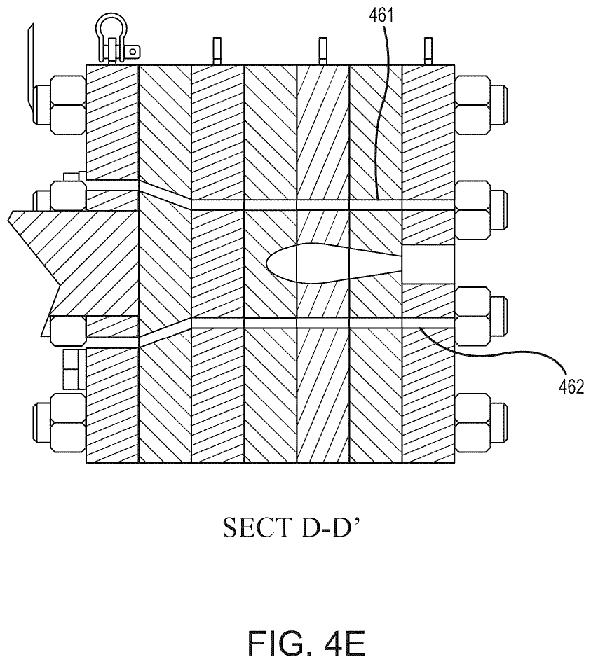

For example, with reference now to FIG. 4A, a side view of the housing assembly 212 that includes a plurality of plates 410 stacked together in the longitudinal direction (i.e., the Z-direction from FIGS. 3A and 3B) is illustrated, in accordance with various embodiments. In various embodiments, the housing assembly 212 comprises the plurality of plates 410, a fluid conduit 420, and a feed spout 270. Although illustrated as including a feed spout 270, the present disclosure is not limited in this regard. For example, as described further herein, the extruder device 201 can comprise any arrangement for feeding a fibrous mixture into the chamber 213 from FIG. 2, such as a screw conveyor, or any other fluid conduit adaptable to deliver a fibrous mixture from one location to another and be within the scope of this disclosure.

In various embodiments, the plurality of plates 410 comprise a front plate 401, an end plate 402, and a plurality of middle plates 411. The plurality of plates 410 are coupled together by a compressive force in the longitudinal direction (i.e., the Z-direction). For example, the housing assembly 212 can comprise a fastener arrangement 430 (e.g., bolt and nut, stud and dual nuts, bolt and nutplate, clamp, or any other fastener arrangement that may be readily apparent to one skilled in the art) configured to generate a compressive force between adjacent plates in the plurality of plates 410 and form a forming section (e.g., reforming section 215 of the housing assembly 212 from FIG. 2). Although described herein as including a piston pump section 210 with at least a portion of the housing assembly 212 formed from a plurality of plates 410 stacked together, the present disclosure is not limited in this regard. For example, a cast piston housing formed from a unitary piece of material, a machined piston housing, a piston housing formed from additive manufacturing, or any other type of piston housing known in the art could be utilized, and would still be within the scope of this disclosure. In this regard, such a configuration could be utilized with the liquid extraction section 220 of the extruder device 201 from FIGS. 3A and 3B and, as described further herein, would still be within scope of this disclosure. However, such a configuration would not allow for quick and efficient maintenance responsive to wear or damage to the housing assembly 212, in accordance with various embodiments.

In various embodiments, a gusset 404 can be disposed on each lateral side (i.e., opposite sides in the X-direction) of the housing assembly 212. In this regard, the gusset plate 404 can couple the housing assembly 212 to the platform 316 of the base 310 from FIG. 3A. Thus, the housing assembly 212 can be structurally supported by the platform 316 relative to the piston 214 from the piston pump section 210 from FIG. 2, in accordance with various embodiments. An array of bolts 440 (or any other fastener that may be readily apparent to one skilled in the art) can couple the front plate 401 to the gusset plate 404 and, similarly, an array of bolts (or any other fastener arrangement that may be readily apparent to one skilled in the art) could couple a bottom side of the gusset plate 404 to the platform 316 from FIG. 3A. In various embodiments, such an arrangement could provide significant structural stability to the remaining plates of the plurality of plates 410 during operation of the extruder device 201. However, the present disclosure is not limited in this regard, and various structural arrangements for coupling the housing assembly 212 to the base 310 from FIG. 3A would be within the scope of this disclosure. For example, each of the plurality of plates 410 could be individually coupled to the platform (e.g., from a top side through the bottom side), a plate could be disposed across the top side and the plate could create a compression force in the vertical (i.e., Y-direction) to couple the housing assembly 212 to the base, or any other coupling arrangement that may be readily apparent to one skilled in the art could be utilized, and would still be within the scope of this disclosure.

With brief reference to FIG. 4B, where a cross-sectional view along section line A-A′ from FIG. 4A is illustrated, the fluid conduit 420 can be coupled to at least one of the plurality of plates 410 (e.g., front plate 401). In various embodiments, each of the plurality of plates 410 comprises an opening (e.g., opening 451 for front plate 401, opening 452 for middle plate 412, opening 453 for middle plate 413, opening 454 for middle plate 414, opening 455 for middle plate 415, opening 456 for middle plate 416, and opening 457 for end plate 402). In various embodiments, the chamber 213 includes a feed section that extends from an outlet of the feed spout 270 from FIG. 4A into the internal cavity 422 of the fluid conduit 420, a compression section, and a reforming section. The compression section (e.g., defined at least partially by the openings 452, 453 of middle plates 412, 413) can extend from the feed section to the reforming section (e.g., defined at least partially by the openings 454, 455, 456 of the middle plates 414, 415, 416). The reforming section can be output into a discharge section (e.g., opening 457 of end plate 402), which can discharge a reformed fibrous mixture into the adjacent section (e.g., a cooling section 240 from FIG. 2 or a heating section 230 followed by a cooling section 240), in accordance with various embodiments. Although defined as having different sections (e.g., feed section compression section, and reforming section) the housing assembly 212 is not limited by these designations. For example, the fibrous mixture experiences compression in the feed section as well as the compression section and the reforming section, in accordance with various embodiments. Stated another way, the various sections in the housing assembly 212 can have overlapping functions, in accordance with various embodiments.

Although each of the plurality of plates 410 are separate and distinct components, the housing assembly 212 can be configured with an air-tight fluid conduit for the chamber 213, in accordance with various embodiments. For example, in various embodiments, the housing assembly 212 could be fabricated in such a manner that the internal working chamber (i.e., chamber 213) is welded internally at each plate connection (e.g., between opening 452 and opening 453, between opening 453 and opening 454, between opening 454 and opening 455, between opening 455 and opening 456, and between opening 456 and opening 457) via a laborer or an automated welding arm as the plates are assembled layer by layer. In this regard, this method of fabrication would produce an airtight working chamber capable of withstanding high pressures, in accordance with various embodiments.

With brief reference now to FIG. 4C, a cross-sectional view of the housing assembly 212 of the piston pump section 210 along section line B-B′ from FIG. 4B is illustrated, with like numerals depicting like elements, in accordance with various embodiments. In various embodiments, the feed spout 270 of the piston pump section 210 further comprises a feed chamber 274. In various embodiments, the inlet 272 can comprise a funnel (e.g., decreasing in cross-sectional area) to funnel a fibrous mixture (e.g., dried animal feed or any other fibrous product) into the feed chamber 274. Once the fibrous mixture is deposited into the feed chamber 274, the piston 214 can be driven by the driving mechanism 290 from FIGS. 2 and 3A to push the fibrous mixture through the plurality of plates 410 of the housing assembly 212, in accordance with various embodiments.

With combined reference now to FIGS. 4B and 4C, the openings for each of the plurality of plates 410 from the compression section (e.g., middle plate 412 and middle plate 413) can comprise a common cross-sectional profile. In various embodiments, the openings for each of the plurality of plates 410 from the reforming section (e.g., openings 454, 455, 456 for middle plates 414, 415, 416) can comprise a varying cross-sectional profile. In various embodiments, a cross-sectional area of the cross-sectional profile of the reforming section (e.g., corresponding to the openings 454, 455, 456 for the middle plates 414, 415, 416) decreases as the reforming section extends from forward to aft (i.e., from the feed section to the discharge section). In this regard, although the cross-sectional profile of the openings 454, 455, 456 in the reforming section expands in the lateral direction as the openings 454, 455, 456 extend longitudinally (i.e., in the Z-direction) from the feed section (e.g., an outlet of the fluid conduit 420) to the discharge section (e.g., an inlet of the end plate 402), a vertical height of the openings 454, 455, 456 narrows such that the cross-sectional area of the openings 454, 455, 456 decreases as the reforming section extends from forward to aft. Due to the decrease in cross-sectional area, the fibrous mixture traversing therethrough is compressed, reformed, and output to the discharge end of the housing assembly 212 into a reformed shape that corresponds to a cross-sectional profile of a desired end shape (e.g., a substantially rectangular shape).

Stated another way, the internal cavity 422 of the fluid conduit 420 is configured to receive a fibrous mixture from an adjacent section (e.g., from a feed spout 270 as shown in FIGS. 2, 3A, 3B, and 4A) and a piston 214 from FIG. 2 to drive the fibrous mixture therethrough. In this regard, the internal cavity 422 of the fluid conduit 420 comprises a cross-sectional profile having a complimentary shape to a piston (e.g., piston 214 from FIG. 2). The piston 214 can traverse from outside the chamber 213 from FIG. 2 through the internal cavity 422 of the fluid conduit 420 and push a fibrous mixture that is received from the feed spout 270 into the chamber 213 of the housing assembly 212, and eventually through the chamber 213, as described further herein. Although illustrated with a single chamber (e.g., internal cavity 422 and openings 452, 453), for receiving the piston 214 from FIG. 2 and a respective fibrous mixture, the present disclosure is not limited in this regard. For example, as described further herein, the piston pump section 210 from FIG. 2 can comprise more than one piston with corresponding chambers (e.g., at least two pistons with corresponding chambers, a piston with a plurality of piston rods where each piston rod has a corresponding chamber, or a combination of the two) and would still be within the scope of this disclosure. In various embodiments, the piston 214 from FIG. 2 does not extend past that compression section. In this regard, since the reforming section is decreasing in cross-sectional area, the piston cannot extend into the reforming section of the housing assembly 212, in accordance with various embodiments.

Based on the construction of the housing assembly 212 (i.e., each of the plurality of plates having a flat plate construction with simplified machined features), if any of the plurality of plates 410 is damaged, or experiences significant wear relative to a remainder of the plurality of middle plates 411, the damaged (or worn) plate can be replaced without having to replace the housing assembly 212 entirely. Stated another way, some of the plurality of plates 410 may wear faster than other of the plurality of plates 410. In such a scenario, the plate that is overly worn can be replaced without replacing the remainder of plates, in a quick and efficient manner, and at much lower cost relative to replacing the housing assembly 212 in its entirety. Similarly, if multiple of the extruder device 201 from FIG. 2 are utilized in a single plant, based on wear of certain plates in the plurality of plates 410, the housing assembly 212 of different extruder devices can be rearranged based on wear to optimize for life of the housing assembly 212, in accordance with various embodiments.

With continued reference to FIGS. 4B and 4C, the end plate 402 can have a different cross-sectional profile relative to the remaining of the plurality of plates 410 to output the fibrous mixture from the piston pump section 210 from FIGS. 2 and 3 into an adjacent section (e.g., a heating section, a cooling section, a liquid extraction section, and/or a combination of any of these sections). In various embodiments, the end plate 402 comprises an opening 457 that is substantially rectangular in shape. In various embodiments, the opening 457 can correspond to a cross-sectional profile of a sheet of densified fibrous matrix that is formed from the extruder device 201 from FIGS. 2, 3A, and 3B. In various embodiments, at the outlet of the reforming section (e.g., the inlet of opening 457), the cross-sectional area increases to a cross-sectional profile corresponding to the sheet of the densified fibrous material that is desired (e.g., a sheet for palletizing as described further herein). In this regard, the fibrous mixture is compressed throughout the reforming section 215 and then expands as the fibrous mixture is output to a pre-liquid extraction section (e.g., a heating section 230, a cooling section 240, or a combination of a heating section 230 followed by a cooling section 240). In various embodiments, a reforming section can be defined within the chamber 213 of the piston pump section 210.

In various embodiments, only some of the openings from the plurality of plates 410 form the chamber 213 from FIG. 2. For example, the opening 451 of the front plate 401 can be configured to receive the fluid conduit 420 and be coupled thereto (e.g., via a radial compressive force or any other coupling mechanism that may be readily apparent to one skilled in the art). In this regard, the opening 451 of the front plate 401 may not form a portion of the chamber 213. However, the present disclosure is not limited in this regard. For example, the fluid conduit 420 could comprise a fitting, coupling, or any other fluid coupling device, and the front plate 401 could comprise a complimentary fitting, coupling, or any other fluid coupling device, and the opening 451 of the front plate 401 could form a portion of the chamber 213, and such an embodiment would still be within the scope of this disclosure.

Referring now to FIG. 4D, a translucent view of a front view (e.g., along section line C-C′ from FIG. 4A) of the housing assembly 212 is illustrated, in accordance with various embodiments. Accordingly, as shown in FIG. 4D, in combination with FIGS. 4B and 4C, a cross-sectional profile of the openings 452, 453, 454, 455, 456, 457 can be configured to transition from a substantially circular cross-section (e.g., at the opening 452) to a substantially rectangular cross-section (e.g., at the discharge end, or opening 457) by flattening the circular cross-section in a vertical direction and expanding the circular cross-section in a lateral direction, in accordance with various embodiments. However, the present disclosure is not limited in this regard, and various intermediate shapes and starting shapes for the fibrous mixture (e.g., a square shape to a rectangular shape, an ovular shape to a rectangular shape, etc.) may be readily apparent to one skilled in the art, and would be within the scope of this disclosure.

Referring now to FIG. 4E, a cross-sectional view along the section line D-D′ from FIG. 4D is illustrated, in accordance with various embodiments. In various embodiments, the housing assembly 212 comprises at least one drain relief channel (e.g., drain relief channel 461 and/or drain relief channel 462). With combined reference to FIGS. 4D and 4E, the housing assembly 212 can comprise a plurality of drain relief channels 460 that are spaced apart outward from a perimeter of the openings that form the portion of chamber 213 in the plurality of plates 410. In this regard, if any liquid from the fibrous mixture that is being densified by the extruder device 201 escapes during the reformation process (i.e., as the fibrous mixture is traversing through the piston pump section 210), each of the plurality of drain relief channels 460 can be configured to receive that liquid and route the liquid to a respective collection tank as described further herein. In various embodiments, the liquid can potentially escape through adjacent plates in the plurality of plates 410. In various embodiments, channels connecting the chamber 213 from FIGS. 4B and 4C to the plurality of drain relief channels 460 can be formed in the plurality of plates 410.

Referring back to FIG. 3B, at least a portion of the liquid extraction section 220 can be coupled to the piston pump section 210 (e.g., via structural links 288). Although illustrated as being coupled to the liquid extraction section 220 by structural links 288, the present disclosure is not limited in this regard. For example, the piston pump section 210 could be directly coupled to the support structure 280 (e.g., as shown in FIG. 3A) to provide support to the liquid extraction section 220 during operation, in accordance with various embodiments.

With combined reference now to FIGS. 3A and 3B, in various embodiments the extruder device 201 comprises a manifold 282 extending from an outlet of the piston pump section 210 (e.g., the opening 457 of the end plate 402 from FIG. 4C of the housing assembly 212) to an inlet of the liquid extraction section 220, as described further herein. In this regard, the manifold 282 comprises a fluid conduit that fluidly couples the piston pump section 210 to the liquid extraction section 220, in accordance with various embodiments. In various embodiments, the extruder device 201 can further comprise a compression housing 286 at least partially enclosing a portion of the liquid extraction section 220. In various embodiments, the compression housing 286 is configured to provide structural support for a compression arrangement within the compression housing 286, as described further herein. In this regard, in response to traversing through the compression housing 286, a fibrous mixture can be compressed to extract liquid from the respective fibrous mixture, thereby densifying the fibrous mixture, as described further herein.

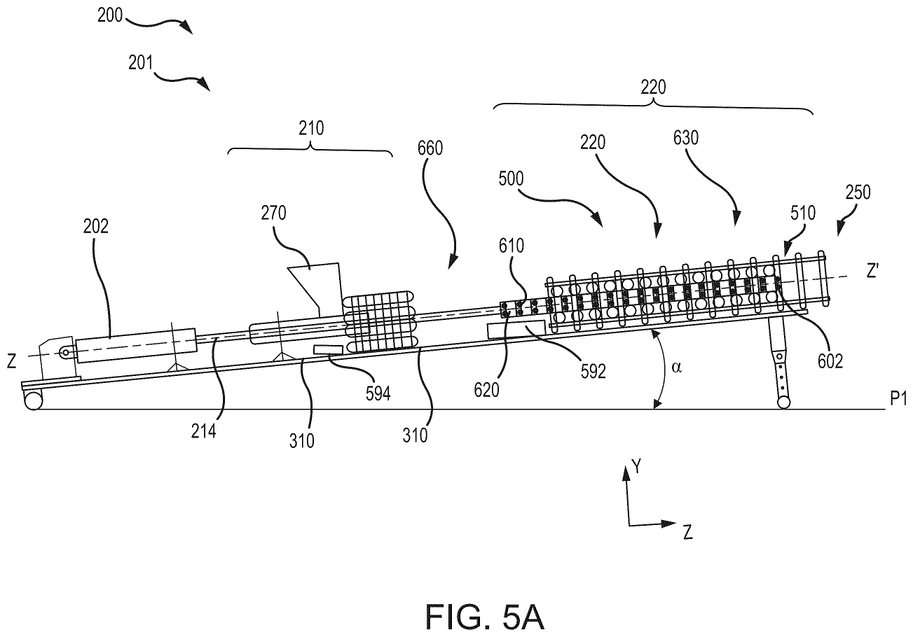

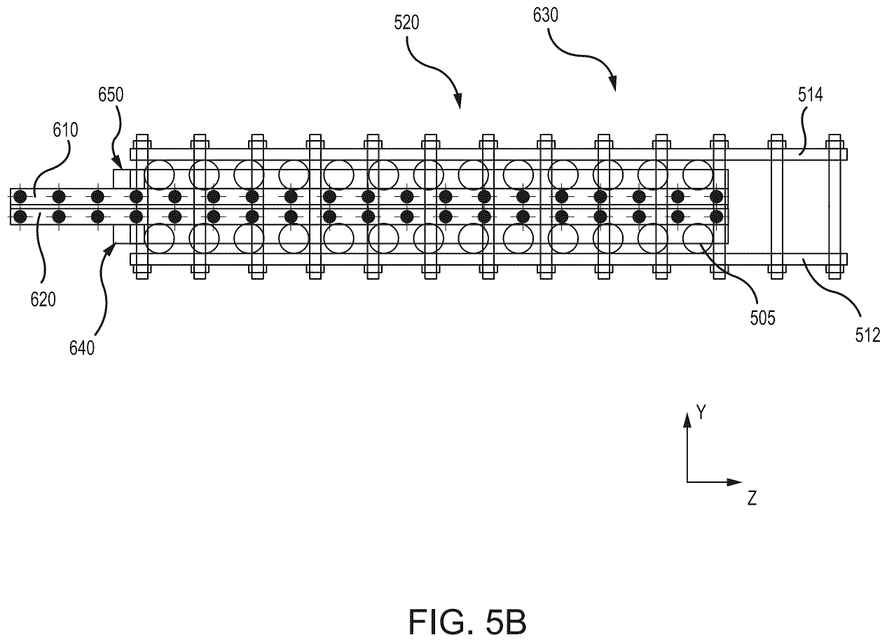

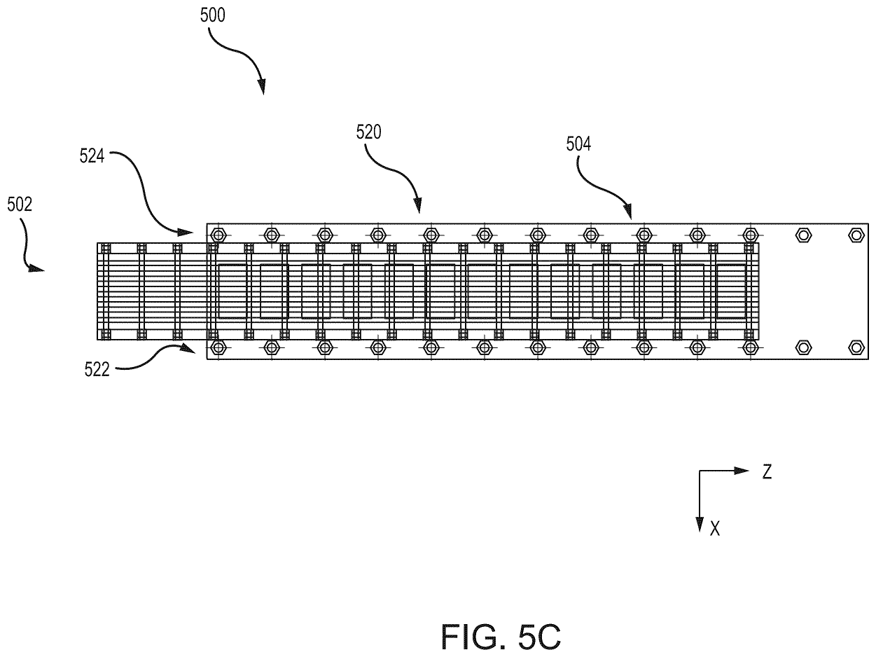

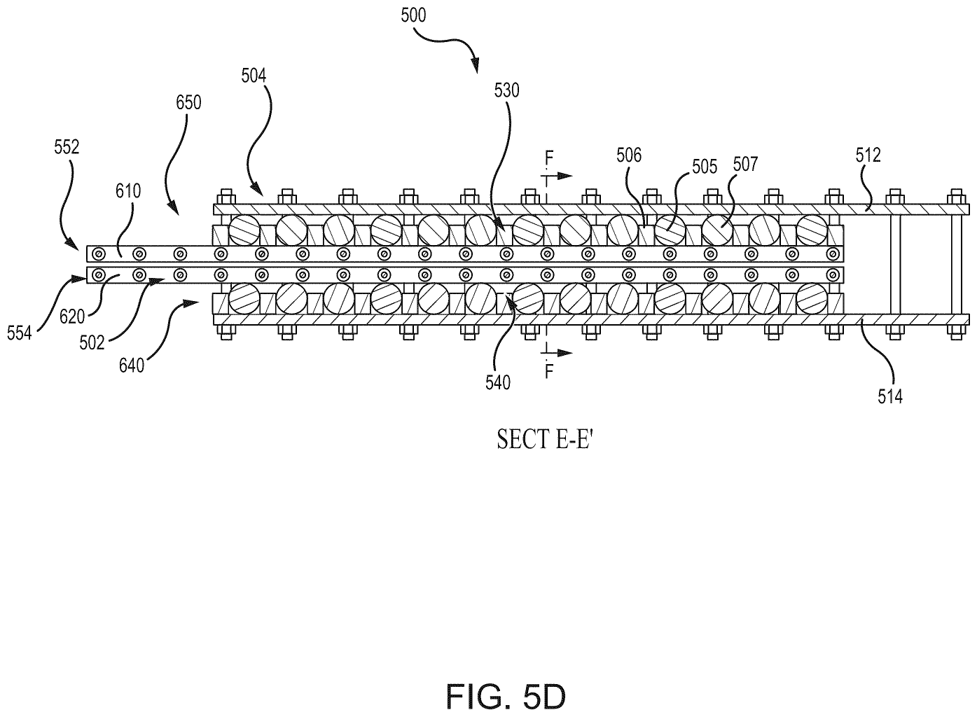

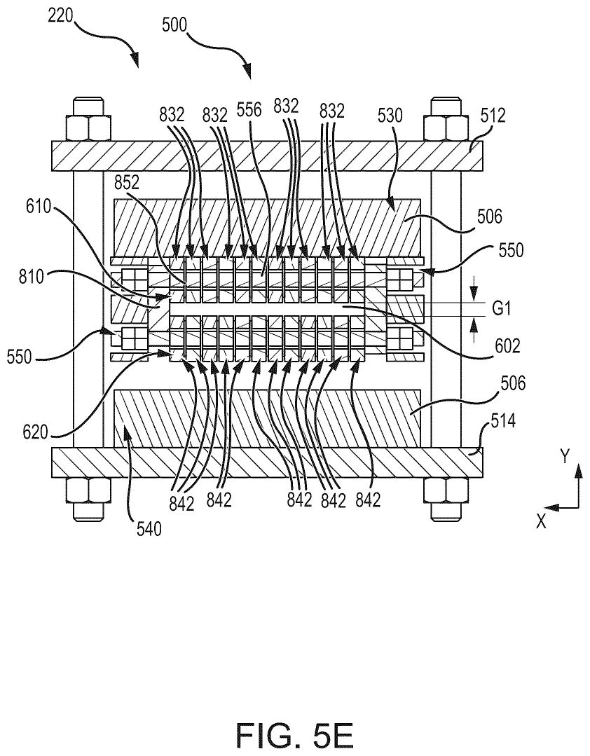

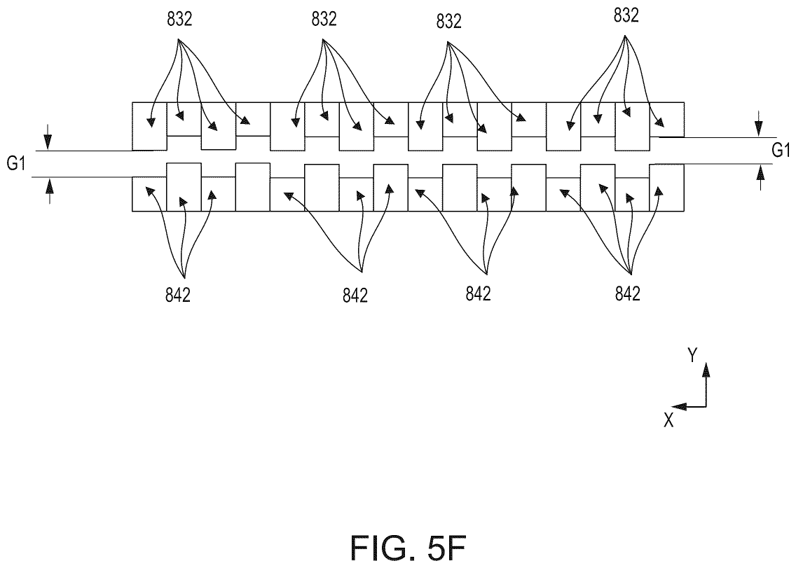

Referring now to FIG. 5A, a translucent side view of the extruder device 201 from FIG. 3A is illustrated with like numerals depicting like elements, in accordance with various embodiments. In various embodiments, the liquid extraction section 220 comprises a liquid extraction assembly 500. The liquid extraction assembly 500 comprises a fixed structure 502 and a moveable structure 504. In this regard, moveable structure 504 is configured to move relative to the fixed structure 502 and supply a compressive force to the fixed structure 502. In various embodiments, in response to the compressive force supplied to the fixed structure 502, a channel 602 that is defined by the fixed structure 502 and configured to receive a fibrous mixture during operation of the extruder device 201, is also compressed in local areas. In this regard, based on the arrangement of the liquid extraction assembly 500, liquid can be extracted as local areas are continually compressed responsive to moving the moveable structure 504 relative to the fixed structure, in accordance with various embodiments.

In various embodiments, the fixed structure 502 comprises a top planar structure 610 and a bottom planar structure 620. In various embodiments, the moveable structure 504 comprises a compression arrangement 630. Although described in FIG. 5A as having the entire compression arrangement 630 as the moveable structure 504, the present disclosure is not limited in this regard. For example, portions of the compression arrangement 630 can be moveable relative to other components of the compression arrangement 630, as described further herein, and are still within the scope of this disclosure.

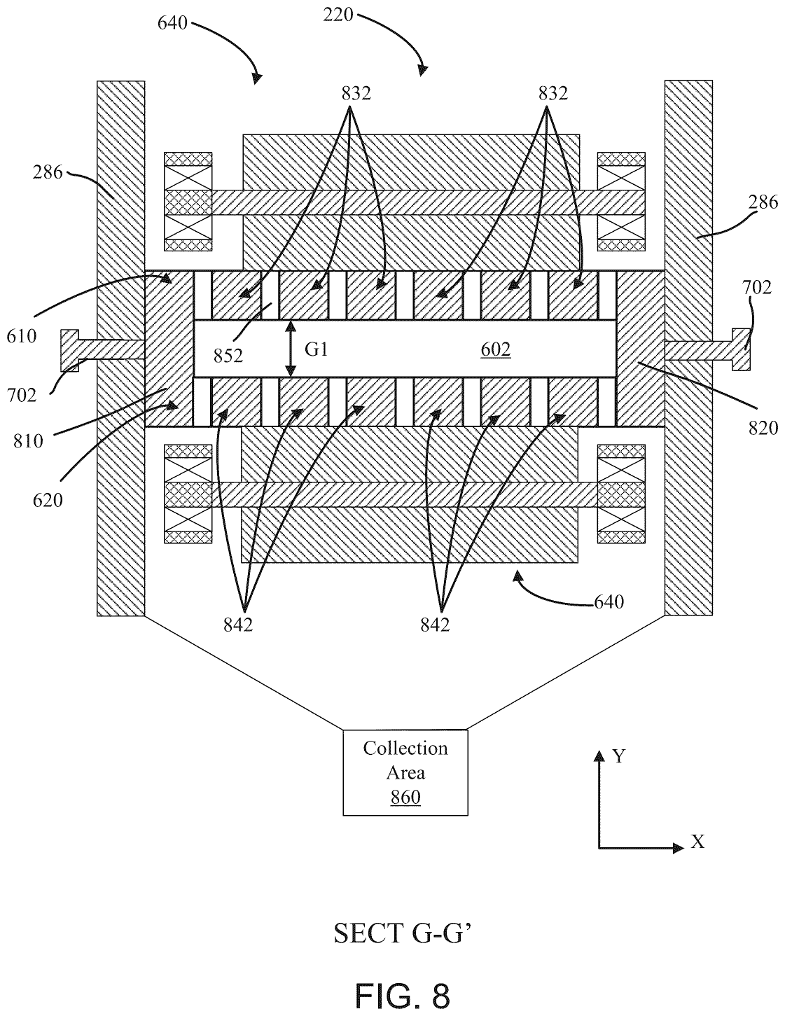

In various embodiments, the top planar structure 610 and the bottom planar structure 620 each comprise one of a mechanical screen or a plurality of rods (e.g., the plurality of rods 832 for the top planar structure 610 or the plurality of rods 842 for the bottom planar structure 620, as shown in FIGS. 5E and 8 and described further herein). In various embodiments, the bottom planar structure 620 can comprise one of the mechanical screens or the plurality of rods, and the top planar structure 610 can be a continuous unitary sheet. The present disclosure is not limited in this regard. In various embodiments, if the top planar structure 610 and/or the bottom planar structure 620 comprise the mechanical screen, the mechanical screen can include a mesh size between 0.001 inches (0.0025 cm) and 0.064 inches (1.6 mm). In various embodiments, if the top planar structure 610 and/or the bottom planar structure 620 comprises the mechanical screen, the mechanical screen can be woven or hole punched. The present disclosure is not limited in this regard. In various embodiments, if the top planar structure 610 and the bottom planar structure 620 comprises the plurality of rods, each of the plurality of rods can have one of a square or rectangular cross-section, each of the plurality of rods can be aligned adjacent to an adjacent of the plurality of rods, as described further herein. In various embodiments, a gap between each of the plurality of rods can be a set gap (i.e., a fixed gap). In this regard, as described further herein, a shim can be disposed between each set of adjacent rods to set the gap therebetween. In various embodiments, the gap can be set locally by the shim, but the gap can vary during operation of the extruder device 201 between shims that are spaced apart in the longitudinal direction. The fixed gap is not meant to be limiting in this regard. In various embodiments, a shim thickness can be between 0.001 inches (0.025 mm) and 0.32 inches (0.8 mm), or about 0.01 inches (0.25 mm).

In various embodiments, the compression arrangement 630 is configured to provide compressive forces in the vertical direction (i.e., the Y-direction). In this regard, the compression arrangement 630 is configured to supply a compressive force to a fibrous mixture that is traversing through a channel 602 that is at least partially defined between the top planar structure 610 and the bottom planar structure 620.

As shown in FIG. 5A, the liquid extraction section 220 is configured to allow liquid that is extracted to flow away from the discharge end 250. For example, the platform 316 of the base 310 can be orientated at an acute angle (e.g., angle α) above a horizontal plane P1, defined by a ground plane. In this regard, in various embodiments, the acute angle (e.g., angle α) allows liquid that is extracted in any section (e.g., in the piston pump section 210 or the liquid extraction section) to flow away from the discharge end 250 and towards a respective collection tank (e.g., collection tank 592 and/or collection tank 594). Although illustrated with two collection tanks in FIG. 5A, any number of collection tanks in combination with plumbing could be utilized and would be within the scope of this disclosure. In this regard, a collection system for collecting the extracted liquid of the extruder device 201 could comprise various plumbing configurations, which could be active (i.e., including a fluid driving system) or passive (i.e., allowing the liquid to drain from gravity), and would be within the scope of this disclosure. In various embodiments, the angle α can be between 0.5 degrees and 90 degrees, or between 0.5 degrees and 75 degrees, or between 1 degree and 60 degrees, or between 1 degree and 45 degrees, or between 1 degree and 30 degrees, in accordance with various embodiments.

In various embodiments, the coordinate system described previously herein (i.e., the X-Y-Z coordinate system) is a coordinate system defined by a longitudinal axis of the extruder device 201 (e.g., axis Z-Z′ in FIG. 5A) that is normal to a plane, which is at an angle relative to a horizontal plane (e.g., plane P1). Stated another way, if the angle α is 0 degrees, the coordinate system X-Y-Z would be a z-direction corresponding to the axis Z-Z′ and a vertical plane (i.e., an X-Y plane) corresponding to a lateral direction of the extruder device 201, and a vertical direction of the extruder device 201 relative to the platform 316.

With reference now to FIG. 5B, a side translucent view of the liquid extraction assembly 500 of the extruder device 201 from FIG. 5A is illustrated, in accordance with various embodiments. In various embodiments, the compression arrangement 630 of the moveable structure 504 comprises a sled 510. The sled 510 is configured to translate forward (i.e., in the positive z-direction) and aft (in the negative z-direction) along the longitudinal axis relative to the top planar structure 610 and the bottom planar structure 620 during operation of the extruder device 201. In this regard, responsive to the translating, a compressive force is applied by the sled 510 to the top planar structure 610 and the bottom planar structure 620.

In various embodiments, the sled 510 comprises a top plate 512, a bottom plate 514, a first set of rollers 640, a second set of rollers 650, and a fastener arrangement 520. In various embodiments, the fastener arrangement 520 is configured to operably couple the sled 510 to the fixed structure 502. For example, with brief reference to FIG. 5C, where a top-down view of the liquid extraction assembly 500 is illustrated in accordance with various embodiments, the fastener arrangement 520 can comprise a first array of fasteners 522 and a second array of fasteners 524. The first array of fasteners 522 can be spaced apart from the second array of fasteners 524 in the lateral direction (i.e., the x-direction). Furthermore, each of the first array of fasteners 522 can be spaced apart from each other in the longitudinal direction (i.e., the Z-direction), and each of the second array of fasteners 524 can be spaced apart from each other in the longitudinal direction. Although illustrated as having the first array of fasteners 522 and the second array of fasteners aligned longitudinally, the present disclosure is not limited in this regard. For example, the first array of fasteners 522 could be offset from the second array of fasteners 524, in accordance with various embodiments. In various embodiments, the fixed structure 502 is disposed laterally (i.e., in the X-direction) between the first array of fasteners 522 and the second array of fasteners 524. In this regard, the first array of fasteners 522 can clamp the moveable structure 504 to the fixed structure 502 on opposite lateral sides, resulting in a compressive force therebetween, in accordance with various embodiments. Although illustrated with a rod and hex nut fastener arrangement, the present disclosure is not limited in this regard. For example, the fastener arrangement 520 could comprise a bolt and nut arrangement, a clamp arrangement, or any other fastener arrangement that may be readily apparent to one skilled in the art.

In various embodiments, the top planar structure 610 and the bottom planar structure 620 each extend in the longitudinal direction (i.e., the Z-direction) from the manifold 282 to the discharge end 250. In various embodiments, the compression arrangement 630 comprises a first set of rollers 640 (e.g., a first set of compression rollers) and a second set of rollers 650 (e.g., a second set of compression rollers). In various embodiments, there can be any number of sets of rollers. The present disclosure is not limited in this regard. In various embodiments, each roller in the respective set of rollers could be a stack of discs, a single cylinder per roller, or any other type of roller arrangement that may be readily apparent to one skilled in the art. In various embodiments, each of the set of rollers 640, 650 could comprise a uniform roller (e.g., a cylindrical roller), a non-uniform roller (e.g., an ovular roller), or the sets of rollers (e.g., set of rollers 640, 650) could comprise a combination of uniform and non-uniform rollers. The present disclosure is not limited in this regard.

In various embodiments, the first set of rollers 640 and the second set of rollers 650 are configured to compress the top planar structure 610 and the bottom planar structure 620 together. For example, the first set of rollers 640 and the second set of rollers 650 are configured to compress the top planar structure 610 and the bottom planar structure 620 toward each other to compress the fibrous mixture traversing therethrough. The driving mechanism 290 is configured to drive the piston 214 (e.g., directly or indirectly) at least partially through the chamber of the housing assembly 212 to drive a fibrous mixture between the top planar structure 610 and the bottom planar structure 620. For example, in response to the driving mechanism 290 driving the piston 214 through the piston pump section 210 with a fibrous mixture disposed in the feed spout 270, the fibrous mixture traverses through the piston pump section 210, through the manifold 282 (or any similar structure), and through the channel 602 defined vertically between the top planar structure 610 and the bottom planar structure 620, as described further herein. Stated another way, the driving mechanism 290 is configured to drive the piston 214 at least partially through a chamber (e.g., chamber 213 of the piston pump section 210) to drive a fibrous mixture between the top planar structure 610 and the bottom planar structure 620.

Referring now to FIG. 5D, a cross-sectional view of the liquid extraction assembly 500 from FIG. 5C along section line E-E′ is illustrated, in accordance with various embodiments. In various embodiments, each of the first set of rollers 640 and the second set of rollers 650 is a loose roller 505. In this regard, the loose roller 505 can be secured in the longitudinal direction by a roller plate (e.g., roller plate 530 for the first set of rollers 640 and roller plate 540 for the second set of rollers 650), and secured vertically between a plate and a planar structure (e.g., between top plate 512 and top planar structure 610 for each of the first set of rollers 640 or between bottom plate 514 and the bottom planar structure 620 for the second set of rollers 650). In this regard, the first set of rollers 640 are compressed between the top plate 512 and the top planar structure 610 of the fixed structure 502, and the second set of rollers 650 are compressed between the bottom planar structure 620 and the bottom plate 514, and each of the first set of rollers 640 and the second set of rollers 650 are secured longitudinally between a lateral spar 506 and a lateral spar 507 of the respective roller plate (e.g., roller plate 530 or roller plate 540). Accordingly, responsive to translating the moveable structure 504 relative to the fixed structure 502, the first set of rollers 640 and the second set of rollers 650 compress the top planar structure 610 and the bottom planar structure 620 toward each other, which generates local compressive forces to the fibrous mixture traversing therethrough, resulting in liquid being extracted therefrom as described further herein. Although the first set of rollers 640 and the second set of rollers 650 are illustrated as being loose in the moveable structure 504, the present disclosure is not limited in this regard. For example, each of the first set of rollers 640 and the second set of rollers 650 could include a shaft extending therethrough from a first side of the roller plate 530 to a second side of the roller plate 530 and such an embodiment would still be within the scope of this disclosure.

Referring now to FIG. 5E, a cross-sectional view of the liquid extraction assembly 500 from FIG. 5D along section line F-F′ is illustrated, with like numerals depicting like elements, in accordance with various embodiments. In various embodiments, the liquid extraction assembly 500 of the liquid extraction section 220 further comprises a first longitudinal sidewall 810 spaced apart laterally (i.e., in the X-direction) from a second longitudinal sidewall 820. In various embodiments, the top planar structure 610 and the bottom planar structure 620 each extend laterally from the first longitudinal sidewall 810 to the second longitudinal sidewall 820. In various embodiments, the top planar structure 610 and the bottom planar structure 620 each comprise a plurality of rods (e.g., the plurality of rods 832 for the top planar structure 610 and/or the plurality of rods 842 for the bottom planar structure 620). In various embodiments, each of the plurality of rods 832, 842 include one of a square or rectangular cross-section. In various embodiments, each of the plurality of rods 832, 842 are aligned adjacent to an adjacent of the plurality of rods 832, 842. Although illustrated in FIG. 5E as having each of the plurality of rods 832, 842 defining a set gap G1 that is continuous in the lateral direction from a first side of the liquid extraction assembly 500 to the second side of the liquid extraction assembly 500, the present disclosure is not limited in this regard. For example, with brief reference to FIG. 5E, the plurality of plates 832, 842 can be staggered, resulting in a gap G1 that is staggered in a vertical direction (i.e., the Y-direction). In this regard, the gap G1 can be the same between adjacent rods in the vertical direction (e.g., a first of the plurality of rods 832 that is spaced apart from a first of the plurality of rods 842) but an orientation of adjacent rods in the lateral direction can be staggered relative to each other (e.g., a first of the plurality of rods 832 can be staggered relative to a second of the plurality of rods 832, the second of the plurality of rods 832 being adjacent to the first of the plurality of rods 832). In this regard, in addition to providing smaller standardized portions of a densified sheet that is formed from the liquid extraction assembly 500, the staggered configuration can potentially result in greater liquid release from the fibrous material traversing therethrough. In various embodiments, the plurality of rods 832, 842 are placed in alternating up and down orientations such that the extrudate still forms a dense block when stacked, but readily breaks into longitudinal pieces when applied later by an end-user. In various embodiments, the plurality of rods 832, 842 may be staggered from 5% of the extrudate width to 150% of the extrudate width, or between 5% and 100% of the extrudate width.

Referring back to FIG. 5E, in various embodiments, a shim 852 can be disposed between a first rod and a second rod in the plurality of rods 832, 842. For example, the shim 852 is disposed between a first of the plurality of rods 832 and a second of the plurality of rods 842. In this regard, a lateral spacing (i.e., in the X-direction) between adjacent rods in the plurality of rods 832, 842 can be pre-set. The spacing between rods in the plurality of rods 832, 842 can be configured to allow a liquid that is extracted from a fibrous mixture traversing through the channel 602 to travel therethrough to a respective collection area (e.g., collection tank 592 from FIG. 5A). In various embodiments, each of the plurality of rods 832, 842 can comprise grooves, which can at least partially form an extraction channel. However, the present disclosure is not limited in this regard. For example, the roller plate 530 could include extraction channels, or a plumbing structure could be utilized for routing extracted liquid, and such embodiments would still be within the scope of this disclosure. In various embodiments, although described as utilizing gravity and drain angles, the present disclosure is not limited in this regard. For example, forced blowing, or vacuum suction could be utilized instead of, or in addition to, gravity for routing extracted liquid from an extraction location (e.g., outward from the top planar structure 610 and/or the bottom planar structure 620) to the collection area (e.g., collection tank 592 from FIG. 5A), in accordance with various embodiments. Stated another way, collection of the extracted liquid from the liquid extraction section 220 can be passive or active. The present disclosure is not limited in this regard.

In various embodiments, the plurality of rods 832 of the top planar structure 610 and the plurality of rods of the bottom planar structure 620 are each compressed together in a lateral direction (i.e., the X-direction) between the first longitudinal sidewall 810 and the second longitudinal sidewall 820. In this regard, with combined reference to FIGS. 5D and 5E, the fixed structure 502 the fixed structure 502 can comprise a fastener arrangement 550 that couples the top planar structure 610 to the bottom planar structure 620, which sets a gap of the channel 602. For example, the fastener arrangement 550 comprises a first array of fasteners 552 and a second array of fasteners 554. In this regard, each of the first array of fasteners 552 couple the plurality of rods 832 of the top planar structure 610 to the first longitudinal sidewall 810 and the second longitudinal sidewall 820. Similarly, each of the second array of fasteners 554 couple the plurality of rods 842 of the bottom planar structure 620 to the first longitudinal sidewall 810 and the second longitudinal sidewall 820. In various embodiments, the first array of fasteners 552 can each be spaced apart from each other in the longitudinal direction (i.e., the Z-direction), and each of the second array of fasteners 554 can be spaced apart from each other in the longitudinal direction. In various embodiments, the first array of fasteners 552 are spaced apart from the second array of fasteners in the vertical direction (i.e., the Y-direction). In various embodiments the fastener arrangement 550 is configured to compress the plurality of rods 832, 842 together in the lateral direction (i.e., the X-direction) and setting a fixed width W1 and a fixed gap G1 for the channel 602, in accordance with various embodiments. Although each fastener in the fastener arrangement 550 is illustrated as including a rod and dual hex nuts, the present disclosure is not limited in this regard. For example, each fastener in the fastener arrangement 550 could include a bolt and nut arrangement, a bolt and nutplate arrangement, a bolt and insert arrangement, a bolt and blind threaded aperture arrangement, or any other fastener arrangement that may be readily apparent to one skilled in the art.

In various embodiments, the channel 602 can comprise a cross-sectional area (e.g., in the X-Y plane) that is substantially constant from a first longitudinal end of the channel 602 to the discharge end 250. However, the present disclosure is not limited in this regard. For example, the cross-sectional area can decrease as the channel 602 extends from the first longitudinal end of the channel 602 to the discharge end 250, the cross-sectional area can decrease until the liquid extraction section 220 and remain substantially constant throughout the liquid extraction section 220, the cross-sectional area can decrease until the liquid extraction section 220, or be oriented in any other type of arrangement and be within the scope of this disclosure.

In various embodiments, although illustrated with each of the fasteners in the fastener arrangement as extending through the longitudinal sidewalls 810, 820 and each of the plurality of rods 832, 842, the present disclosure is not limited in this regard. For example, fasteners could be disposed on opposite lateral sides and compress the longitudinal sidewalls 810, 820 together to secure the plurality of rods 832, 842 laterally therebetween (e.g., as shown in FIG. 8 and described further herein), in accordance with various embodiments.

In various embodiments, the channel 602 is at least partially defined by the first longitudinal sidewall 810, the top planar structure 610, the second longitudinal sidewall 820, and the bottom planar structure 620. In various embodiments, responsive to traversing the fibrous matrix through the liquid extraction section 220, liquid from the fibrous matrix is extracted between adjacent rods in the plurality of rods 842 of the bottom planar structure 620.

In various embodiments, a compressive force provided by the fastener arrangement 550 can be set such that each of the plurality of rods 832, 842 are configured to allow some movement as the first set of rollers 640 and the second set of rollers 650 translate back and forth (e.g., in the longitudinal direction) to help keep liquid leaching gaps clear (e.g., set via the shims, such as shim 852, between adjacent rods in the plurality of rods 832, 842). In this regard, although described as being components of a fixed structure 502, the term “fixed” is not meant to be overly limiting. Stated another way, minor movement of components of the fixed structure 502 during operation of the extruder device 201 from FIGS. 3A and 3B is within the scope of this disclosure, and the terms “fixed” and “moveable” for the fixed structure 502 and the moveable structure 504 are meant to be relative to one another (i.e., the moveable structure 504 moves relative to the fixed structure).

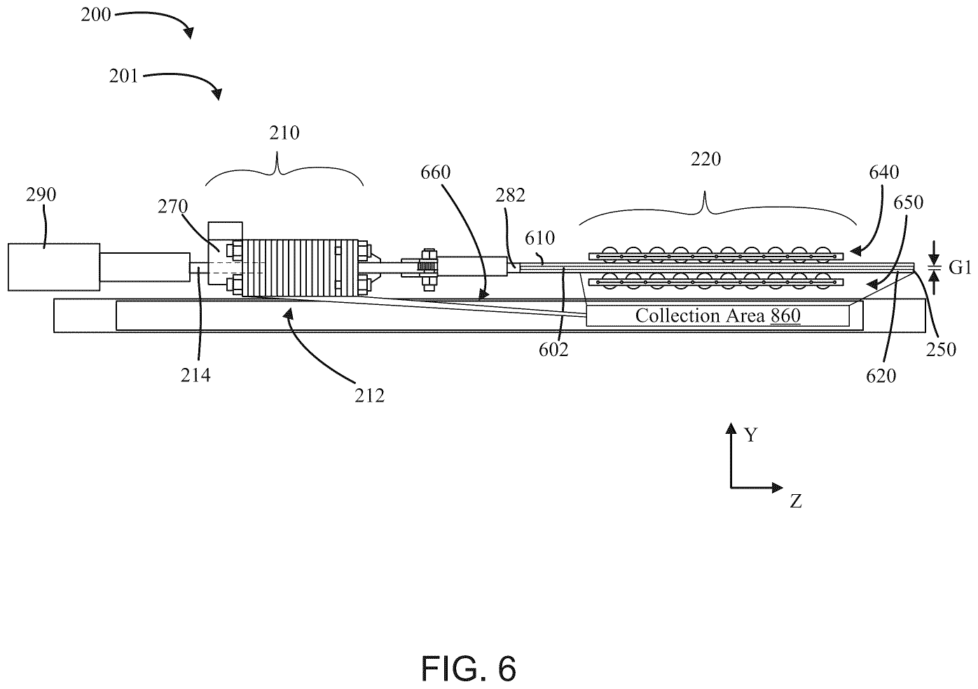

Referring now to FIG. 6, a side view of the extruder device 201 of liquid extraction section 220 from FIG. 3B is illustrated with the compression housing 286 from FIG. 3B removed for ease of reference, and like numerals depicting like elements. In various embodiments, the top planar structure 610 and the bottom planar structure 620 can be structurally supported by the compression housing 286 and various structural supports (e.g., structural links 288 and/or structural mounts 289). However, the present disclosure is not limited in this regard, and any structural arrangement for supporting the top planar structure 610 and the bottom planar structure 620 from FIG. 6 would be within the scope of this disclosure.

Although described herein in FIG. 3B as having the extruder device 201 disposed at an angle relative to a ground surface, the present disclosure is not limited in this regard. For example, as shown in FIG. 3B and FIG. 6, the extruder device 201 can include a channel that is substantially parallel to a plane defined by a ground surface. In this regard, a collection system for the extracted liquid of the extrusion device 201 can include a drain system 660 that is configured to route the extracted liquid that is produced during operation of the extruder device 201 to the collection area 860. In various embodiments, the drain system 660 could be an active drain system (i.e., with a vacuum, a pump, or any other mechanism for actively pulling or pushing the liquid to the collection area 860), or a passive drain system (i.e., a system that utilizes gravity to rout the extracted liquid to the collection area 860). The present disclosure is not limited in this regarding.

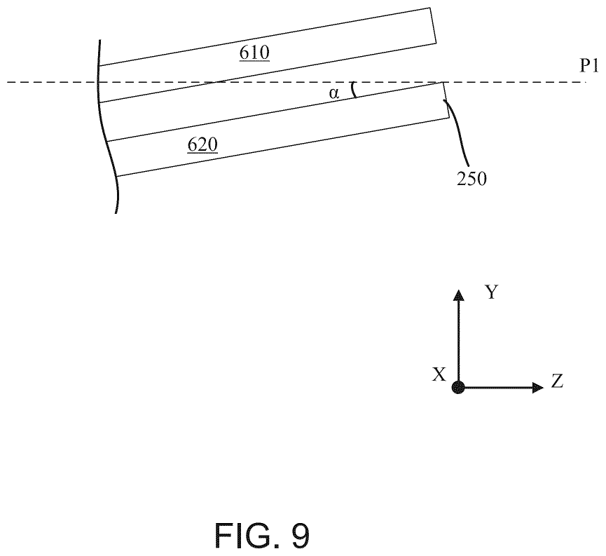

With brief reference to FIG. 9, in various embodiments, the liquid extraction section 220 is configured to allow liquid that is extracted proximal the discharge end 250 to flow away from the discharge end 250. For example, the bottom planar structure 620 is configured to be oriented at an acute angle (e.g., angle α) above a horizontal plane P1 defined through the discharge end 250 of the bottom planar structure 620. In this regard, in various embodiments, the acute angle (e.g., angle α) allows liquid that is extracted proximal the discharge end 250 of the liquid extraction section to flow away from the discharge end 250. In various embodiments, the top planar structure 610 can also be orientated at the acute angle. However, the present disclosure is not limited in this regard (e.g., as shown in FIG. 3A where the extruder device 201 is oriented at an angle α above a ground plane). In various embodiments, the angle α can be between 0.5 degrees and 15 degrees, or between 0.5 degrees and 10 degrees, or between 1 degree and 5 degrees, in accordance with various embodiments. Although illustrated as angling the bottom planar structure 620 in a longitudinal direction (i.e., X-direction) relative to the horizontal plane P1, the present disclosure is not limited in this regard. For example, the liquid extraction section 220 could be configured such that the bottom planar structure 620 is angled laterally (i.e., in the X-direction) to allow the liquid that is extracted to flow towards a longitudinal sidewall (e.g. first longitudinal sidewall 810 or second longitudinal sidewall 820 from FIG. 5E or 8). In this regard, the liquid could be extracted from one of the lateral sides of the compression arrangement 630 from FIG. 5E or FIG. 8, in accordance with various embodiments. In various embodiments, a combination of a longitudinal angle and lateral angle could be utilized and would also be within the scope of this disclosure. In various embodiments, the discharge could also be vertical (i.e., pointed directly up). In this regard, the extruder device 201 could also be rotated 90 degrees from a horizontal plane, which would facilitate the sheets that are discharged standing on their side at the discharge end 250, in accordance with various embodiments.

Referring back to FIG. 6, in various embodiments, a collection area 860 can be disposed proximate the compression arrangement 630 of the liquid extraction section 220. For example, the collection area 860 can be disposed vertically below the compression arrangement 630. In this regard, liquid (e.g., oil) that is extracted from a fibrous mixture (e.g., a dried animal feed) can be collected. In various embodiments, the collection area 860 comprises one or more containers (e.g., tanks, buckets, or any other container that is capable of capturing a liquid therein). In various embodiments, a drain system 660 can be configured to route liquid that may be extracted at various other locations in the extruder device 201 to the collection area. For example, the drain system 660 can comprise one or more conduits that connect a potential area of extraction (e.g., the housing assembly 212 of the piston pump section 210) to the collection area 860. Although illustrated as connecting the piston pump section 210 to the collection area 860, the present disclosure is not limited in this regard. For example, only the liquid extraction section 220 could be fluidly coupled to the collection area 860, additional locations such as the manifold 282, the feed spout 270, and/or the discharge end 250 could be fluidly coupled to the collection area 860, or any other arrangement of the drain system 660 that would be readily apparent to one skilled in the art is within the scope of this disclosure.

In various embodiments, the extruder device 201 comprises a liquid collection tank (e.g., disposed in the collection area 860). In this regard, during operation of the extruder device 201, liquid can travel through the plurality of drain relief apertures (e.g., that form the drain relief channel 461 and/or drain relief channel 462 from FIG. 4E). of the housing assembly 212 from FIG. 4E and/or through the bottom planar structure 620 to the liquid collection tank (e.g., disposed in the collection area 860). In various embodiments, the liquid can be routed via the drain system 660 (e.g., via one or more conduits). In various embodiments, the drain system 660 can rely on gravity (e.g., with a negative drain angle from a local extraction location to the collection area 860), or rely on a pump (e.g., to provide an extraction force to the liquid). The present disclosure is not limited in this regard.

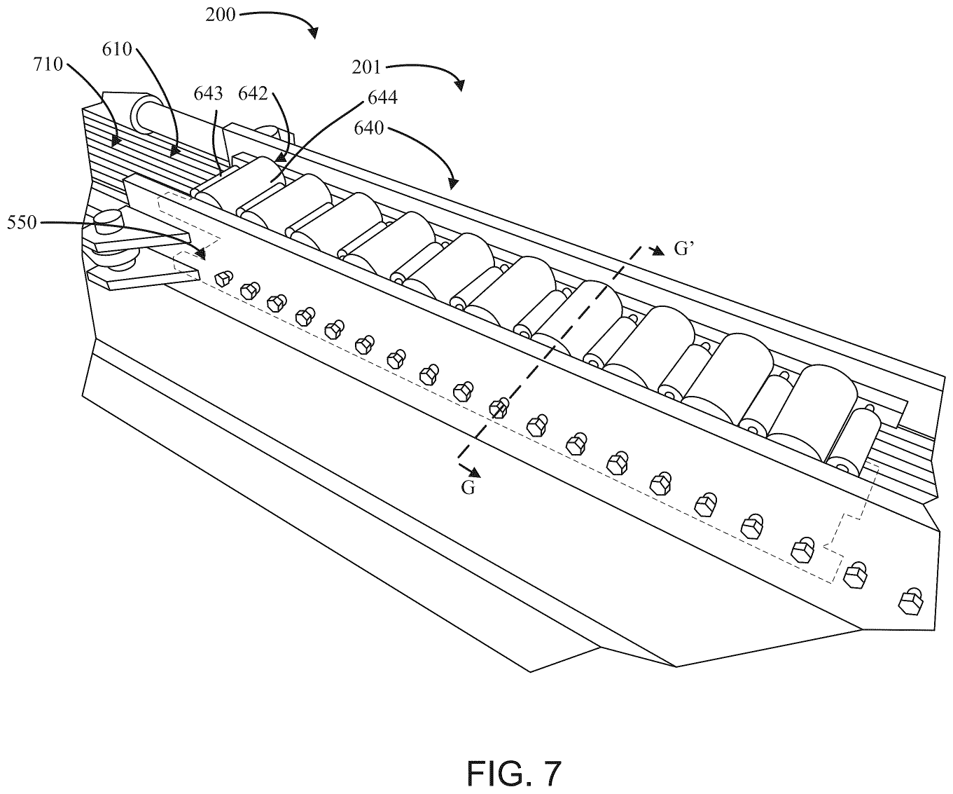

For example, referring now to FIG. 7, a perspective view of the liquid extraction section 220 with a top wall 284 from FIG. 3 of the liquid extraction section 220 removed for ease of reference, is illustrated, with like numerals depicting like elements, in accordance with various embodiments. In various embodiments, with combined reference to FIGS. 6 and 7, each of the set of rollers 640, 650 can comprise a compression roller 642. In this regard, the compression arrangement 630 can be configured to provide different compressive forces at different local longitudinal positions in the liquid extraction section 220 (e.g., the compression roller for each of the set of rollers 640, 650 can be configured to provide a same or a different compressive force). For example, a compressive force at a first longitudinal location that is more proximal to the piston pump section 210 relative to a second longitudinal location can provide a lower compressive force, in accordance with various embodiments. In this regard, the compression arrangement 630 can be configured to provide greater local compressive forces as the fibrous mixture traverses through the liquid extraction section 220, in accordance with various embodiments. However, the present disclosure is not limited in this regard. For example, the compressive force at each local location can remain relatively constant throughout the liquid extraction section 220 and would still be within the scope of this disclosure.

In various embodiments, the compression roller 642 can comprise a main roller 644 that supplies a compressive force to an adjacent structure (e.g., the top planar structure 610 for compression roller 642 of the set of rollers 640) and a counterweight 643. In this regard, the counterweight 643 can be adjusted to adjust a compressive force supplied by the compression roller 642. Additionally, by having the set of rollers 640, 650, which are spaced apart in the longitudinal direction (i.e., the Z-direction) from adjacent rollers, each of the set of rollers 640, 650 can be independently adjusted. Stated another way, each of the set of rollers 640, 650 can provide a different compressive force, if desired, in accordance with various embodiments. However, the present disclosure is not limited in this regard, and a configuration of the liquid extraction section 220 where each of the set of rollers 640, 650 is configured to supply a substantially equal compressive force is within the scope of this disclosure.

Referring now to FIG. 8, a cross-sectional view of the liquid extraction section 220 along section line G-G′ from FIG. 7 is illustrated with like numerals depicting like elements, in accordance with various embodiments. In various embodiments, the liquid extraction section 220 further comprising a first longitudinal sidewall 810 spaced apart laterally (i.e., in the X-direction) from a second longitudinal sidewall 820. In various embodiments, the top planar structure 610 and the bottom planar structure 620 each extend laterally from the first longitudinal sidewall 810 to the second longitudinal sidewall 820. In various embodiments, the top planar structure 610 and the bottom planar structure 620 each comprise a plurality of rods (e.g., the plurality of rods 832 for the top planar structure 610 and/or the plurality of rods 842 for the bottom planar structure 620). In various embodiments, each of the plurality of rods 832, 842 include one of a square or rectangular cross-section. In various embodiments, each of the plurality of rods 832, 842 are aligned adjacent to an adjacent of the plurality of rods 832, 842.

In various embodiments, a shim can be disposed between a first rod and a second rod in the plurality of rods 832, 842. For example, the shim 852 is disposed between a first of the plurality of rods 832 and a second of the plurality of rods 842. In this regard, a lateral spacing (i.e., in the X-direction) between adjacent rods in the plurality of rods 832, 842 can be pre-set. The spacing between rods in the plurality of rods 832, 842 can be configured to allow a liquid that is extracted from a fibrous mixture traversing through the channel 602 to travel therethrough to a respective collection area 860. In various embodiments, as described previously herein and with brief reference to FIG. 9, the angle α of the top planar structure 610 relative to the horizontal plane P1 can create a drain angle for extracted liquid that is output vertically from the top planar structure 610. In various embodiments, the drain angle can also be horizontal (e.g., towards the lateral sides, such as in the +X direction and/or −X direction). In various embodiments, each of the plurality of rods 832, 842 can comprise grooves, which can at least partially form an extraction channel. In this regard, an orientation of the grooves (e.g., in the longitudinal direction or the lateral direction) can route a liquid being extracted to the collection area 860. In various embodiments, although described as utilizing gravity and drain angles, the present disclosure is not limited in this regard. For example, forced blowing, or vacuum suction could be utilized for routing extracted liquid from an extraction location (e.g., outward from the top planar structure 610 and/or the bottom planar structure 620) to the collection area 860, in accordance with various embodiments. Stated another way, collection of the extracted liquid from the liquid extraction section 220 can be passive or active. The present disclosure is not limited in this regard.

In various embodiments, the plurality of rods 832 of the top planar structure 610 and the plurality of rods of the bottom planar structure 620 are each compressed together in a lateral direction (i.e., the X-direction) between the first longitudinal sidewall 810 and the second longitudinal sidewall 820. In various embodiments, the channel 602 is at least partially defined by the first longitudinal sidewall 810, the top planar structure 610, the second longitudinal sidewall 820, and the bottom planar structure 620. In various embodiments, responsive to traversing the fibrous matrix through the liquid extraction section 220, liquid from the fibrous matrix is extracted between adjacent rods in the plurality of rods 842 of the bottom planar structure 620.

In various embodiments, each of the plurality of rods 832, 842 are configured to move as the first set of rollers 640 and the second set of rollers 650 translate back and forth (e.g., in the longitudinal direction) to help keep liquid leaching gaps clear (e.g., set via the shims, such as shim 852, between adjacent rods in the plurality of rods 832, 842).

Although described previously herein in FIGS. 5D and 5E as including a fastener arrangement 550 for adjusting a horizontal compressive force (or a horizontal gap) that included an array of fasteners 552 for the top planar structure 610 and an array of fasteners 554 for the bottom planar structure 620, the present disclosure is not limited in this regard. For example, with combined reference to FIGS. 7 and 8, the fastener arrangement 550 for the extruder device 201 can comprise an array of adjustment fasteners 702. In various embodiments, each of the array of adjustment fasteners 702 can be configured to adjust a compression force that the longitudinal sidewalls 810, 820 provide to the top planar structure 610 and the bottom planar structure 620. In various embodiments, each of the array of adjustment fasteners 702 can be further configured to adjust a width of the channel 602 (e.g., by removing or adding rods into the top planar structure 610 and the bottom planar structure 620). In various embodiments, each of the array of adjustment fasteners 702 are coupled to the compression housing 286 of the extruder device 201 from FIG. 3B. Stated another way, adjustment of the gap G1 set in the liquid extraction section 220 (e.g., the leaching area) can be accomplished with a series of bolts (e.g., the adjustment fasteners or spring adjusted bolts) and plates (e.g., longitudinal sidewalls 810, 820) as shown in FIG. 8, in accordance with various embodiments.

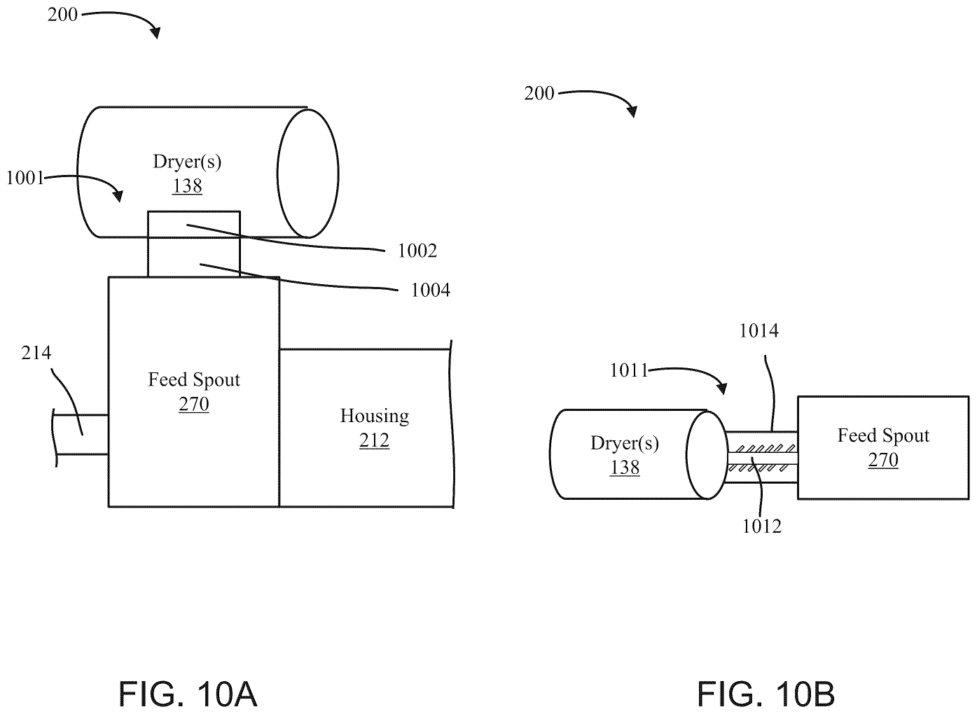

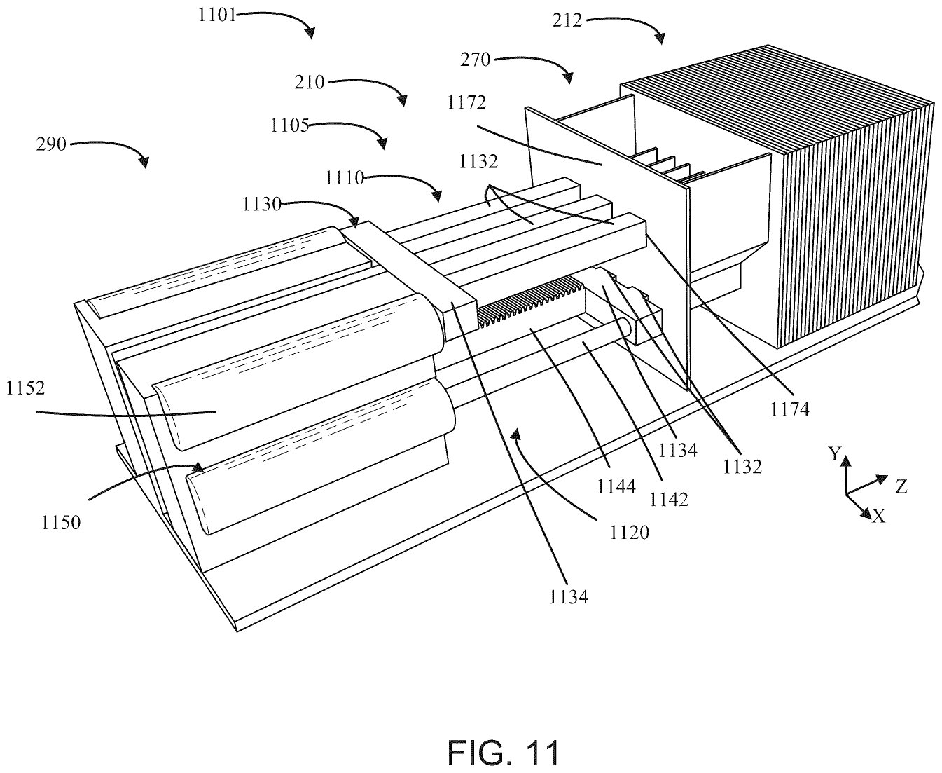

Referring now to FIGS. 10A and 10B, a schematic view of a portion of the liquid extraction system 200 from FIGS. 2 and 3 is illustrated, with like numerals depicting like elements, in accordance with various embodiments. The liquid extraction system can comprise one or more dryers 138 and a fluid conduit (e.g., fluid conduit 1004 for the liquid extraction system 200 from FIG. 10A or the fluid conduit 1014 for the liquid extraction system 200 from FIG. 10B). The fluid conduit 1004, 1014 extends from the one or more dryers 138 to a portion of the piston pump section 210 (e.g., the feed spout 270, the housing assembly 212, or any other portion of the piston pump section 210 that may be readily apparent to one skilled in the art). In various embodiments, the fluid conduit 1004, 1014 extends from the one or more dryers 138 to the feed spout 270. In various embodiments, the fluid conduit 1004, 1014 is configured to fluidly couple the one or more dryers 138 to the chamber 213 of the housing assembly 212 after a drying cycle is completed for a fibrous mixture (e.g., a dried animal feed). For example, the liquid extraction system 200 can further comprise a feed transfer mechanism (e.g., the feed transfer mechanism 1001 for the liquid extraction system 200 of FIG. 10A, or the feed transfer mechanism 1011 for the feed transfer mechanism of FIG. 10B).

In various embodiments, the feed transfer mechanism 1001 comprises a door 1002. The door 1002 can be configured to drop a dried fibrous mixture (e.g., the dried animal feed) from the one or more dryers 138 through the fluid conduit 1004 and into the piston pump section 210 (e.g., the chamber 213 of the housing assembly 212 from FIG. 2 and/or the feed spout 270). Although illustrated as including the fluid conduit 1004, the present disclosure is not limited in this regard. For example, the liquid extraction system 200 from FIG. 10A could not include the fluid conduit 1004, and an inlet of the feed spout 270 could be sized to ensure all of the dried fibrous mixture that was dropped from the one or more dryers 138 was collected by the feed spout 270, in accordance with various embodiments.

In various embodiments, the feed transfer mechanism 1011 comprises a screw 1012. The screw 1012 can be configured to convey the dried fibrous mixture (e.g., a dried animal feed) from the one or more dryers 138 through the fluid conduit 1014 and into the piston pump section 210 (e.g., the feed spout 270, the chamber 213 of the housing assembly 212 from FIGS. 2 and 3 directly, or any other portion of the piston pump section 210 that may be readily apparent to one skilled in the art).

Referring now to FIG. 11, a perspective view of a portion of the extruder device 1101 is illustrated, with like numerals depicting like elements, in accordance with various embodiments. In various embodiments, the extruder device 201 is similar to the extruder device 201 disclosed previously herein with the exception that the piston pump section 210 of the extruder device 1101 comprises a dual piston pump arrangement 1105 (e.g., pump section 1110 spaced apart vertically from a pump section 1120). In this regard, in various embodiments, the extruder device 1101 is configured to produce two densified fibrous mixtures simultaneously, within a similar footprint to the extruder device 201 from FIGS. 2 and 3 described previously herein.

In various embodiments, the pump section 1110 and the pump section 1120 can each comprise a piston 1130. The piston 1130 can comprise one or more piston rods 1132. Each of the one or more piston rods 1132 extends in a longitudinal direction (i.e., the Z-direction) from a piston head 1134. In various embodiments, each of the one or more piston rods 1132 can comprise a substantially square cross-sectional shape (e.g., in the X-Y plane). However, the present disclosure is not limited in this regard. For example, each of the one or more piston rods 1132 can include a substantially rectangular shape, a substantially circular shape, or any other shape that may be readily apparent to one skilled in the art and would still be within the scope of this disclosure. In various embodiments, a substantially square or a substantially rectangular shape for each of the one or more piston rods may be easier to manufacture (e.g., via machining or additive manufacturing) relative to an alternative shape.

In various embodiments, the piston 1130 for each of the pump section 1110 and the pump section 1120 further comprises a drive shaft 1142. The drive shaft 1142 extends from the piston head 1134 in an opposite direction from each of the one or more piston rods 1132 (e.g., a-Z-direction). In this regard, the driving mechanism 290 can comprise a pump 1150 (e.g., a hydraulic pump, a steam engine, a steam turbine, a pneumatic compressor, an electromagnetic compressor, or any other direct driving mechanism) associated with each respective drive shaft 1142. In this regard, the drive shaft 1142 can be configured to be driven by a pressure generated in a housing 1152 of the pump 1150. In various embodiments, to avoid having to employ a high pressure hydraulic pump as the driving mechanism 290, the piston 1130 can alternatively be driven using a lever arm such that a lower pressure piston moving faster on the longer drive end is able to deliver a higher pressure to the pump piston. Similarly, in various embodiments, the driving mechanism 290 could comprise a large wheel to drive the piston 1130 similar to a steam piston on a train steam engine.

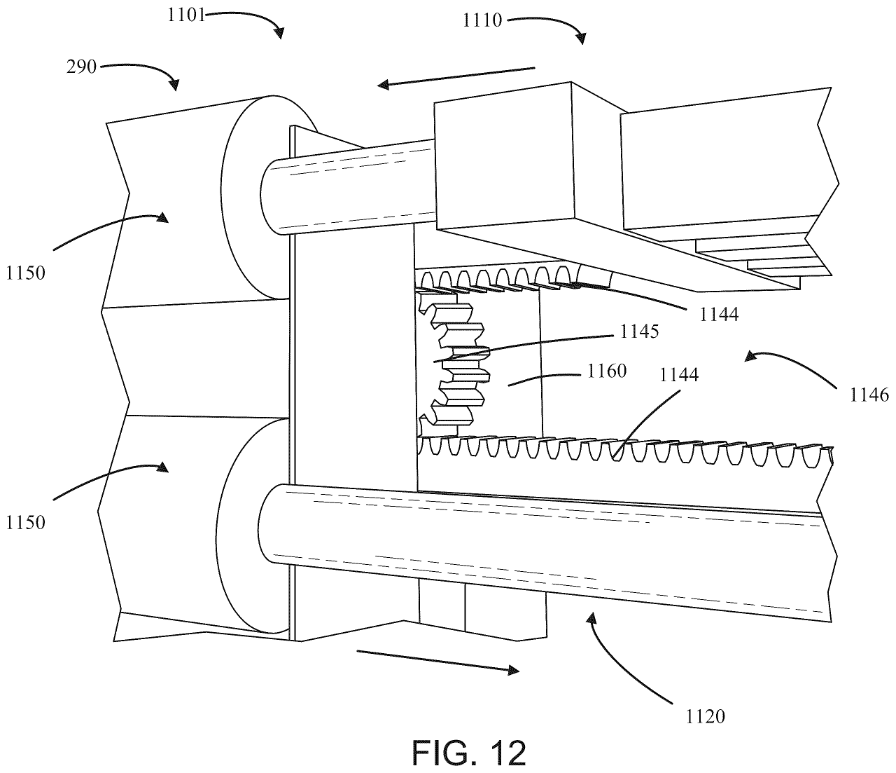

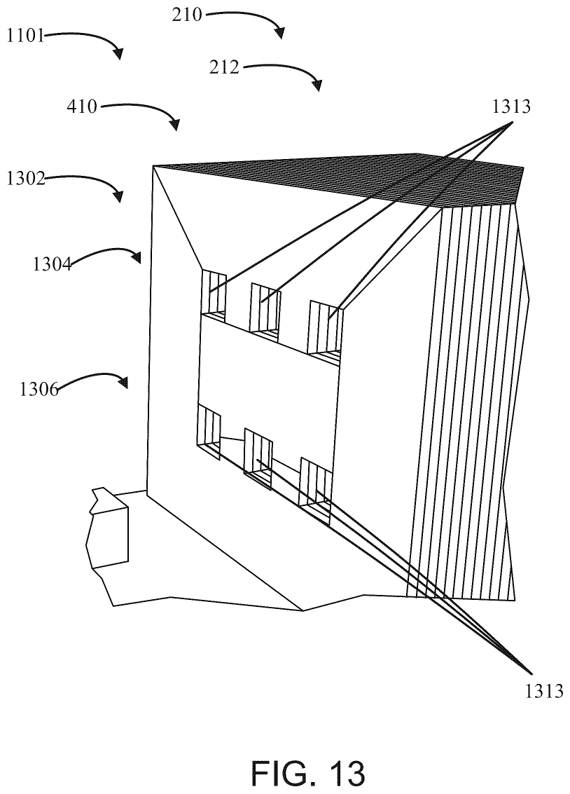

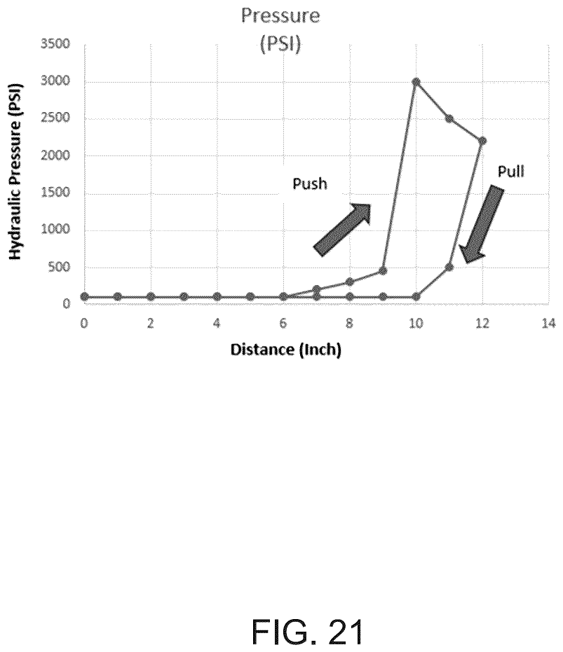

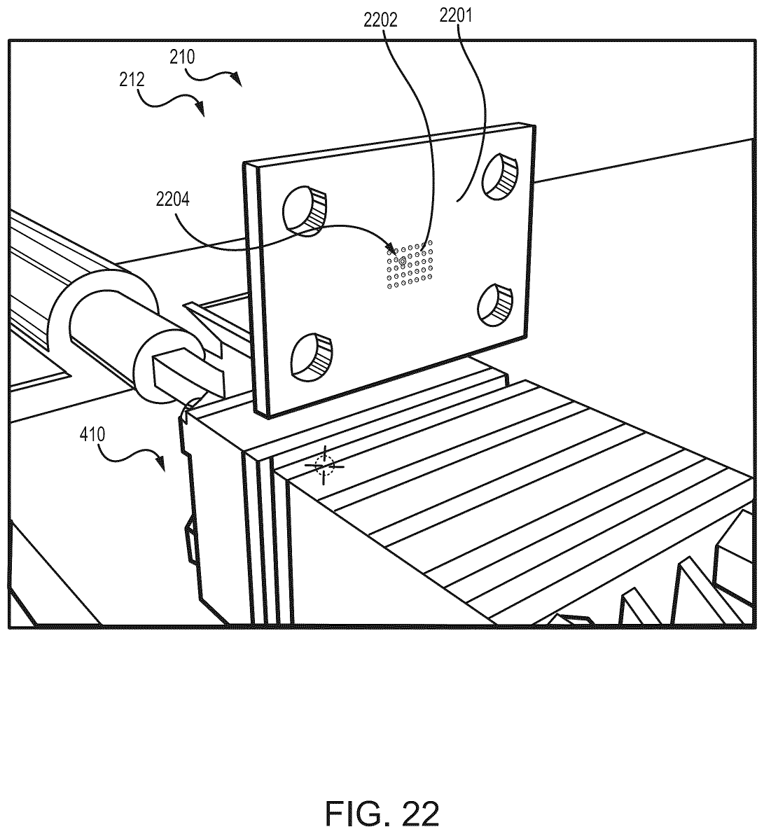

In various embodiments, the piston 1130 further comprises a rack 1144 spaced laterally (i.e., in the X-direction) from the drive shaft 1142. The rack 1144 can also extend from the piston head 1134 in an opposite direction from each of the one or more piston rods 1132 (e.g., a −Z-direction). With brief reference to FIG. 12, the rack 1144 can be configured to engage a pinion 1145 that is rotatably coupled to a housing 1160 of the driving mechanism 290. The pinion 1145 can be configured to engage the rack 1144 of the pump section 1120 and the rack 1144 of the pump section 1110. In this regard, a compression force to push a piston through the housing assembly 212 of the piston pump section 210 and compress a fibrous mixture therein will always be higher than a force to retract the piston back to a default position. In this regard, the rack and pinion arrangement 1146 can be configured to provide a mechanical advantage to assist in pushing a respective piston to compress a fibrous mixture (e.g., a dried animal feed) through the housing assembly 212 of the piston pump section 210. For example, in FIG. 12, the piston 1130 of the pump section 1110 is assisting (e.g., via the rack and pinion arrangement 1146) pushing the piston 1130 of the pump section 1120, in accordance with various embodiments. In this regard, a pressure supplied by a respective pump (e.g., pump 1150 for pump section 1110 and pump 1150 for pump section 1120) can be reduced during a compression phase of operation of the respective pump. For example, with brief reference to FIG. 21, an expected pressure profile of a hydraulic pump (e.g., pump 1150 for pump section 1110 without the rack and pinion arrangement 1146) is illustrated in accordance with various embodiments. As shown, the work for a pull motion is less than the work for a push motion of the hydraulic pump. Accordingly, by incorporating the rack and pinion arrangement the hydraulic pressure for the push motion can be reduced and the hydraulic pressure for the pull motion can be increased to be approximately equal (e.g., plus or minus 10%), so a size of the respective hydraulic pump can be reduced. Accordingly, a total size for the piston 1130 for each of the pump section 1110 and the pump section 1120 may be reduced relative to an embodiment without the rack and pinion arrangement 1146. Stated another way, the use of a gear arrangement (e.g., the rack and pinion arrangement 1146) between two pistons (e.g., piston 1130 of pump section 1110 and piston 1130 of pump section 1120) can allow for the retraction piston force be applied to the piston that is compressing.

Although illustrated in FIGS. 11 and 12 as including a drive shaft 1142 on one lateral side and a rack and pinion arrangement 1146 on another lateral side of the extruder device 1101, the present disclosure is not limited in this regard. For example, the piston 1130 for each of the pump section 1110 and the pump section 1120 could comprise only the drive shaft 1142, two or more of the drive shaft 1142, or any other arrangement that may be readily apparent to one skilled in the art, and would still be within the scope of this disclosure. However, the arrangement shown in FIGS. 11 and 12 can ensure that a minimal amount of energy in the extruder device 1101 is wasted. Stated another way, the extruder device 1101 as shown in FIGS. 11 and 12 can consume less energy per output of densified material, in accordance with various embodiments. Additionally, the arrangement shown in FIGS. 11 and 12 can provide twice the output of an extruder device with a single pump arrangement, in accordance with various embodiments.

Referring back to FIG. 11, the housing assembly 212 and the feed spout 270 of the piston pump section 210 of the extruder device 1101 can comprise a plurality of apertures, each of the plurality of apertures configured to receive a rod from the one or more piston rods 1132 of the piston 1130 for each pump section 1110, 1120. In this regard, each of the plurality of apertures can comprise a complementary cross-sectional shape to the cross-sectional profile of a respective rod in the one or more piston rods 1132. For example, for a substantially square-shaped rod, a front wall 1172 of the feed spout 270 can comprise a square shaped aperture 1174 corresponding to a respective rod in the one or more piston rods 1132.

Similarly, with brief reference to FIG. 13, each of the plurality of plates 410 of the housing assembly 212 for the extruder device 1101 can comprise a plurality of apertures 1302. Each of the plurality of apertures 1302 can include an aperture shape that is complementary in shape to a respective rod from the one or more piston rods 1132 for each pump section 1110, 1120 from FIG. 2. In this regard, for a two piston pump section (e.g., pump section 1110 and 1120), each with an array of three of the one or more piston rods 1132, the plurality of apertures 1302 can comprise a first array 1304 of three apertures in the plurality of apertures 1302 spaced apart vertically from a second array 1306 of three apertures in the plurality of apertures 1302. Although described herein as two arrays of three apertures, the present disclosure is not limited in this regard. For example, various other arrangements, such as a single rectangular shaped rod for each piston pump section (e.g., pump section 1110 and pump section 1120), more than three rods for each piston pump section, two rods for each piston pump section, or any other arrangement that may be readily apparent to one skilled in the art and is within the scope of this disclosure.

With continued reference to FIG. 13, each of the plurality of apertures 1302 can form a portion of one or more chambers 1313 of the housing assembly 212. In this regard, the extruder device 1101 can comprise a number of chambers (e.g., six) that correspond to a number of piston rods in the piston pump section 210 (e.g., two sets of three for the piston rods 1132 of the piston 1130). In various embodiments, a width of each of the one or more chambers 1313 can be between 0.5 inches (1.26 cm) and 8 inches (20.3 cm), or between 0.5 inches (1.26 cm) and 6 inches (15.2 cm), or between one inch (2.54 cm) and 4 inches (10.2 cm). Similarly, in various embodiments, a height of each of the one or more chambers 1313 can be between 0.5 inches (1.26 cm) and 8 inches (20.3 cm), or between 0.5 inches (1.26 cm) and 6 inches (15.2 cm), or between one inch (2.54 cm) and 4 inches (10.2 cm).

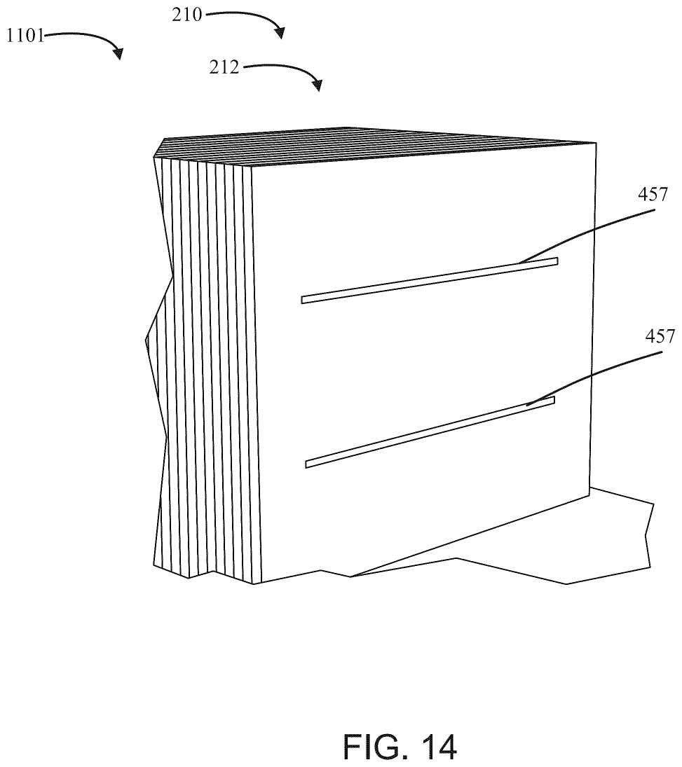

Referring now to FIG. 14, an output of the piston pump section 210 of the extruder device 1101 from FIG. 11 is illustrated in accordance with various embodiments. In this regard, the plurality of plates 410 of the housing assembly 212 for the extruder device 1101 can comprise two of the opening 457 from FIG. 4C disposed in the end plate 402 of the plurality of plates 410. A first of the opening 457 can be spaced apart vertically from a second of the opening 457. In this regard, the extruder device 1101 can be configured with two distinct channels for compressing and reforming two distinct densified fibrous mixtures in parallel, in accordance with various embodiments.

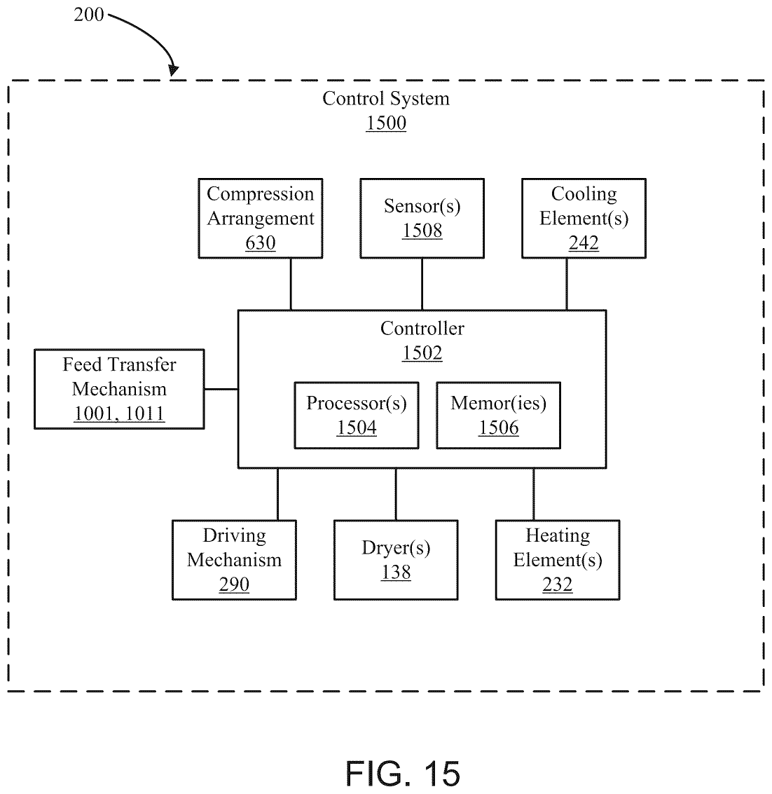

Referring now to FIG. 15, a schematic view of a control system 1500 for a liquid extraction system 200 is illustrated in accordance with various embodiments. Although described herein as being configured to control the liquid extraction system 200, the present disclosure is not limited in this regard. For example, the control system 1500 could be configured as a control system for the process 100 from FIG. 1. Stated another way, the control system 1500 could control a dry grind process in an ethanol plant in its entirety and would be within the scope of this disclosure. However, for brevity, the control system 1500 is described herein with specifics related to operation of the liquid extraction system 200.

In various embodiments, the control system 1500 comprises a controller 1502 (e.g., one or more processors 1504 and one or more associated memories 1506). In various embodiments, controller 1502 can be integrated into a computer system of a liquid extraction system 200, an ethanol plant (e.g., configured to perform the process 100 from FIG. 1), or a main control system of any other application within the scope of this disclosure. In various embodiments, controller 1502 can be configured as a central network element or hub to access various systems and components of control system 1500. Controller 1502 can comprise a network, computer-based system, and/or software components configured to provide an access point to various systems and components of control system 1500. In various embodiments, controller 1502 comprises one or more processors 1504. In various embodiments, controller 1502 can be implemented in a single processor of the one or more processors 1504. In various embodiments, controller 1502 can be implemented as, and may include, more than one of the one or more processors 1504 and/or one or more tangible, non-transitory memories (e.g., the one or more associated memories 1506) and be capable of implementing logic. Each of the one or more processors 1504 can be a general-purpose processor, a digital signal processor (“DSP”), an application specific integrated circuit (“ASIC”), a field programable gate array (“FPGA”) or other programable logic device, discrete gate or transistor logic, discrete hardware components, or the one or more processors 1504 can be any combination thereof. Controller 1502 can comprise a processor in the one or more processors 1504 that is configured to implement various logical operations in response to execution of instructions, for example, instructions stored on a non-transitory, tangible, computer-readable medium (e.g., at least one of the one or more memories 1506) configured to communicate with the processor in the one or more processors 1504.

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, the controller 1502 is operably coupled to various electronically controlled components (e.g., the driving mechanism 290, the one or more dryers 138, one or more heating elements 232 of the heating section 230 from FIG. 2, one or more cooling elements 242 from the cooling section 240 from FIG. 2, one or more sensors 1508, the compression arrangement 630, and/or the feed transfer mechanism 1001, 1101). In this regard various components of the liquid extraction system 200 can be controlled by the controller 1502 as described further herein.

In various embodiments, the one or more sensors 1508 can comprise any sensor that could provide data to the controller 1502 that could be utilized for operation of the liquid extraction system 200. In various embodiments, the one or more sensors 1508 can include one or more temperature sensors (e.g., disposed in each of the one or more dryers 138, disposed in the heating section 230 from FIG. 2, disposed in the cooling section 240 from FIG. 2, disposed in the chamber 213 of the housing assembly 212 from FIG. 2, or disposed in any other portion of the liquid extraction system where temperature measurements may be desired). In various embodiments, the one or more sensors 1508 can include one or more pressure sensors (e.g., disposed in the chamber 213 of the housing assembly 212 from FIG. 2, disposed within the channel 602 of the liquid extraction section 220 from FIGS. 6 and 8, disposed on the top planar structure 610 and/or the bottom planar structure 620 to monitor a compressive force of the compression arrangement 630 from FIG. 6, or disposed in any other portion of the liquid extraction section 220 where pressure measurements may be desired). In various embodiments, the one or more sensors 1508 can comprise a level sensor (e.g., disposed in the feed spout 270 to monitor an amount of a fibrous mixture disposed therein). In various embodiments, the one or more sensors 1508 can comprise one or more temperature sensors (e.g., probes, laser readers, infrared temperature camera, infrared probe). In various embodiments, the one or more sensors 1508 can comprise one or more thickness probes (e.g., a light detection and ranging (LiDAR) probe for measuring thickness, a linear footage recorder, or any other thickness measuring sensor that may be readily apparent to one skilled in the art). In various embodiments, data from the one or more sensors 1508 can be utilized by the controller 1502 for adjusting operational parameters of the liquid extraction system 200 in real-time. In various embodiments, the one or more sensors 1508 can comprise a load cell disposed in the chamber 213 of a piston pump section 210 as shown in FIG. 2. In this regard, the load cell can provide pressure data to the controller 1502 for use by the controller 1502 in ensuring that the pressure of the piston pump section 210 remains in a desired operational range.

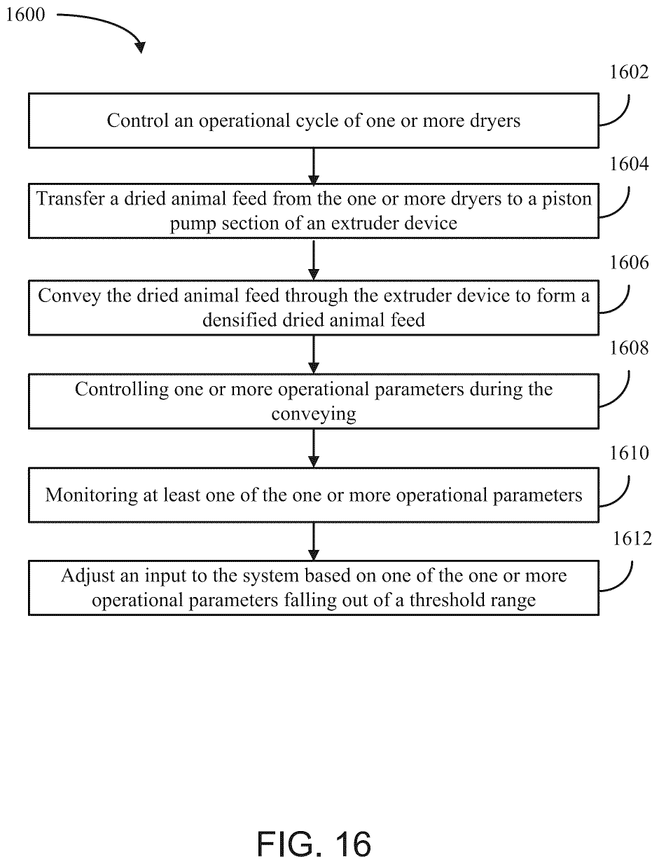

Referring now to FIG. 16, a process 1600 performed by the control system 1500 from FIG. 15 is illustrated, in accordance with various embodiments. With combined reference to FIGS. 15 and 16, the process 1600 comprises controlling, by the controller 1502, an operational cycle of the one or more dryers 138 (step 1602). In various embodiments, the operational cycle of the one or more dryers 138 can be greater than 160° F. (71° C.), or between 160° F. (71° C.) and 235° F. (113° C.). In various embodiments, after step 1602, a dried animal feed is produced from the one or more dryers 138. In various embodiments, the dried animal feed can be any of the dried animal feed output from the process 100 from FIG. 1 as described previously herein.

In various embodiments, the process 1600 further comprises transferring, by the controller 1502 and via the feed transfer mechanism 1001, 1011, the dried animal feed generated from step 1602 to a piston pump section 210 of an extruder device (e.g., extruder device 201 from FIGS. 2 and 3 or extruder device 1101 from FIG. 11) (step 1604). In various embodiments, the dried animal feed can be fed to the extruder device through a feed spout 270, directly into a chamber 213 of a piston pump section 210 as shown in FIG. 2, or fed to any other portion of extruder device that would be readily apparent to one skilled in the art. In various embodiments, the controller 1502 drops the dried animal feed into the extruder device (e.g., via a door 1002 as shown in FIG. 10A), the controller 1502 conveys the dried animal feed into the extruder device (e.g., via a screw 1012 as shown in FIG. 10B), or the controller 1502 transfers the dried animal feed to the extruder device by any transfer method that may be readily apparent to one skilled in the art.

In various embodiments, the process 1600 further comprises conveying, by the controller 1502, the dried animal feed through the extruder device (e.g., extruder device 201 from FIGS. 2 and 3 or extruder device 1101 from FIG. 11) (step 1606). In this regard, the controller 1502 can be configured to control an operational cycle of the extruder device by controlling the driving mechanism 290. For example, the controller 1502 can control a hydraulic pressure supplied to a hydraulic pump, an amount of steam supplied to a steam engine, initiate a steam turbine operational cycle for a steam turbine, electrically coupling a powered source to a pneumatic compressor (e.g., via an electrical switch or any other method known in the art), or couple a power source to an electromagnetic compressor (e.g., via an electrical switch or any other method known in the art), in accordance with various embodiments.

In various embodiments, the process 1600 further comprises controlling, by the controller 1502, one or more operational parameters during the conveying in step 1606 (step 1608). For example, the process 1600 can control any operational parameters of the extruder device in the liquid extraction system 200. In various embodiments, the controller 1502 can control a periodic interval for a compression phase followed by a retraction phase for the piston of the extruder device (e.g., piston 214 of extruder device 201 from FIGS. 2 and 3 or piston 1130 for each pump section 1110 and pump section 1120), a compressive force applied by each compression roller in the compression arrangement 630, a temperature output of the one or more cooling elements 242, a temperature output of the one or more heating elements 232, a chamber pressure in the liquid extraction section (e.g., the liquid extraction section 220 from FIG. 2), a chamber pressure in the piston pump section (e.g., piston pump section 210 from FIG. 2 or 11), a timing of a releasing of a solvent in the liquid extraction section 220 from FIGS. 2 and 3, or any other operational parameter of the respective extruder device (e.g., extruder device 201 from FIGS. 2 and 3, or extruder device 1101 from FIG. 11). For example, the solvent can comprise supercritical fluids (e.g., supercritical xenon, ethane, carbon dioxide, or any other supercritical fluid that may be readily apparent to one skilled in the art), hexane, petroleum ether, demulsifiers (e.g., acid catalysed phenol-formaldehyde resins, base catalysed phenol-formaldehyde resins, epoxy resins, polyethyleneimines, polyamines, di-epoxides, polyols, dendrimer, or any other demulsifier that may be readily apparent to one skilled in the art), alcohol, or any other solvent that may be readily apparent to one skilled in the art based on the specific application.

In various embodiments, the process 1600 can further comprise monitoring, by the controller 1502, at least one of the one or more parameters from step 1608 (step 1610). In this regard, the process 1600 can monitor the at least one of the one or more parameters to ensure that the extruder device remains within a desired operability range. In various embodiments, if the extruder device falls outside of a desired range, the controller 1502 can be configured to stop the extruder device (e.g., by disconnecting a power supply). However, the present disclosure is not limited in this regard.

In various embodiments, the controller 1502 is configured to ensure that the feed is compressed in the compression arrangement 630 at a pressure between 5,000 PSIG (34.5 MPa) and 15,000 PSI (103.4 MPa). However, the present disclosure is not limited in this regard, and the pressure supplied by the compression arrangement 630 can be application specific. Stated another way, based on a specific application and a specific liquid to be extracted, the pressure supplied by the compression arrangement 630 can be adjusted to optimize an amount of liquid extraction, in accordance with various embodiments.

In various embodiments, if the extruder device falls outside of a desired range of operability, the process 1600 can further comprise adjusting, by the controller 1502, an input to the liquid extraction system 200 based on the one or more operational parameters falling out of a threshold range (step 1612). For example, the controller 1502 can receive pressure data from the one or more sensors 1508 (e.g., corresponding to a measured pressure in the chamber 213 of the piston pump section 210 from FIG. 2). In this regard, the controller 1502 can modulate the piston 214 from FIG. 2, by connecting and disconnecting a power supply for operation of the driving mechanism 290, in response to a pressure exceeding a pressure threshold, in accordance with various embodiments. Alternatively, in response to a pressure exceeding a pressure threshold, controller 1502 can disconnect the power supply to turn off the extruder device, in accordance with various embodiments. In various embodiments, the controller 1502 could disconnect one of the one or more heating elements 232 in response to a temperature exceeding a temperature threshold in the heating section 230 from FIG. 2. Accordingly, based on sensor data received from the one or more sensors 1508, the controller 1502 can monitor the operational parameters in step 1610. Then, based on the sensor data indicating the operation of the extruder device is outside a respective range, the controller 1502 can stop the extruder device or adjust input parameters into the extruder device, in accordance with various embodiments.

Although the densification and liquid extraction process performed by the liquid extraction system 200 disclosed herein is described as being automated via a control system 1500 and process 1600, the present disclosure is not limited in this regard. For example, a non-automated liquid extraction system could include a flywheel for the driving mechanism 290, or any other driving mechanism that does not utilize a programed controller and would still be within the scope of this disclosure.

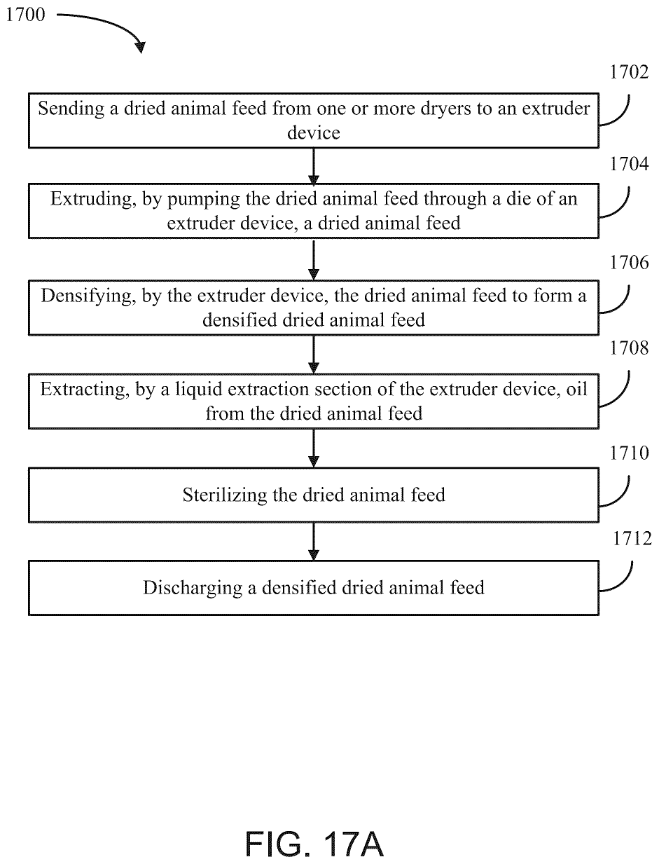

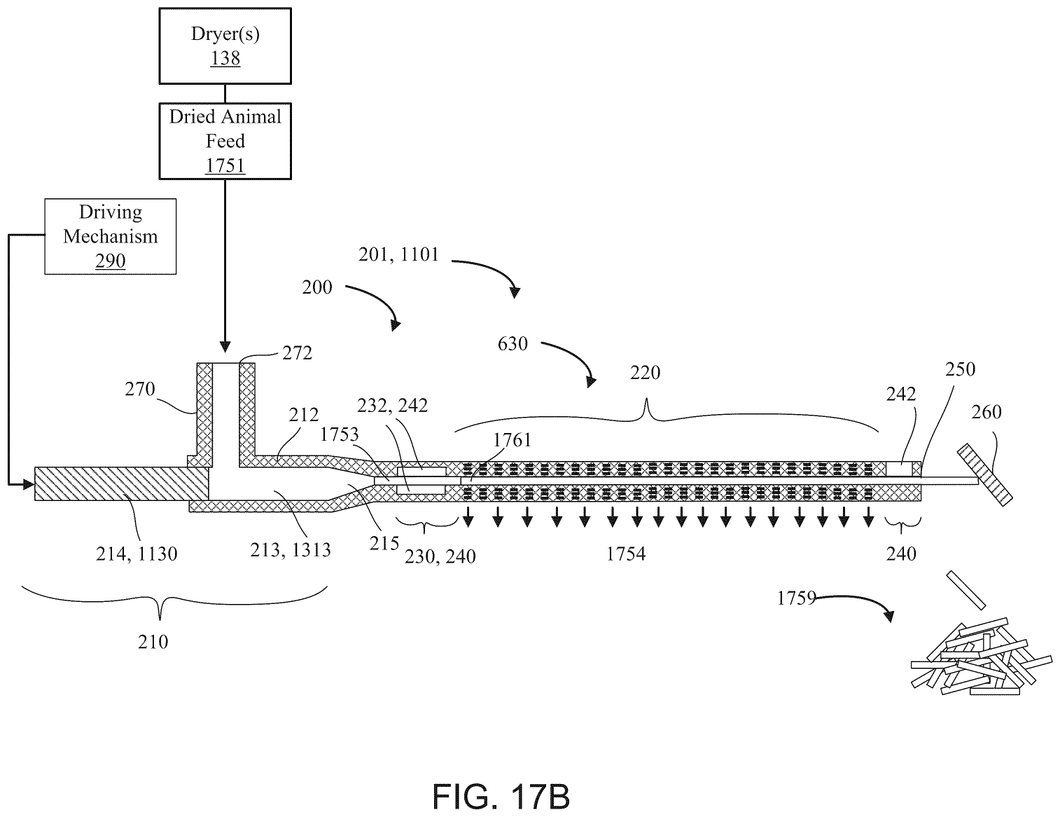

Referring now to FIGS. 17A and 17B, a method 1700 for manufacturing a densified animal feed (FIG. 17A) and a schematic illustration of the method 1700 (FIG. 17B) are illustrated, in accordance with various embodiments. With combined reference now to FIGS. 17A and 17B, the method 1700 can provide a densified dried animal feed 1759 as on output of the extruder device 201, 1101. The densified animal feed 1759 comprises a density that is greater than 55 lbs./ft³ (881 kg/m³). In this regard, by densifying a dried animal feed 1751 (e.g., Hi-Pro 140, DDG 142, DDGS 146, Enrich Yeast Hi-Pro 144) above 55 lbs./ft³ (881 kg/m³), the densified animal feed 1759 can be palletized and shipped via container shipping, resulting in greatly reduced shipping costs relative to typical shipping methods associated with dried animal feeds. In various embodiments, the dried animal feed is DDGS 146.

In various embodiments, the method 1700 comprises sending a dried animal feed 1751 from one or more dryers 138 to an extruder device 201, 1101 (step 1702). Prior to the sending, the method 1700 can further comprise heating, by the one or more dryers 138, an animal feed to form the dried animal feed 1751. For example, the animal feed can be heated to a temperature that is greater than or equal to 160° F. (71° C.) in the one or more dryers 138. In this regard, the one or more dryers 138 can be configured to remove excess moisture from a fibrous mixture (e.g., the animal feed) received in the process 100 from FIG. 1 described previously herein.

In various embodiments, the method 1700 comprises extruding, by pumping a dried animal feed 1751 through a die 1761 of an extruder device (e.g., extruder device 201 from FIGS. 2 and 3 or extruder device 1101 from FIG. 11), a dried animal feed (step 1704). In various embodiments, the die 1761 extends from an outlet of the reforming section 215 to the discharge end 250 of the extruder device 201, 1101. In this regard, the die 1761 is configured to impart a specific cross-sectional shape to the dried animal feed 1751 that is being pumped therethrough in step 1704. In various embodiments, the die 1761 comprises a generally rectangular cross-sectional shape (e.g., channel 602 from FIGS. 5E and 8 and/or the 457 disposed through the end plate 402 of housing assembly 212 from FIGS. 4C and 14). In this regard, the die 1761 can be sized and configured to form one or more sheets of the densified dried animal feed 1759, as described further herein. Although described herein as having a generally rectangular shape, the present disclosure is not limited in this regard. For example, the die 1761 could comprise a generally circular shape (e.g., for forming rods that can be stacked onto a pallet or oriented vertically on a pallet) or a generally W-shaped cross-section (e.g., to form a corrugated sheet) and would still be within the scope of this disclosure. Accordingly, various cross-sectional shapes may be readily apparent to one skilled in the art and would still be within the scope of this disclosure.

In various embodiments, responsive to the extruding in step 1704, the method 1700 can further comprise generating by one or more pistons (e.g., piston 214, a piston 1130, two or more of the piston 1130, or any other combination of pistons) a pressure between 6,000 PSIG (41.3 MPa) and 10,000 PSIG (68.95 MPa) in one or more chambers (e.g., chamber 213, each of the plurality of chambers 1313) of a housing assembly 212 for the one or more pistons. In this regard, the method 1700 can further comprise pushing (or pumping) the dried animal feed 1751 through the die via the one or more pistons (e.g., piston 214, a piston 1130, two or more of the piston 1130, or any combination of pistons).

In various embodiments, the extruding in step 1704 further comprises reforming, by the extruder device 201, 1101, the dried animal feed 1751 prior to extracting a liquid (e.g., via a liquid extraction section) to form a reformed dried animal feed 1753. In this regard, between the piston pump section 210 and the liquid extraction section 220, the reformed dried animal feed 1753 can be modified (e.g., heated to sanitize the dried animal feed 1751, cooled to stabilize the dried animal feed 1751, injected with a solvent configured to leach oil from the reformed dried animal feed 1753, or any other modification that may be readily apparent to one skilled in the art based on his disclosure) prior to the reformed dried animal feed 1753 entering the liquid extraction section 220. In this regard, although described herein as including the heating section 230 between the piston pump section 210 and the liquid extraction section 220, the present disclosure is not limited in this regard. For example, the heating section 230 could be a cooling section, a solvent supply apparatus, or any other modifier that may be readily apparent to one skilled in the art and would still be within the scope of this disclosure. Stated another way, if the heating section 230 is replaced with a cooling section (e.g., cooling section 240), the method 1700 can further comprise reforming, by the extruder device 201, 1101, the dried animal feed 1751 prior to the extracting to form a reformed dried animal feed 1753, and cooling, by a cooling section (e.g., cooling section 240 in place of heating section 230), the reformed dried animal feed 1753 to stabilize the reformed animal feed prior to the extracting in the liquid extraction section 220.

In various embodiments, for a liquid extraction system 200 from FIG. 2 with a solvent system, the driving mechanism 290 (e.g., a pump) will have a “reverse flow preventer” in the piston pump section 210. For example, a plate can be installed inside housing assembly 212 of the piston pump section 210 with a plurality of orifices that are sized and configured to prevent a back flow of the fibrous mixture traversing therethrough. For example, the plurality of orifices can be configured to require a greater pressure for flowing the fibrous mixture backward (i.e., in a forward direction, or a direction opposite a flow direction). The piston 214 (e.g., a piston/ram) can then push the fibrous mixture through the chamber 213, and responsive to being pushed through the chamber 213, the fibrous mixture can be prevented from flowing backward by the plurality of orifices, in accordance with various embodiments. For example, with brief reference to FIG. 4F, a plate 2201 in the plurality of plates 410 of the housing assembly 210 can comprise an orifice arrangement 2202. The orifice arrangement 202 can comprise a plurality of orifices 2204 (e.g., arranged in rows and columns, a circular array, an ovular array, or any other configuration that may be readily apparent to one skilled in the art. In various embodiments, each of the plurality of orifices 2204 can comprises a cross-sectional area on a forward side of the plate 2201 that is greater than a cross-sectional area on an aft side of the plate 2201.

In various embodiments, a periodic interval set by operation of the driving mechanism 290 of the one or more pistons (e.g., piston 214, a piston 1130, two or more of the piston 1130, or any combination of pistons) can compress the dried animal feed 1751 being traversed through the extruder device 201, 1101. In various embodiments, compressing the dried animal feed can include pressures between 5,000 PSIG (34.5 MPa) and 15,000 PSIG (103.4 MPa). In this regard, the dried animal feed 1751 can be forced through a reforming section (e.g., chamber 213 or the plurality of chambers 1313) to form a sheet of up to an inch (2.54 cm) thick, or up to 0.5 inches (1.26 cm) thick, with widths between 3 inches (7.6 cm) and 6 feet (1.83 m), or between 3 inches (7.6 cm) and 5 feet (1.52 m), or approximately 4 feet (1.22 m), in accordance with various embodiments.

In various embodiments, responsive to the extruding the dried animal feed in step 1704, the method 1700 further comprises densifying, by the extruder device 201, 1101, the dried animal feed 1751 to form a densified dried animal feed 1759 (step 1706). The densified dried animal feed 1759 comprises a density that is greater than 55 lbs./ft³ (881 kg/m³) as described further herein. In various embodiments, the density is between 55 lbs./ft³ (881 kg/m³) and 75 lbs./ft³ (1201 kg/m³).

In various embodiments, responsive to the extruding the dried animal feed 1751, the method 1700 further comprises extracting, by a liquid extraction section 220 of the extruder device 201, 1101, oil 1754 from the dried animal feed 1751 (or the reformed dried animal feed 1753) (step 1708). Stated another way, the liquid extraction section 220 of the extruder device 201, 1101 disclosed herein is configured to leach a liquid (e.g., oil) from a fibrous mixture (e.g., a dried animal feed 1751 or reformed dried animal feed 1753) and densify the fibrous matrix (e.g., the dried animal feed 1751 or the reformed dried animal feed 1753) as the fibrous matrix traverses through the extruder device 201, 1101. In this regard, during operation of the extruder device 201, 1101 disclosed herein, the liquid extraction section 220 of the extruder device 201, 1101 is configured to convert the fibrous matrix (e.g., the dried animal feed 1751) into a densified fibrous matrix (e.g., a densified dried animal feed 1759). In various embodiments, during the liquid extraction step, the dried animal feed 1751 will maintain a rough shape originally set by a discharge orifice of the reforming section 215 (e.g., corresponding to a shape of the opening 457 from FIGS. 4C and 14).

In various embodiments, step 1708 can further comprise compressing, by a compression arrangement 630 of the liquid extraction section 220, the dried animal feed 1751 (or the reformed dried animal feed 1753) to leach at least a portion of the oil 1754 therefrom. In this regard, the compression arrangement 630 is configured to compress the dried animal feed 1751 (or the reformed dried animal feed 1753) between opposing planar structures (e.g., the top planar structure 610 and the bottom planar structure 620 from FIG. 6). Responsive to the compressive force, the oil 1754 can be leached from the dried animal feed 1751 (or reformed dried animal feed 1753) traversing through the liquid extraction section 220, in accordance with various embodiments. In various embodiments, the compressing the dried animal feed 1751 (or reformed dried animal feed 1753) can further comprise traversing a first set of rollers (e.g., set of rollers 640 from FIG. 6) and a second set of rollers (e.g., set of rollers 650 from FIG. 6), back and forth along the bottom planar structure (e.g., bottom planar structure 620 from FIG. 6) and the top planar structure (e.g., top planar structure 610 from FIG. 6), respectively.

In various embodiments, the extracting the oil in step 1708 further comprises maintaining a pressure between 100 PSIG (689 KPa) and 1,500 PSIG (10.3 MPa) as the dried animal feed 1751 (or reformed dried animal feed 1753) traverses the extraction section of the extruder device 201, 1101. In various embodiments, the pressure range in the liquid extraction section 220 of the extruder device 201, 1101 is significantly less than expellers that are utilized for oil extraction. Additionally, the pressure can be maintained in the liquid extraction section 220 of the extruder device 201, 1101, for a relatively long residence time compared to expellers. For example, a residence time in the liquid extraction section 220 of the extruder device 201, 1101 disclosed herein can be between 10 seconds and 10 minutes, or between 15 seconds and 3 minutes.

In various embodiments, the method can comprise sterilizing the dried animal feed 1751 (or the reformed dried animal feed 1753) (step 1710). For example, during the extruding process of method 1700, the heating section 230 from FIG. 2 can be utilized to heat the dried animal feed further and sanitize the dried animal feed 1751 during the extruding. Then, the cooling section 240 from FIG. 2 can be utilized to stop the sterilization process. Accordingly, the sterilizing the dried animal feed 1751 can comprise heating, via a heating section 230 of the extruder device 201, 1101, the dried animal feed 1751 to form a sanitized animal feed, and optionally, the sterilizing the dried animal feed can further comprise cooling, via a cooling section 240 of the extruder device 201, 1101, the sanitized animal feed to end a sterilization process. Although described herein as including a sterilization step, the present disclosure is not limited in this regard. For example, a sterilization step may not be needed, since the dried animal feed 1751 may be sanitized in a prior step or may be considered sufficiently sanitized via the process 100 from FIG. 1, in accordance with various embodiments.

In various embodiments, the method 1700 further comprises discharging the densified dried animal feed 1759 (step 1712). In this regard, the method 1700 can further comprise breaking (e.g., one of cutting, crumbling, or briquetting) the densified dried animal feed 1759 at the discharge end 250 of the extruder device 201, 1101. Alternatively, the method 1700 can further comprise reforming, by the extruder device 201, 1101, the plurality of sheets of densified dried animal feed including the densified dried animal feed 1759.

In various embodiments, the method 1700 from FIGS. 17A and 17B use less energy relative to traditional oil extraction methods, such as expeller devices, screw extruders and/or pellet mills.

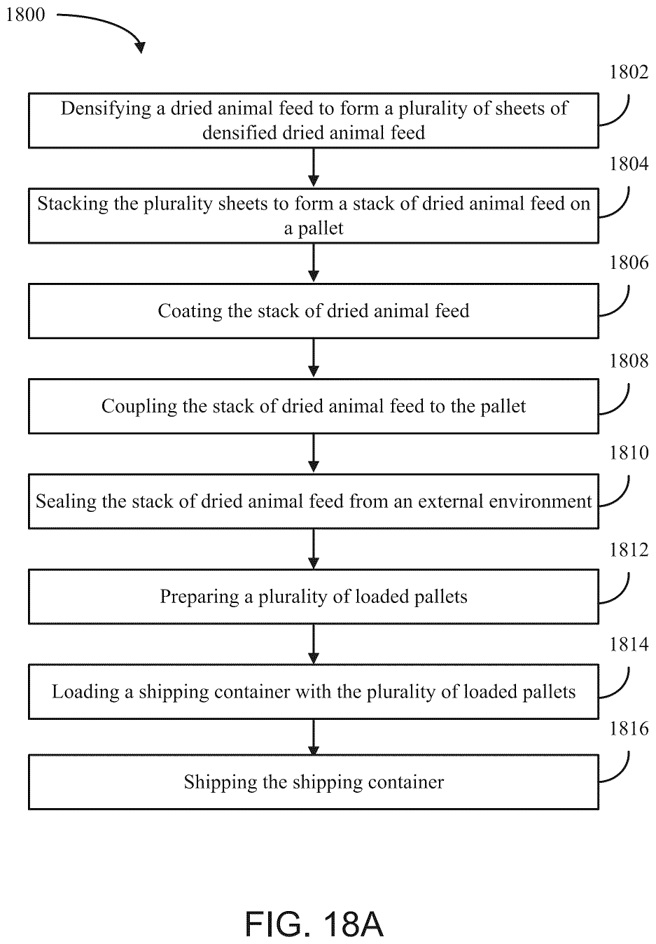

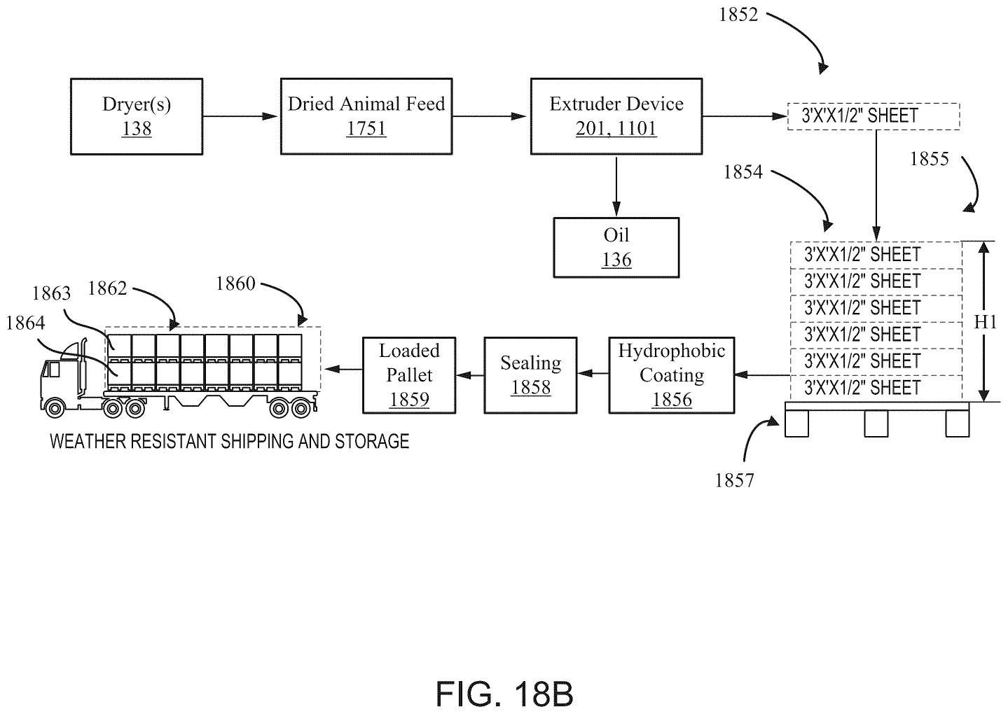

Referring now to FIGS. 18A and 18B, a method 1800 of facilitating transport of a dried animal feed (FIG. 18A) and a schematic illustration of the method 1800 (FIG. 18B) are illustrated, in accordance with various embodiments. As described herein, the extruder device disclosed previously herein (e.g., extruder device 201, 1101 used in the method 1700 as shown in FIG. 17B), can be configured to densify a dried animal feed above a threshold density for shipping via palletized shipping, in contrast with dry bulk shipping. In this regard, shipping costs can be greatly reduced for a dried animal feed relative to typical shipping methods.

In various embodiments, the method 1800 comprises densifying a dried animal feed 1751 to form a plurality of sheets of densified dried animal feed 1854, each (e.g., sheet 1852) of the plurality of sheets of densified dried animal feed comprising a density that is greater than 55 lbs./ft³ (881 kg/m³) (step 1802). In various embodiments, each of the plurality of sheets of densified dried animal feed 1854 is formed, by the extruder device 201, 1101. For example, the method 1800 can further comprise any of the steps from the method 1700 from FIG. 17A. In this regard, the method 1800 can further comprise reforming, by the extruder device 201, 1101, the plurality of sheets of densified dried animal feed 1854, the plurality of sheets of densified dried animal feed including the densified dried animal feed 1759 (e.g., that is output from the extruder device 201, 1101 as shown in FIG. 17B).

For example, in various embodiments, the densifying in step 1802 further comprises pushing (or pumping) the dried animal feed 1751 through an extruder device 201, 1101 to form each of the plurality of sheets of densified dried animal feed 1854. In various embodiments, the method 1800 further comprises leaching oil 136 from the dried animal feed 1751 while the dried animal feed is being pushed through the extruder device 201, 1101. In various embodiments, the method 1800 further comprises collecting the oil 136 that is leached from the dried animal feed 1751 (e.g., for selling as distiller's corn oil). In various embodiments, the method 1800 further comprises heating, by the extruder device 201, 1101, the dried animal feed 1751 after, during, or before the leaching the oil to sanitize each of the plurality of sheets of densified dried animal feed. In various embodiments, the method 1800 further comprises cooling, by the extruder device 201, 1101, the dried animal feed 1751 after the heating to end a sterilization process. In various embodiments, the method 1800 further comprises drying, by the one or more dryers 138, an animal feed to form the dried animal feed 1751 and sending the dried animal feed 1751 to the extruder device 201, 1101.

In various embodiments, the method 1800 can further comprise scoring each (e.g., sheet 1852) of the plurality of sheets of densified dried animal feed 1854. In this regard, upon arriving at a final destination, each of the plurality of sheets of densified dried animal feed 1854 can be easily broken into bit size pieces (e.g., by cattle or by a feeder) along the scoring marks to facilitate feeding an animal with the densified dried animal feed. In various embodiments, the scoring can be done by the extruder device 201, 1101 (e.g., proximate a discharge end), or done after the densifying step 1802 prior to the stacking step 1804. The present disclosure is not limited in this regard. In various embodiments, scoring may be easier when the dried animal feed is in a heated state. Accordingly, the scoring can be performed by the extruder device aft of the liquid extraction section 220 of the extruder device 201, 1101 from FIG. 17B and forward of the cooling section 240 (e.g., if a cooling section 240 is included in the extruder device 201, 1101), in accordance with various embodiments. In various embodiments, responsive to the scoring, each of the plurality of sheets of densified dried animal feed 1854 form a corrugated sheet (e.g., a kit-kat style sheet with longitudinal scores).

In various embodiments, the method 1800 further comprises stacking the plurality of sheets of densified dried animal feed 1854 to form a stack of densified animal feed 1855 on a pallet 1857. In this regard, each of sheets of densified dried animal feed 1854 formed by the extruder device 201, 1101 can be sized and configured to be stacked on a standard sized pallet (e.g., pallet 1857). In this regard, a length of the sheet 1852 can be less than or equal to 48 inches (122 cm), and a width of the sheet 1852 can be less than or equal to 40 inches (102 cm). However, the present disclosure is not limited in this regard, and any sized sheets of the plurality of sheets of densified dried animal feed 1854 would be within the scope of this disclosure.

In various embodiments, the method 1800 further comprises coating the stack of densified animal feed 1855 with a hydrophobic coating 1856 (step 1806). In this regard, the stack of dried animal feed can be coated to resist moisture during shipping and storage. In various embodiments, the hydrophobic coating can be a food grade hydrophobic coating (e.g., prepared using attapulgite natural nanorods). In this regard, the hydrophobic coating can be configured to avoid liquid food adhesion and reduce waste relative to non-food grade hydrophobic coatings. In various embodiments, the hydrophobic coating can comprise at least one of: wax, palm oil, polyethylene glycol (PEG), pectin, hydrophobic silicas, titania-polyurea (TiO 2-SPUA), polylactic acid (PLA), various lipid-based coatings, or any other hydrophobic coating that may be readily apparent to one skilled in the art. Although described herein as including a hydrophobic coating in step 1806, the present disclosure is not limited in this regard. For example, the stack of densified animal feed 1855 may not be coated with a hydrophobic coating 1856 and would still be within the scope of this disclosure. However, a hydrophobic coating 1856 can extend a shelf life of the dried animal feed, increasing a potential value thereof, in accordance with various embodiments.

In various embodiments, the method 1800 further comprises coupling the stack of densified animal feed 1855 to the pallet 1857 (step 1808). In various embodiments, the stack of densified animal feed 1855 can be coupled to the pallet 1857 by any coupling method (e.g., straps, shrink wrapping, water resistant slip covers, or any other coupling method known in the shipping arts). In various embodiments, the stack of densified animal feed 1855 that are coupled to the pallet 1857 form a loaded pallet 1859.

In various embodiments the method 1800 further comprises scaling 1858 the stack of dried animal feed from an external environment (step 1810). For example, in the coupling step (e.g., step 1808), the stack of dried animal feed can be shrink wrapped to seal the stack of dried animal feed from the external environment. In this regard, by coating the stack of densified animal feed 1855 with a hydrophobic coating 1856 and sealing 1858 the stack of densified animal feed 1855 from an external environment, a shelf life of the stack of dried animal feed can be greatly increased relative to typical dried animal feed that is shipped in bulk cargo in loose pellets. Stated another way, not only can a cost of shipping per weight of dried animal feed be greatly improved by the method 1800 disclosed herein, but also a shelf life of the product. For example, the stack of densified animal feed 1855 can be stored for significantly longer after arrival at an end location prior to use, in accordance with various embodiments. In various embodiments, the sealing in step 1810 can create a moisture barrier around the stack of densified animal feed 1855.

In various embodiments, a height H1 of the stack of densified animal feed 1855 relative to a top surface of the pallet 1857 can be less than or equal to 42 inches (106.7 cm). In this regard, by keeping the height H1 less than or equal to 42 inches (106.7 cm), a first of the loaded pallet 1859 can be stacked on a second of the loaded pallet 1859 in a shipping container 1860. Stated another way, a shipping volume can be further improved by loading each of a plurality of pallets to a height H1 that is less than 42 inches (106.7 cm) to facilitate stacking within a shipping container 1860. Although described herein as having a height H1 that is less than or equal to 42 inches (106.7 cm), the present disclosure is not limited in this regard. For example, any height H1 and would still be within the scope of this disclosure.

In various embodiments, the method 1800 further comprises preparing a plurality of loaded pallets (step 1812). In this regard, each of the plurality of loaded pallets can be prepared in accordance with the loaded pallet 1859.

In various embodiments, the method 1800 further comprises loading a shipping container 1860 with the plurality of loaded pallets 1862 (step 1814). In various embodiments, the loading the shipping container 1860 can further comprise stacking a first 1863 of the plurality of loaded pallets 1862 on a second 1864 of the plurality of loaded pallets 1862. Although described herein as stacking a first 1863 of the plurality of loaded pallets 1862 on a second 1864 of the plurality of loaded pallets 1862, the present disclosure is not limited in this regard. For example, the shipping container 1860 can be loaded with only a single row of a plurality of loaded pallets 1862 and would still be within the scope of this disclosure. Similarly, a different product could be loaded on the plurality of loaded pallets 1862 or intermixed with the plurality of loaded pallets 1862 (e.g., in a less than a truckload (LTL) shipment) and still be within the scope of this disclosure.

In various embodiments, the method 1800 further comprises shipping the shipping container 1860 (step 1816). In this regard, as described previously herein, a shipping cost for the densified dried animal feed product produced by the method 1700 from FIGS. 17A and 17B can be significantly less relative to shipping costs associated with typical dried feed products produced from the process 100 in an ethanol plant 10 from FIG. 1. Additionally, the method 1800 can significantly increase a weight of dried animal feed product shipped in a single shipment by forming the densified animal feed product via the method 1700 from FIGS. 17A and 17B and utilizing the method 1800 for shipping the dried animal feed product.

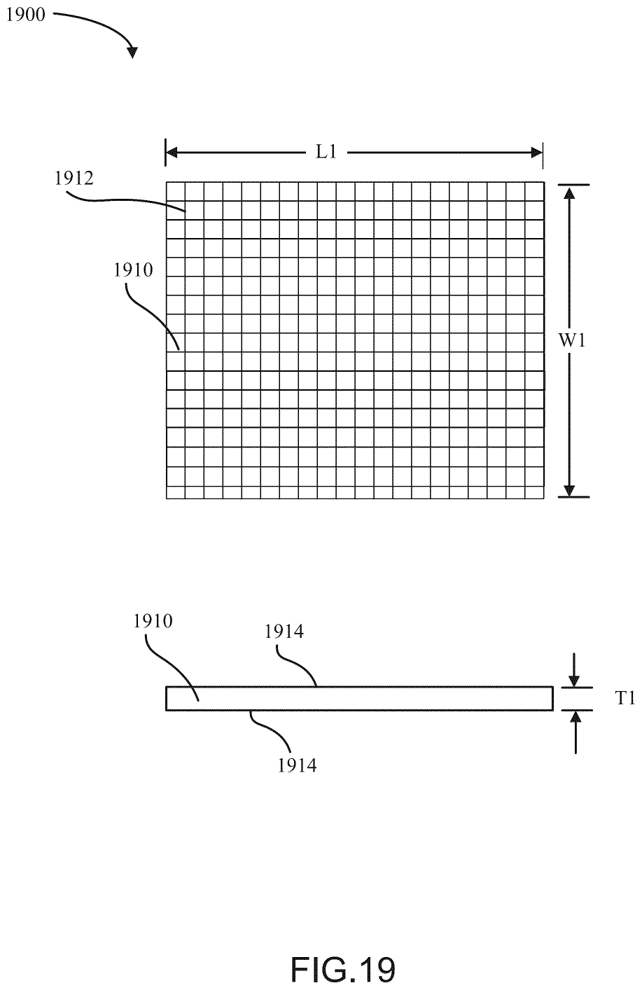

Referring now to FIG. 19, a top-down view, and a side view of a densified dried animal feed 1900 formed via the method 1700 from FIGS. 17A and 17B in preparation for shipping in accordance with method 1800 from FIGS. 18A and 18B is illustrated, in accordance with various embodiments. The densified dried animal feed 1900 comprises a sheet of dried cercal grain-based composition 1910 (e.g., formed from a feedstock 101 in the process 100 from FIG. 1). The sheet of dried cereal grain-based composition 1910 comprises a density that is greater than 55 lbs./ft³ (881 kg/m³). In various embodiments, the sheet of dried cereal grain-based composition 1910 comprises a density between 55 lbs./ft³ (881 kg/m³) and 80 lbs./ft³ (1281 kg/m), or between 55 lbs./ft³ (881 kg/m³) and 75 lbs./ft³ (1201 kg/m³). In this regard, the sheet of dried cercal grain-based composition 1910 can be shipped on a pallet 1857 via a shipping container 1860 as shown in FIG. 18B, in accordance with various embodiments.

In various embodiments, the sheet of dried cereal grain-based composition 1910 comprises one of dried distillers' grains with solubles (DDGS) (e.g., DDGS 146 from FIG. 1), dried distillers' grains (DDG) (e.g., DDG 142 from FIG. 1), grain distillers' dried yeast (e.g., Enrich Yeast Hi-Pro 144 from FIG. 1), oilseeds, soybean meal, gluten meal, rice hulls, wheat hulls, sugarcane bagasse, distillers' solids, brewery solids, sugar beet pulp, orange peel, olive pulp, peanut solids, fruit bunch, or any other composition that may be readily apparent to one skilled in the art.

In various embodiments, the sheet of dried cereal grain-based composition 1910 comprises a generally cuboid shape. In this regard, the sheet of dried cereal grain-based composition 1910 comprises a length L1, a width W1 and a thickness T1. In various embodiments, a thickness of the sheet of dried cereal grain-based composition is between 0.1 inches (0.254 cm) and 1.0 inches (2.54 cm), or between 0.25 inches (0.635 cm) and 0.75 inches (1.905 cm).

In various embodiments, sheet of dried cereal grain-based composition 1910 comprise DDGS having a composition comprising between 25% and 50% protein by weight, between 0.5% and 10% starch by weight, between 7% and 15% fiber by weight, and between 4% and 13% fat by weight. In this regard, dried DDGS can have a relatively high oil extraction potential compared to other animal feed products produced by the process 100 from FIG. 1 in an ethanol plant.

In various embodiments, the densified dried animal feed 1900 further comprises a plurality of scores 1912 forming a corrugated sheet, each of the plurality of scores 1912 extending along a surface 1914 of the sheet of dried cereal grain-based composition. In various embodiments, the plurality of scores 1912 can include two or more columns in the plurality of scores, two or more rows in the plurality of scores, or a combination of two or more columns and two or more rows. Although described herein as comprising the plurality of scores 1912 to facilitate an ease of breaking a respective sheet of dried cereal grain-based composition 1910 when using the densified dried animal feed 1900, the present disclosure is not limited in this regard. For example, the densified dried animal feed 1900 could be without any scores and still be within the scope of this disclosure. In various embodiments, only one surface (e.g., surface 1914) can include a plurality of scores, or multiple surfaces (e.g., surface 1914 and surface 1916) can include scores. The present disclosure is not limited in this regard.

In various embodiments, each of the plurality of scores 1912 is configured to facilitate a break along a respective score in the plurality of scores 1912 in response to suppling a force to an end of the sheet of dried cereal grain-based composition 1910 that is spaced away from a respective score in the plurality of scores 1912. Stated another way, each of the plurality of scores can be configured as a breaking edge to separate one side of the score from another side of the score, in accordance with various embodiments.

In various embodiments, the plurality of scores 1912 can be shaped and sized for a target consumer of the densified dried animal feed 1900. For example, the plurality of scores 1912 can define sub-shapes that can be sized and configured for ease of consumption (e.g., by cattle or any other animal that may consume the densified dried animal feed 1900). In various embodiments, a width and/or length of each of the sub-shapes formed by the plurality of scores 1912 can be less than 2.0 inches (5.1 cm), or less than 1.5 inches (3.8 cm).

Although described herein as forming the densified dried animal feed 1900 in the form of the sheet of dried cereal grain-based composition 1910, the present disclosure is not limited in this regard. For example, the die 1761 for shaping the densified dried animal feed output from the extruder device 201, 1101 from FIG. 17B can include a circular cross-section and be configured to output rods of densified dried animal feed. The rods could similarly be stacked on a pallet and cut to a size corresponding to the height H1 from FIG. 18B or cut to a length corresponding to either a width or a length of a respective pallet 1857 from FIG. 18B and stacked within a box, or other container, and would still be within the scope of this disclosure. In various embodiments, if the densified dried animal feed is formed into rods, the rods could have a diameter that is less than or equal to 0.75 inches (1.91 cm), or less than or equal to 0.625 inches (1.59 cm). In this regard, densified rods formed in this manner could easily break into target chunk sizes for cattle or other target species, in accordance with various embodiments.

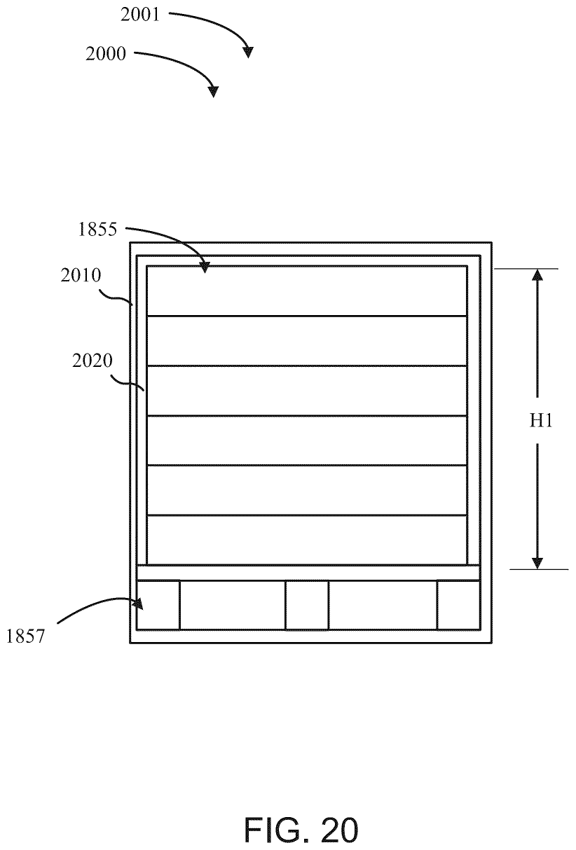

Referring now to FIG. 20, a side view of a loaded pallet 2000 with a shipping arrangement 2001 created by the method 1800 from FIGS. 18A and 18B is illustrated, in accordance with various embodiments. The shipping arrangement 2001 comprises a stack of densified animal feed 1855. The stack of densified animal feed 1855 includes the densified dried animal feed 1900 from FIG. 19. The shipping arrangement comprises a pallet 1857 and the stack of densified animal feed 1855 disposed (e.g., stacked) on the pallet 1857. In various embodiments, the stack of densified animal feed 1855 form a generally cuboid shape. In various embodiments, a height of the stack of densified animal feed 1855 relative to a top surface of the pallet 1857 is less than or equal to 42 inches.

In various embodiments, the shipping arrangement 2001 further comprising a cover 2010 (e.g., shrink wrapping, a slipcover such as a super sack, or any other cover that may be readily apparent to one skilled in the art) encapsulating the stack of densified animal feed 1855 on the pallet 1857. In this regard, the cover 2010 can create a moisture barrier around the stack of the densified animal feed 1855. Although illustrated as having the cover 2010 enclose the pallet 1857 and the stack of densified animal feed 1855, the present disclosure is not limited in this regard. For example, a pallet 1857 that has a top surface that is continuous can include cover 2010 that does not enclose a bottom side of the pallet 1857 and would still be within the scope of this disclosure.

In various embodiments, the shipping arrangement 2001 can include a hydrophobic coating 2900 enclosed within the cover 2010. In this regard, a shelf life of the densified animal feed 1855 can be enhanced as described previously herein. In various embodiments, with combined reference to FIGS. 18B and 20, loaded pallet 2000 can be loaded into the shipping container 1860 as described previously herein. In this regard, the shipping container 1860 comprises a plurality of loaded pallets 1862, which can include the loaded pallet 2000.

Further enhancements of the invention can be achieved. By integrating a solvent, especially one that will flash/volatilize readily at ambient pressure on the backend of the device, the solvent (1) volume helps displace oil trapped in the void fraction of the solid material, and (2) turn into gas once pressure is released, leaving the void fractions empty or (3) enable collapsing of the void fraction while under pressure. Solvents mentioned are known for increasing the solubility of the fat/oil in the solid matrix, thus enabling its motility out to the extraction. Examples of solvents are water, carbon dioxide, ethanol, methanol, fusel oils, petroleum ether, hexane and demulsifiers.

In one embodiment, the feed material is pretreated to modify some of the extruder device feed prior to the extruder device. Chemicals or biochemicals such as enzymes or microorganisms are able to hydrolyze bonds and facilitate improved release of bound fats and moisture from the solids. Chemicals common for use to pretreat biomass such as acids (sulfuric, acetic and the like), bases (ammonia, potassium hydroxide, sodium hydroxide and the like) or organosolv solvents would all be suitable for this priming unit operation.

For some processes, the target extractant is not evenly distributed across all of the bulk solid stream. For example, in the case of DDGS, the bulk can be a heterogeneous mixture of bran fiber, corn tip caps, yeast, zein protein and other suspended solids, all coated in the dryer with the soluble solids syrup. This feedstock can be classified by one of many such methods to sort the bulk material into fractions with elevated levels of fat, whereby the enriched fractions are only fed to the device, allowing for improved effective capacity for fat/oil extraction.

The extraction yields and throughput rates can be adjusted by normalizing heterogeneous particle distributions.

For some feed applications, the preferred shape of the pressed product can be a pellet or larger range cube. The disclosed invention allows for this through changes to the extruder device discharge cross section and subsequent extraction rods, whereby they are appropriately staggered to press the solids into parallel cylinders.

The pressed cylinder shapes can then be broken or cut apart from one another and to desired length for the application.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

1. An extruder device, comprising:
a driving mechanism;
a piston pump section comprising a housing assembly and a piston, the housing assembly including a chamber disposed therein; and
a liquid extraction section coupled to the piston pump section, the liquid extraction section comprising a top planar structure, a bottom planar structure, a first set of members and a second set of members, the first set of members and the second set of members configured to compress the top planar structure and the bottom planar structure together, the driving mechanism configured to drive the piston, directly or indirectly, at least partially through the chamber to drive a fibrous mixture between the top planar structure and the bottom planar structure.

2. The extruder device of claim 1, wherein the housing assembly further comprises a feed spout and a fluid conduit, the fluid conduit comprising a portion of the chamber, the feed spout in fluid communication with the chamber.

3. The extruder device of claim 1, wherein the top planar structure and the bottom planar structure each comprise one of:
a mechanical screen; or
a plurality of rods, each of the plurality of rods having one of a square, rectangular, or trapezoidal, or trapezoidal with arched product facing edges cross-section, each of the plurality of rods aligned adjacent to an adjacent of the plurality of rods.

4. The extruder device of claim 3, wherein the liquid extraction section further comprising a first longitudinal sidewall spaced apart laterally from a second longitudinal sidewall, and wherein the top planar structure and the bottom planar structure each comprise the plurality of rods.

5. The extruder device of claim 4, wherein the plurality of rods of the top planar structure and the plurality of rods of the bottom planar structure are each compressed together in a lateral direction between the first longitudinal sidewall and the second longitudinal sidewall by a fastener arrangement.

6. The extruder device of claim 5, wherein responsive to traversing the fibrous mixture through the liquid extraction section, liquid from the fibrous mixture is extracted between adjacent rods in the plurality of rods of the bottom planar structure.

7. The extruder device of claim 5, wherein each of the plurality of rods is configured to move independently from one another, and
wherein one or more shims is disposed between a first of the plurality of rods and a second of the plurality of rods to set a leach gap therebetween.

8. The extruder device of claim 1, wherein:
the housing assembly further comprises a plurality of plates;
each of the plurality of plates comprise an opening;
each of the plurality of plates is stacked in a longitudinal direction;
each of the plurality of plates is coupled together by a compressive force in the longitudinal direction; and
the opening of at least a portion of the plurality of plates forms at least a portion of the chamber of the housing assembly.

9. The extruder device of claim 8, wherein the housing assembly further comprises:
a feed spout; and
a fluid conduit, wherein the chamber is at least partially defined by an internal cavity of the fluid conduit and the opening from each of the plurality of plates.

10. The extruder device of claim 1, further comprising a drain relief channel disposed through the plurality of plates, wherein each of the plurality of plates comprise a drain relief aperture that at least partially forms the drain relief channel.

11. The extruder device of claim 10, further comprising a liquid collection tank, wherein during operation of the extruder device, liquid travels through the drain relief channel to the liquid collection tank.

12. The extruder device of claim 1, wherein the driving mechanism comprises one of a hydraulic pump, a lever arm, a wheel and crank arrangement, an electromagnet compressor, a pneumatic compressor, a steam engine, a steam turbine, or a flywheel.

13. The extruder device of claim 12, wherein:
during operation of the extruder device, the liquid extraction section is configured to leach a liquid from the fibrous mixture and densify the fibrous mixture as the fibrous mixture traverses therethrough,
the liquid extraction section comprises a discharge end, and
during operation of the extruder device, the liquid extraction section is configured to convert the fibrous mixture into a densified fibrous mixture.

14. The extruder device of claim 13, wherein the densified fibrous mixture comprises a dried animal feed, and wherein the dried animal feed comprises a density between 55 lbs./ft³ (881 kg/m³) and 75 lbs./ft³ (1201 kg/m³).

15. The extruder device of claim 1, wherein the bottom planar structure is configured to be oriented at an acute angle above a horizontal plane defined through an inlet end of the bottom planar structure.

16. The extruder device of claim 15, wherein the acute angle allows liquid that is extracted proximal a discharge end of the liquid extraction section to flow away from the discharge end.

17. The extruder device of claim 1, further comprising:
a heating section disposed adjacent to the liquid extraction section;
a cooling section disposed adjacent to the heating section; and
a discharge end disposed adjacent to the cooling section.

18. The extruder device of claim 17, further comprising a breaker spaced apart from the discharge end, the breaker configured to break a densified dried animal feed that is discharged from the discharge end.

19. The extruder device in claim 1, precluded by a partitioning device such as a mechanical sieve screen, air aspirator, electrostatic separators, ionic separators, airjet sieve, cyclone, time-of-flight separator, tumbling segregator or similar device capable of partitioning feed fractions by particle size and/or composition.

20. The extruder device in claim 1, precluded by a particle milling device such as a rollermill, hammermill, airjet mill, ball mill or the like.

21. The extruder device of claim 5, whereby the extraction rods are shaped and configured in such a way to produce a series of shaped cross-sections. In one embodiment, the cross section is a series of circular shapes of between ⅛″ and ⅞″.

22. The extruder device of claim 1, where the length of extrudate is controlled by a bar, plate, knife and/or sawblade.

23. A system for generating a densified dried animal feed comprising:
an extruder device comprising:
a driving mechanism;
a piston pump section comprising a housing assembly and a piston, the housing assembly including a chamber disposed therein; and
a liquid extraction section coupled to the piston pump section, the liquid extraction section comprising a top planar structure, a bottom planar structure, a first set of members and a second set of members, the first set of members and the second set of members configured to compress the top planar structure and the bottom planar structure together, the driving mechanism configured to drive the piston, directly or indirectly, at least partially through the chamber to drive a fibrous mixture between the top planar structure and the bottom planar structure;
one or more dryers;
a fluid conduit extending from at least one of the one or more dryers to the chamber of the housing assembly of the piston pump section;
a feed transfer mechanism, the feed transfer mechanism comprising one of:
a door configured to drop a dried animal feed from the one or more dryers through the fluid conduit and into the chamber of the housing assembly of the piston pump section; or
a screw configured to convey the dried animal feed from the one or more dryers through the fluid conduit and into the chamber of the housing assembly of the piston pump section; and
a controller electronically coupled to the one or more dryers and the extruder device, the controller configured to:
control an operational cycle of the one or more dryers;
transfer the dried animal feed from the one or more dryers to the chamber of the housing assembly of the piston pump section; and
convey the dried animal feed through the extruder device to form the densified dried animal feed.

24. A housing assembly for an extruder device, the housing assembly comprising:
a plurality of plates stacked in a longitudinal direction, the plurality of plates at least partially defining a chamber of a piston pump section of the extruder device therein, the chamber comprising a first cross-sectional profile at an inlet of the plurality of plates and a second cross-sectional profile at an outlet of the plurality of plates, the second cross-sectional profile being different from the first cross-sectional profile;
a fastener arrangement, wherein each of the plurality of plates are coupled together by a compressive force in the longitudinal direction from the fastener arrangement;
a feed spout; and
a fluid conduit coupled to a forward plate in the plurality of plates, wherein the chamber of the piston pump section of the extruder device is at least partially defined by an internal cavity of the fluid conduit,
wherein the chamber is configured to reform a fibrous mixture as the fibrous mixture traverses from the inlet of the plurality of plates to the outlet of the plurality of plates.

25. The system of claim 24, where a temperature control step is applied between the compression chamber and the liquid extraction system.

26. The system of claim 25, where the liquid extraction system is contained and controlled under negative pressure.

27. The system of claim 24, where the energy of the vaporized fluid is recovered using condensing fluid, mechanical vapor recompression or a heat pump.

28. The extruder device of claim 3, where a volatile fluid solvent is blended with the slurry feed stream. In one embodiment, the solvent is water, carbon dioxide, ethanol, methanol, fusel oil, petroleum ether, hexane, or demulsifier.

29. The extruder device of claim 3, where the feed material is pretreated with a chemical or biochemical. In one embodiment, the pretreatment material is enzymes or microorganisms.
